(19) United States
(12) Patent Application Publication
(10) Pub. No.: US 2003/0072962 A1
(43) Pub. Date: Apr. 17, 2003

(54) Steel sheet having organic coating and method for manufacturing the same

(75) Inventors: Akira Matsuzaki, Fukuyama (JP); Satoru Ando, Fukuyama (JP); Naoto Yoshimi, Fukuyama (JP); Takahiro Kubota, Fukuyama (JP); Masaaki Yamashita, Fukuyama (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: NKK CORPORATION, Tokyo (JP)

(21) Appl. No.: 10/116,594

(22) Filed: Apr. 4, 2002

Related U.S. Application Data
(63) Continuation of application No. PCT/JP01/04394, filed on May 25, 2001.

(30) Foreign Application Priority Data
May 30, 2000 (JP) 2000-161045
May 30, 2000 (JP) 2000-161049

(51) Int. Cl. B32B 15/08; B32B 15/18

(52) U.S. Cl. 428/623; 428/418; 428/659; 428/653; 428/633

(57) ABSTRACT

Steel sheet having organic coating comprises: a zinc or a zinc alloy plated steel sheet or an aluminum or an aluminum alloy plated steel sheet; a composite oxide coating formed on the surface of the plated steel sheet and containing at least one metal selected from the group consisting of Mn and Al; and an organic coating formed on the composite oxide coating and containing a rust-preventive additive component.

### FIELD OF THE INVENTION

The present invention relates to a steel sheet with organic coating, optimum for automobiles, household electric appliances, building materials, or the like, and to an environmentally compatible surface treated steel sheet free of heavy metals such as chromium, lead, cadmium, and mercury, harmful to environment and to human body, during manufacturing process and in the products, to respond to the issues: of influence on workers and users who handle the products; of measures of waste water treatment during manufacturing process; further of environment such as volatilization and elution of toxic substances from the products under use environments.

### DESCRIPTION OF THE RELATED ARTS

Steel sheets for household electric appliances, for building materials, and for automobiles widely use zinc-base plated steel sheets or aluminum-base plated steel sheets on which surface chromate treatment was given by a treating liquid consisting mainly of chromic acid, bichromic acid, or their salts to increase corrosion resistance. The chromate treatment is superior in the corrosion resistance and is an economic treatment method being easily applied.

Although the chromate treatment uses hexavalent chromium which is a substance under control of a pollution regulation, the hexavalent chromium does substantially not contaminate environment and human body because the hexavalent chromium is treated in a closed system during the treatment process to fully reduce the consumption and recover thereof, thus to prevent from releasing to natural environment, and because a sealing action of organic coating brings the chromium elusion from the chromate coating nearly zero. Nevertheless, recent global environmental concern increases the movement to independently diminish the use of heavy metals including the hexavalent chromium. Furthermore, to prevent pollution caused from the disposal of shredder dust of waste products, a movement has begun to eliminate or reduce the content of heavy metals in the products as far as possible.

Responding to the situation, many pollution-free treatment technologies independent of chromate treatment, or what is called the chromium-free technologies, have been introduced to prevent the generation of white rust on zinc-base plated steel sheets. Among these technologies, some methods using organic-base compounds and organic resins are provided. Examples of that type of technologies are:

(1) A method using tannic acid, (for example, JP-A-51-71233, (the term “JP-A” referred to herein signifies “Unexamined Japanese Patent Publication”)),

(2) A method using a thermosetting coating prepared by mixing an epoxy resin, an amino resin, and tannic acid, (for example, JP-A-63-91581),

(3) A method using a cheleting force of tannic acid, such as a method using a mixed composition of an water- base resin, an amino resin, and tannic acid, (for example, JP-A-8-325760),

(4) A method of surface treatment applying an aqueous solution of hydrazine derivative onto the surface of a tinplate or a galvanized sheet, (for example, JP-B-53-27694 and JP-B-56-10386, (the term “JP-B” referred to herein signifies “Examined Japanese Patent Publication”)),

(5) A method using a rust-preventive agent containing an amine-added salt prepared by adding an amine to a mixture of acylsarcosine and benzotriazole, (for example, JP-A-58-130284), and

(6) A method using a treating agent prepared by mixing a heterocyclic compound such as a benzothiazole compound and tannic acid, (for example, JP-A-57-198267).

The prior arts described above, however, have problems given below.

First, the methods (1) through (4) described above have a problem of corrosion resistance. A cause of the problem is that any of the methods does not have a self-repairing effect. That is, the chromate coating provides strong corrosion resistance by the synergy effect of (a) barrier effect, (a hindrance effect to the corrosion causes (water, oxygen, chlorine, or the like) by insoluble compounds (hydrate oxides) consisting mainly of trivalent chromium), and (b) self-repairing effect, (protective film forming effect at the origin of corrosion by hexavalent chromium). The conventional chromium-free technology can provide the barrier effect to some extent by using an organic resin or the like, but cannot realize strong corrosion resistance as the self-repairing effect because no self-repairing material substituting the hexavalent chromium is available.

The method (1) described above gives insufficient corrosion resistance, and fails to attain uniform appearance after the treatment. The method (2) described above does not particularly aim to directly form a rust-preventive coating of thin film (0.1 to 5 μm in thickness) on the surface of zinc-base or aluminum-base plating surface. Therefore, even if the method (2) is applied in a thin film shape onto the surface of zinc-base or aluminum-base plating, sufficient corrosion resistance cannot be attained. The method (3) described above also provides insufficient corrosion resistance.

The method (4) described above does not apply to a zinc-base or aluminum-base plated steel sheet. And, even when the method (4) is applied to a zinc-base or aluminum-base plated steel sheet, the obtained coating does not have a network structure so that the coating has no sufficient barrier performance, thus the corrosion resistance is insufficient. JP-B-53-23772 and JP-B-56-10386 disclose the mixing of a water-soluble polymer compound (a polyvinylalcohol, a maleic acid ester copolymer, an acrylic acid ester copolymer, and the like) in an aqueous solution of hydrazine derivative. However, simple mixture of an aqueous solution of hydrazine derivative and a water-soluble polymer compound cannot attain sufficient corrosion resistance.

The methods (5) and (6) described above do not aim to form a rust-preventive coating on the surface of a zinc-base or aluminum-base plated steel sheet within a short time. And, even if a treating agent is applied on the surface of plated steel sheet, excellent corrosion resistance cannot be attained because of lack of barrier performance to the corrosion causes such as oxygen and water. The method (6) described above also deals with the mixing with a resin (epoxy resin, acrylic resin, urethane resin, nitrocellulose resin, polyvinylchloride resin, or the like) as an additive. However, a simple mixture of a resin with a heterocyclic compound such as a benzothiazole compound cannot attain satisfactory corrosion resistance.

Under practical use conditions that give alkali degreasing at an approximate pH range of from 9 to 11 using spraying or the like to remove oil applied onto the surface during press-working or the like, all of the methods (1) through (6) have a problem of peeling or damaging the coating during the alkali degreasing process, thus failing to keep the corrosion resistance. Therefore, these methods are not suitable for practical use as a method to form rust-preventive coating.

### SUMMARY OF THE INVENTION

It is an object of the present invention to provide a steel sheet with organic coating, containing no heavy metals such as hexavalent chromium in the coating, being safe and non-harmful during the manufacturing process and during use, and providing excellent corrosion resistance.

To attain the object, the present invention provides a steel sheet having organic coating, comprising: a zinc or a zinc alloy plated steel sheet or an aluminum or an aluminum alloy plated steel sheet; a composite oxide coating formed on the surface of the plated steel sheet; and an organic coating formed on the composite oxide coating.

The composite oxide coating contains at least one metal selected from the group consisting of Mn and Al.

The organic coating contains at least one rust-preventive additive component selected from the group consisting of (a) through (i),

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate,

(f) at least one organic compound selected from the group consisting of a triazole, a thiol, a thiadiazole, a thiazole, and a thiuram,

(g) at least one substance selected from the group consisting of calcium and a calcium compound,

(h) at least one compound selected from the group consisting of a phosphate and a silicon oxide, and

(i) a Ca ion exchanged silica.

The composite oxide coating preferably has thicknesses of from 0.005 to 3 μm. The composite oxide coating preferably contains: (α) oxide fine particles, (β) at least one substance selected from the group consisting of a phosphate and a phosphoric acid compound, and (γ) at least one metal selected from the group consisting of Mn and Al. The component (α) contained in the composite oxide coating is preferably a silicon oxide. The composite oxide coating may further contain an organic resin.

At least one rust-preventive additive component selected from the group consisting of (a) through (i), being contained in the organic coating, is preferably any one of the following-given (1) through (7).

(1) (e) a molybdenate, (g) at least one substance selected from the group consisting of calcium and a calcium compound, and (h) at least one compound selected from the group consisting of a phosphate and a silicon oxide;

(2) (e) a molybdenate, and (i) a Ca ion exchanged silica;

(3) (f) at least one organic compound selected from the group consisting of a triazole, a thiol, a thiadiazole, a thiazole, and a thiuram, (g) at least one substance selected from the group consisting of calcium and a calcium compound, (h) at least one compound selected from the group consisting of a phosphate and a silicon oxide;

(4) (f) at least one organic compound selected from the group consisting of a triazole, a thiol, a thiadiazole, a thiazole, and a thiuram, and (i) a Ca ion exchanged silica;

(5) (e) a molybdenate, and (f) at least one compound selected from the group consisting of a triazole, a thiol, a thiadiazole, a thiazole, and a thiuram,

(6) (e) a molybdenate, (f) at least one organic compound selected from the group consisting of a triazole, a thiol, a thiadiazole, a thiazole, and a thiuram, (g) at least one substance selected from the group consisting of calcium and a calcium compound, and(h) at least one compound selected from the group consisting of a phosphate and a silicon oxide; and

(7) (e) a molybdenate, (f) at least one organic compound selected from the group consisting of a triazole, a thiol, a thiadiazole, a thiazole, and a thiuram, and (i) a Ca ion exchanged silica.

The organic coating preferably has thicknesses of from 0.1 to 5 μm.

The organic coating preferably contains a reaction product (X) obtained from a reaction between a film-forming organic resin (A) and a compound (B) containing activated hydrogen, at least a part of the compound (B) being consisting of a hydrazine derivative (C) containing activated hydrogen. The content of the rust-preventive additive component (Y) is preferably from 1 to 100 parts by weight (solid matter) to 100 parts by weight (solid matter) of the reaction product (X).

The film-forming organic resin (A) is preferably a resin (D) containing epoxy group.

The resin (D) containing epoxy group is preferably an epoxy resin expressed by the formula of:

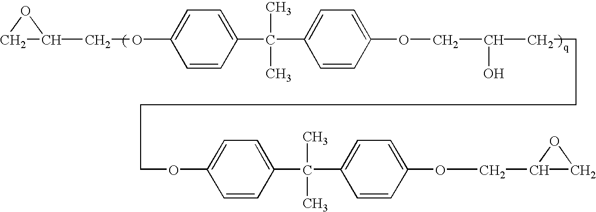

The hydrazine derivative (C) containing activated hydrogen is preferably a pyrazole compound containing activated hydrogen and/or a triazole compound containing activated hydrogen.

The content of the hydrazine derivative (C) containing activated hydrogen in the compound (B) containing activated hydrogen is preferably from 10 to 100 mole %.

The organic coating may further contain a solid lubricant (Z). The content of the solid lubricant (Z) is preferably from 1 to 80 parts by weight (solid matter) to 100 parts by weight (solid matter) of the reaction product (X).

The organic coating preferably consists essentially of an organic polymer resin (A) containing OH group and/or COOH group, as a base resin, and the content of the rust-preventive additive component (B) is preferably from 1 to 100 parts by weight (solid matter) to 100 parts by weight (solid matter) of the base resin.

The organic coating preferably further contains a solid lubricant (C), and the content of the solid lubricant (C) is preferably from 1 to 80 parts by weight (solid matter) to 100 parts by weight (solid matter) of the base resin.

The organic polymer resin (A) containing OH group and/or COOH group may be a thermosetting resin. The organic polymer resin (A) containing OH group and/or COOH group may be an epoxy resin and/or a modified epoxy resin.

The steel sheets with an organic coating according to the present invention are used for the steel sheets of electric equipment, building materials, and automobiles.

Furthermore, the present invention provides a steel sheet having organic coating, comprising:

a zinc or a zinc alloy plated steel sheet or an aluminum or an aluminum alloy plated steel sheet; a composite oxide coating being formed on the surface of the plated steel sheet and containing Mg; and

an organic coating formed on the composite oxide coating.

The organic coating contains at least one rust-preventive additive component selected from the group consisting of (a) through (f),

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one organic compound selected from the group consisting of a triazole, a thiol, a thiadiazole, a thiazole, and a thiuram.

At least one rust-preventive additive component selected from the group consisting of (a) through (f) is preferably any one of following given (1) and (2):

(1) (c) a calcium compound and a silicon oxide, (e) a molybdenate, and (f) at least one organic compound selected from the group consisting of a triazole, a thiol, a thiadiazole, a thiazole, and a thiuram; and

(2) (c) a calcium compound and a silicon oxide, and (f) at least one organic compound selected from the group consisting of a triazole, a thiol, a thiadiazole, a thiazole, and a thiuram.

The composite oxide coating preferably has thicknesses of from 0.005 to 3 μm. The composite oxide coating preferably contains: (α) oxide fine particles, (β) at least one substance selected from the group consisting of a phosphate and a phosphoric acid compound, and (γ) Mg.

The organic coating preferably has thicknesses of from 0.1 to 5 μm.

The organic coating preferably contains a reaction product (X) obtained from a reaction between a film-forming organic resin (A) and a compound (B) containing activated hydrogen, at least a part of the compound (B) being consisting of a hydrazine derivative (C) containing activated hydrogen. The content of the rust-preventive additive component (Y) is preferably from 1 to 100 parts by weight (solid matter) to 100 parts by weight (solid matter) of the reaction product (X).

The organic coating preferably further contains a solid lubricant, (Z), and the content of the solid lubricant (Z) is preferably from 1 to 80 parts by weight to 100 parts by weight of the reaction product (X).

The organic coating preferably consists essentially of an organic polymer resin (A) containing OH group and/or COOH group, as a base resin, and the content of the rust-preventive additive component (B) is preferably from 1 to 100 parts by weight (solid matter) to 100 parts by weight (solid matter) of the base resin.

The organic coating preferably further contains a solid lubricant (C), and the content of the solid lubricant (C) is preferably from 1 to 80 parts by weight (solid matter) to 100 parts by weight (solid matter) of the base resin.

The steel sheets having an organic coating according to the present invention are used for the steel sheets of electric equipment, building materials, and automobiles.

Furthermore, the present invention provides a method for manufacturing steel sheet with an organic coating comprising the steps of:

(a) preparing a zinc or a zinc alloy plated steel sheet or an aluminum or an aluminum alloy plated steel sheet;

(b) preparing a treating liquid containing (i) oxide fine particles, (ii) phosphoric acid and/or a phosphoric acid compound, and (iii) at least one substance selected from the group consisting of Mg, Mn, and Al;

(c) adjusting the treating liquid so as the molar concentration of the additive component (i), the total molar concentration of the additive component (ii) converted to P₂O₅, and the total molar concentration of the molar concentration of the additive component (iii) converted to the quantity of above-described metal, to the metal quantity to satisfy the molar ratio of (i)/(iii)=0.1 to 20, and of (iii)/(ii)=0.1 to 1.5;

(d) applying the treating liquid onto the plated steel sheet;

(e) forming a composite oxide film having thicknesses of from 0.005 to 3 μm onto the surface of plated steel sheet by heating to dry the plated steel sheet on which the treating liquid was applied;

(f) applying a coating composition for forming an organic coating onto the composite oxide coating; and

(g) forming an organic coating having thicknesses of from 0.1 to 5 μm by heating to dry the plated steel sheet on which the coating composition was applied.

The additive component (ii) in the treating liquid for forming the composite oxide film is preferably silicon oxide. The treating liquid for forming the composite oxide film preferably further contains an organic resin.

Furthermore, the present invention provides a treating liquid for forming a composite oxide coating that contains (i) oxide fine particles, (ii) phosphoric acid and/or a phosphoric acid compound, and (iii) at least one substance selected from the group consisting of Mg, Mn, and Al; wherein the molar concentration of the additive component (i), the total molar concentration of the additive component (ii) converted to P₂O₅, and the total molar concentration of the additive component (iii) converted to the quantity of above-described metal, to satisfy the molar ratio of (i)/(iii)=0.1 to 20, and of (iii)/(ii)=0.1 to 1.5;

The steel sheets having organic coating for building materials, household electric appliances, automobiles, and the like, that have excellent corrosion resistance, excellent coating appearance and coating adhesiveness, include the following-listed ones, adding to those described above.

(1) A steel sheet with organic coating, comprising a zinc-base plated steel sheet or an aluminum-base plated steel sheet, and an organic coating formed on the surface of the plated steel sheet;

(2) A steel sheet with organic coating, comprising a zinc-base plated steel sheet or an aluminum-base plated steel sheet, a chemical conversion coating formed on the surface of the plated steel sheet, and an organic coating formed on the chemical conversion coating; and

(3) A steel sheet with organic coating, comprising a zinc-base plated steel sheet or an aluminum-base plated steel sheet, a chromate coating formed on the surface of the plated steel sheet, and an organic coating formed on the chromate coating.

### EMBODIMENT TO CARRY OUT THE INVENTION

### Embodiment 1

The inventors of the present invention found a method to obtain a steel sheet with organic coating that induces no pollution and that gives extremely strong corrosion resistance without applying chromate treatment which may give bad influence on environment and on human body. The method is to form a specific composite oxide coating as the first coating layer on the surface of a zinc-base plated steel sheet or an aluminum-base plated steel sheet, then to form a specific chelete-forming resin coating as the second coating layer on the first coating layer, while blending an adequate amount of a specific self-repairing material (rust-preventive additive component) substituting the hexavalent chromium in the chelete-forming resin coating.

Basic features of the present invention are: forming a composite oxide coating as the first coating layer which contains, (preferably contains as the major component), (α) oxide fine particles, (β) at least one substance selected from the group consisting of a phosphate and a phosphoric acid compound, and (γ) at least one metal selected from the group consisting of Mg, Mn, and Al, (including the case of being contained as a compound and/or a composite compound); further forming an organic coating as the second coating layer on the first layer, which second coating layer is prepared by reacting a film-forming organic resin (A) with a compound (B) containing activated hydrogen consisting of a hydrazine derivative (C) all of which or a part of which contains activated hydrogen, to add the hydrazine derivative (C) as a chelete-forming group to the film-forming resin (A), thus to use the chelete-forming resin (a reaction product) as the base resin, and blending a self-repairing material (rust-preventive additive) consisting any one of: (a) a Ca ion exchanged silica and a phosphate, (b) a Ca ion exchanged silica, a phosphate, and a silicon oxide, (c) a calcium compound and a silicon oxide, (d) a calcium compound, a phosphate, and a silicon oxide, (e) a molybdenate, (f) at least one organic compound selected from the group consisting of a triazole, a thiol, a thiadiazole, a thiazole, and a thiuram; or (e) and/or (f) blended with other component.

The first and second coating layers give superior rust-preventive effect to that of conventional chromium-free coating, even when they are used separately. The present invention, however, adopts both of them as a lower layer and an upper layer, respectively, to form a two-layer structure. Thus, the synergy effect of the two-layer structure with a small coating film thickness provides high corrosion resistance comparable with that of the chromate coating. Although the detail mechanism of the two-layer coating structure consisting of that type of specific composite oxide coating and organic coating is not fully analyzed, the following-described interaction of corrosion suppression of individual coating films should give the excellent effect.

The corrosion resistance mechanism of the composite oxide coating as the above-described first coating layer is not fully analyzed. However, the excellent corrosion resistance is attained presumably from the effects that (1) the dense and insoluble composite oxide coating seals the corrosion cause elements as a barrier film; (2) the fine oxide particles such as those of silicon oxide form a stable and dense barrier film together with phosphoric acid and/or a phosphoric acid compound and at least one metal selected from the group consisting of Mg, Mn, and Al; and (3) if the fine oxide particles are those of silicon oxide, the silicate ion enhances the formation of basic zinc chloride under a corrosion environment, thus improving the barrier performance.

The corrosion resistance mechanism of the organic coating as the above-described second coating layer is also not fully analyzed. The mechanism is, however, supposedly the one described below. By adding a hydrazine derivative, not a simple low molecular weight cheleting agent, to the film-forming organic resin, there is induced the action effect (barrier effect) of (1) obtaining an effect to seal the corrosion cause elements such as oxygen and chlorine ions owing to the dense organic polymer film, and (2) forming a passivation layer through a stable and strong bonding of the hydrazine derivative to the surface of the first coating layer, thus giving excellent corrosion resistance.

When particularly a resin containing epoxy group is applied as the film-forming organic resin (A), the reaction between the epoxy group contained resin and a crosslinking agent forms a dense barrier film, which barrier film has excellent performance to prevent permeation of corrosion cause elements such as oxygen. In addition, the hydroxyl group in molecule provides strong bonding force to the base material. These functions give particularly strong corrosion resistance (barrier performance).

Furthermore, by using a pyrazole compound having activated hydrogen and/or a triazole compound having activated hydrogen as the hydrazine derivative (C) having activated hydrogen, stronger corrosion resistance (barrier performance) is attained.

Simple blending of a hydrazine derivative to a film-forming organic resin, as practiced in prior art, gives very little effect of improved corrosion suppression. A presumable reason is that the hydrazine derivative lacking the film-forming organic resin in the molecule thereof should fail in forming a dense barrier layer owing to the low molecular weight of the chelete compound, though the derivative forms a chelete compound with a metal in the first coating layer. To the contrary, by introducing a hydrazine derivative into the molecule of the film-forming organic resin, according to the present invention, very strong effect of corrosion suppression is attained.

The steel sheet with organic coating according to the present invention provides particularly excellent corrosion preventive performance (self-repairing effect) by blending an adequate amount of a rust-preventive additive (Y) (self-repairing material) to the organic coating consisting of above-described specific reaction products, which rust-preventive additive composition (Y) contains:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one organic compound selected from the group consisting of a triazole, a thiol, a thiadiazole, a thiazole, and a thiuram;

or (e) and/or (f) further containing other component. The corrosion preventive mechanism obtained by blending the components (a) through (f) into the specific organic coating is supposedly the following.

The components (a) through (d) give the self-repairing performance by their precipitation action, and the reaction mechanism presumably proceeds in a sequence of following-described steps.

[First step]

Under a corrosive environment, calcium which is less noble than zinc and aluminum, which are the plating metals, preferentially dissolves.

[Second step]

For the case of phosphate, the phosphoric acid ion dissociated by hydrolysis induces a complex-forming reaction with the calcium ion preferentially dissolved in the first step. For the case of silicon oxide, the calcium ion preferentially dissolved in the first step is adsorbed to the surface of the silicon oxide, which then electrically neutralizes the surface charge to coagulate the silicon oxide particles. As a result, for both cases, a dense and insoluble protective film is formed to seal the origin of corrosion, thus to suppress the corrosion reactions.

The component (e) gives the self-repairing performance by the passivation effect. That is, under a corrosive environment, the component (e) forms a dense oxide on the surface of the plated coating together with the dissolved oxygen, which dense oxide seals the origin of corrosion to suppress the corrosion reactions.

The component (f) generates the self-repairing performance by the adsorption effect. That is, zinc and aluminum eluted by corrosion are adsorbed by polar groups containing nitrogen and sulfur, existing in the component (f), to form an inert film, which film seals the origin of corrosion to suppress the corrosion reactions.

Also for the case that the components (a) through (f) are blended in ordinary organic coating, corrosion preventive effect can be obtained to some extent. However, by blending the self-repairing materials of above-described (a) through (f) in the organic coating consisting of a specific chelete-modified resin having excellent barrier performance, as in the case of the present invention, the effect of both of the barrier performance and the self-repairing effect presumably combines to give very strong corrosion preventive effect.

Considering the self-repairing effect obtained by each component of (a) through (d), (e), and (f), to obtain stronger self-repairing performance, it is preferable to adopt the (e) and/or (f) as the essential component and to blend a rust-preventive component (Y) consisting of compounds given below. In particular, the cases of (6) and (7) provide the highest self-repairing performance (or white rust resistance).

(1) A rust-preventive component prepared by blending (e) a molybdenate, (g) at least one substance selected from the group consisting of calcium and a calcium compound, and (h) at least one compound selected from the group consisting of a phosphate and a silicon oxide.

(2) A rust-preventive component prepared by blending (e) a molybdenate, and (i) a Ca ion exchanged silica.

(3) A rust-preventive component prepared by blending (f) at least one organic compound selected from the group consisting of a triazole, a thiol, a thiadiazole, a thiazole, and a thiuram, (g) at least one substance selected from the group consisting of calcium and a calcium compound, (h) at least one compound selected from the group consisting of a phosphate and a silicon oxide.

(4) A rust-preventive component prepared by blending (f) at least one organic compound selected from the group consisting of a triazole, a thiol, a thiadiazole, a thiazole, and a thiuram, and (i) a Ca ion exchanged silica.

(5) A rust-preventive component prepared by blending (e) a molybdenate, and (f) at least one organic compound selected from the group consisting of a triazole, a thiol, a thiadiazole, a thiazole, and a thiuram.

(6) A rust-preventive component prepared by blending (e) a molybdenate, (f) at least one organic compound selected from the group consisting of a triazole, a thiol, a thiadiazole, a thiazole, and a thiuram, (g) at least one substance selected from the group consisting of calcium and a calcium compound, and (h) at least one compound selected from the group consisting of a phosphate and a silicon oxide.

(7) A rust-preventive component prepared by blending (e) a molybdenate, (f) at least one organic compound selected from the group consisting of a triazole, a thiol, a thiadiazole, a thiazole, and a thiuram, and (i) a Ca ion exchanged silica.

The following is the detail description of the present invention and the description about the reason to limit the conditions.

Examples of applicable zinc or zinc alloy plated steel sheet as the base of the steel sheet with organic coating according to the present invention are a galvanized steel sheet, a Zn—Ni alloy plated steel sheet, a Zn—Fe alloy plated steel sheet (an electrolytic plated steel sheet and an alloyed hot dip galvanized steel sheet), a Zn—Cr alloy plated steel sheet, a Zn—Mn alloy plated steel sheet, a Zn—Co alloy plated steel sheet, a Zn—Co—Cr alloy plated steel sheet, a Zn—Cr—Ni alloy plated steel sheet, a Zn—Cr—Fe alloy plated steel sheet, a Zn—Al alloy plated steel sheet (for example, a Zn-5% Al alloy plated steel sheet and Zn-55% Al alloy plated steel sheet), a Zn—Mg alloy plated steel sheet, a Zn—Al—Mg plated steel sheet, further a zinc or a zinc alloy composite plated steel sheet prepared by dispersing a metal oxide, a polymer, or the like into the coating of any one of the above-listed plated steel sheets (for example, a Zn—SiO₂ dispersion plated steel sheet).

As of the above-described coating, two or more layers of the same kind or different kinds can be plated to form a multilayer plated steel sheet.

As for the aluminum or aluminum alloy plated steel sheet as the base of the steel sheet with organic coating according to the present invention, an aluminum plated steel sheet or an Al—Si alloy plated steel sheet can be used.

For the plated steel sheet, small coating weight of Ni and the like may be applied onto the steel sheet in advance, and various kinds of plating described above may be applied on the Ni-plated steel sheet.

The plating method may be either of the electrolytic method (electrolysis in an aqueous solution or in a non-aqueous solution) and the gas phase method.

To prevent the occurrence of coating defects and irregularity on forming a two-layer coating (described later) onto the surface of the plated film, preliminary treatment of alkali degreasing, solvent degreasing, surface treatment (treatment of alkaline surface and treatment of acidic surface) and the like may be applied to the surface of the plating film, at need. To prevent the occurrence of blacking (a kind of oxidization on the surface of the plating film) on the steel sheet with organic coating under a use environment, surface treatment by an acidic or alkaline aqueous solution containing iron group metallic ions (Ni ion, Co ion, Fe ion) can be applied onto the surface of the plating film, in advance, at need. When an electrolytic galvanized plated steel sheet is used as the base steel sheet, an iron group metallic ions (Ni ion, Co ion, Fe ion) can be added to the electrolytic plating bath to prevent the blacking, and these metallic ions can be included in the plated film by 1 ppm or more. In that case, there is no specific upper limit of the iron group metal concentration in the plated film.

The following is the description of the composite oxide coating as the first layer coating formed on the surface of a zinc-base plated steel sheet or an aluminum-base plated steel sheet.

The composite oxide coating is quite different from the alkali silicate treated coating represented by a conventional coating composition consisting of lithium oxide and silicon oxide, the composite oxide coating contains (preferably contains as the main components):

(α) oxide fine particles (preferably those of silicon oxide),

(β) a phosphate and/or a phosphoric acid compound, and

(γ) at least one metal selected from the group consisting of Mg, Mn, and Al, (including the case of containing as a compound and/or a composite compound).

The oxide fine particles as the above-described (α) are preferably those of silicon oxide (SiO₂ fine particles). As of the silicon oxide, colloidal silica is most preferable.

Examples of the colloidal silica are: the products of Nissan Chemical Industries, Ltd., namely, Snowtex O, Snowtex OS, Snowtex OXS, Snowtex OUP, Snowtex AK, Snowtex 040, Snowtex OL, Snowtex OL40, Snowtex OZL, Snowtex XS, Snowtex S, Snowtex NXS, Snowtex NS, Snowtex N, and Snowtex QAS-25; the products of Catalysts & Chemicals Ind. Co., Ltd., namely, Cataloyd S, Cataloyd SI-350, Cataloyd SI-40, Cataloyd SA, and Cataloyd SN; and the products of Asahi Denka Kogyo KK., namely, Adelite AT-20 through 50, Adelite AT-20N, Adelite AT-300, Adelite AT-300S, and Adelite AT20Q.

As of the silicon oxides given above, the ones having particle sizes of 14 nm or smaller are preferable, and 8 nm or smaller are more preferable in view of the corrosion resistance.

The silicon oxide may be the one prepared by dispersing dry silica fine particles in a solution of coating composition. Examples of preferable dry silica are the products of Nippon Aerosil Co., Ltd., namely, Aerosil 200, Aerosil 3000, Aerosil 300CF, and Aerosil 380, and the one having particle sizes of 12 nm or smaller are preferable, and 7 nm or smaller are more preferable.

Applicable examples of the oxide fine particles are, other than the above-described silicon oxides, a colloidal solution and fine particles of aluminum oxide, zirconium oxide, titanium oxide, cerium oxide, and antimony oxide.

From the standpoint of corrosion resistance and of weldability, preferable coating weight of the above-described component (α) is in a range of from 0.01 to 3,000 mg/m², more preferably from 0.1 to 1,000 mg/m², and most preferably from 1 to 500 mg/m².

The phosphoric acid and/or phosphoric acid compound as the above-described component (β) can be prepared, for example, by adding one or more of metallic salt or compound of orthophosphoric acid, diphosphoric acid, polyphosphoric acid, metha-phosphoric acid, or the like to the coating composition as the blend of coating components. Furthermore, one or more of organic phosphoric acid and its salt (for example, phytic acid, phytic acid salt, phsophonic acid, phosphonic acid salt, and their metallic salt) may be added to the coating composition. Among them, primary phosphates are preferable in view of stability of the solution of coating composition.

The existing mode of phosphoric acid and phosphoric acid compound in the coating is not specifically limited, and they may be in crystal or amorphous state. Also the ionicity and solubility of the phosphoric acid and phosphoric acid compound in the coating are not specifically limited.

From the viewpoint of corrosion resistance and of weldability, a preferable coating weight of the above-described component (β) is in a range of from 0.01 to 3,000 mg/m² as P₂O₅ converted value, more preferably from 0.1 to 1,000 mg/m², and most preferably from 1 to 500 mg/m².

The existing mode of one or more of the metals selected from the group consisting of Mg, Mn, and Al, as the above-described component (γ), is not specifically limited, and they may be in a form of metal, or compound or composite compound of oxide, hydroxide, hydrate, phosphoric acid compound, or coordinated compound. The ionicity and solubility of these compound, oxide, hydroxide, hydrate, phosphoric acid compound, and coordinated compound are also not specifically limited.

The method to introduce the component (γ) into the coating may be the addition of Mg, Mn, and Al as phosphate, sulfate, nitrate, and chloride to the coating composition.

From the standpoint of corrosion resistance and prevention of degradation in appearance, a preferable coating weight of the above-described component (γ) is in a range of from 0.01 to 1,000 mg/m² as metal converted value, more preferably from 0.1 to 500 mg/m², and most preferably from 1 to 100 mg/m².

A preferable molar ratio of (α) oxide fine particles to (γ) one or more metal (including the case of being contained as a compound and/or composite compound) selected from the group consisting of Mn, Mn, and Al, (α)/(γ), as the structure components of composite oxide coating, (the component (γ) is the metal converted value of the above-described metal), is in a range of from 0.1 to 20, more preferably from 0.1 to 10. If the molar ratio (α)/(γ) is less than 0.1, the effect of addition of the oxide fine particles is not fully attained. If the ratio (α)/(γ) exceeds 20, the oxide fine particles hinder the densification of the coating.

A preferable molar ratio of the (β) phosphoric acid and/or a phosphoric acid compound to (γ) at least one metal selected from the group consisting of Mg, Mn, and Al, (including the case of existence in a form of compound and/or composite compound), (γ)/(γ), (the component (γ) is as P₂O₅ converted value, and the component (γ) is as metal converted value of the above-given metal), is in a range of from 0.1 to 1.5. If the molar ratio is less than 0.1, the soluble phosphoric acid damages the insolubleness of the composite oxide coating, and degrades the corrosion resistance thereof, which is unfavorable. If the molar ratio exceeds 1.5, stability of the treating liquid significantly decreases, which is also unfavorable.

Aiming at the improvement of workability and corrosion resistance of coating, the composite oxide coating may further contain an organic resin. Examples of the organic resin are one or more of epoxy resin, urethane resin, acrylic resin, acrylic-ethylene resin, acrylic-styrene copolymer, alkyd resin, polyester resin, and ethylene resin. They can be introduced to the coating in a form of water-soluble resin and/or water-dispersible resin.

Adding to these water-base resins, parallel use of a water-soluble epoxy resin, a water-soluble phenol resin, a water-soluble butadiene rubber (SBR, NBR, MBR), a melamine resin, a block isocyanate compound, and an oxazoline compound, as the crosslinking agent, is effective.

As an additive to further improve the corrosion resistance, the composite oxide coating may further contain one or more of a polyphosphate, a phosphate (for example, zinc phosphate, dihydrogen aluminum phosphate, zinc phosphate), a molybdenate, a phosphomolybdate (for example, aluminum phosphomolybdate), an organic acid and a salt thereof (for example, phitic acid, phitic acid salt, phosphonic acid, phosphonate, metallic salt of them, and alkali metal salt), an organic inhibitor (for example, hydrazine derivative, thiol compound, dithiocarbamate), and an organic compound (for example, polyethyleneglycol).

Examples of other additive are one or more of an organic colored pigment (for example, condensation polycyclic-base organic pigment, a phthalocyanine base organic pigment), a colored dye (for example, organic solvent soluble azo-base dye and water-soluble azo-base metallic dye), an inorganic pigment (for example, titanium oxide), a cheleting agent (for example, thiol), a conductive pigment (for example, metallic powder such as that of zinc, aluminum, and nickel, iron phosphide, antimony dope type tin oxide), a coupling agent (for example, silane coupling agent and titanium coupling agent), and a melamine-cyanuric acid additive.

To prevent blacking (a kind of oxidization phenomena on the surface of plating) of a steel sheet with organic coating under use environments, the composite oxide coating may further contain one or more of iron-base metallic ions (Ni ion, Co ion, Fe ion). Among these metallic ions, Ni ion is most preferable. In that case, favorable effect is attained at 1/10,000 M or more of the iron-base metallic ion concentration to 1 M (metal converted value) of the component (γ) in the treating composition. Although the upper limit of the iron-base ion concentration is not specifically specified, a favorable level thereof is to a degree that does not give influence on the corrosion resistance under increasing concentration condition. And, a preferable level thereof is 1 M to the component (γ) (metal converted value), more preferably around 1/100 M.

A preferable thickness of the composite oxide coating is in a range of from 0.005 to 3 μm, more preferably from 0.01 to 2 μm, still further preferably from 0.1 to 1 μm, and most preferably from 0.2 to 5 μm. If the thickness of the composite oxide coating is less than 0.005 μm, the corrosion resistance degrades. If the thickness thereof exceeds 3 μm, the conductivity including weldability degrades. When the composite oxide coating is defined by the coating weight thereof, it is adequate to select the total coating weight of the above-described component (α), the above-described component (β) converted to P₂O₅, and above-described component (γ) converted to metal, in a range of from 6 to 3,600 mg/m², more preferably from 10 to 1,000 mg/m², still more preferably from 50 to 500 mg/m², still further preferably from 100 to 500 mg/m², and most preferably from 200 to 400 mg/m². If the total coating weight is less than 6 mg/m², the corrosion resistance degrades. If the total coating weight exceeds 3,600 mg/m², the conductivity reduces to degrade the weldability.

The following is the description of the organic coating formed as the second coating layer on the above-described composite oxide coating.

According to the present invention, the organic coating formed on the composite oxide coating is the one having thicknesses of from 0.1 to 5 μm, comprising a reaction product (X) obtained from the reaction between a film-forming organic resin (A) and a compound (B) containing activated hydrogen consisting of a hydrazine derivative (C) a part or whole of the compound thereof having activated hydrogen, and a self-repairing material of rust-preventive additive component (Y) of either one of the following-given (a) through (f), or a rust-preventive additive component (Y) blending other components to the above-given (e) and/or (f), further, at need, a solid lubricant:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and silicon oxide,

(e) a molybdenate, and

(f) at least one organic compound selected from the group consisting of a triazole, a thiol, a thiadiazole, a thiazole, and a thiuram.

Applicable film-forming organic resin (A) is not specifically limited if only the resin can react with a compound (B) containing activated hydrogen, a part of or whole of the compound consisting of a hydrazine derivative (C), to bond the compound (B) containing activated hydrogen to the film-forming organic resin by reactions such as addition reaction and condensation reaction, and can adequately form the coating. Examples of the film-forming organic resin (A) are an epoxy resin, a modified epoxy resin, a polyurethane resin, a polyester resin, an alkyd resin, an acrylic-base copolymer resin, a polybutadiene resin, a phenol resin, and an additive or a condensate of these resins. Single or mixture of two or more of them can be applied.

From the viewpoint of reactivity, easiness of reaction, and corrosion prevention, a particularly preferable film-forming organic resin (A) is an epoxy group contained resin (D) having epoxy group within the resin. The epoxy group contained resin (D) is not specifically limited if only the resin (D) can react with a compound (B) containing activated hydrogen consisting of a hydrazine derivative (C) a part of or whole of the compound containing activated hydrogen, thus the compound (B) containing activated hydrogen bonds to the film-forming organic resin by the reactions such as addition and condensation, and can adequately form the coating. Examples of the epoxy group contained resin (D) are epoxy resin, modified epoxy resin, acrylic-base copolymer prepared by copolymerization with epoxy group contained monomer, polyurethane resin containing epoxy group, and additive or condensate of these resins. Single or mixture of two or more of them can be applied.

As of these epoxy group contained resins (D), epoxy resins and modified epoxy resins are particularly preferable from the standpoint of adhesiveness with plating surface and of corrosion resistance.

Examples of the above-described epoxy resin are: an aromatic epoxy resin which is prepared by reacting a polyphenol such as Bisphenol A, Bisphenol F, and novolak type phenol with epihalohydrin such as epichlorohydrin to introduce glycidyl group, or which is prepared by further reacting polyphenol to the glydidyl group introduced reaction product to increase the molecular weight; an aliphatic epoxy resin; and an alicyclic epoxy resin. Single or mixture of two or more of them can be applied. That kind of epoxy resin is preferably the one having number average molecular weights of 1,500 or more if the film-forming performance under low temperatures is required.

The above-described modified epoxy resins include the resins prepared by reacting the epoxy group or hydroxyl group in the above-given epoxy resins with various kinds of modifiers. Examples of these modified epoxy resin are: an epoxy-ester resin prepared by reacting a dry oil fatty acid; an epoxy-acrylate resin prepared by modifying using a polymerizable unsaturated monomer component containing acrylic acid, methacrylic acid, and the like; and an urethane modified epoxy resin prepared by reacting with isocyanate compound.

The acrylic-base copolymer resin prepared by copolymerizing with the above-described epoxy group contained monomer includes a resin synthesized by solution polymerization, emulsion polymerization, or suspension polymerization between unsaturated monomer containing epoxy group and polymerizable unsaturated monomer component consisting essentially of acrylate or methacrylate.

Examples of the above-described polymerizable unsaturated monomer component are: C1-C24 alkylester of acrylic acid or methacrylic acid such as methyl(meth)acrylate, ethyl(meth)acrylate, propyl(meth)acrylate, n-, iso-, or ter-butyl(meth)acrylate, hexyl(meth)acrylate, 2-ethylhexyl (meth)acrylate, decyl(meth)acrylate, lauryl(meth)acrylate; C1-C4 alkyletherified compound such as acrylic acid, methacrylic acid, styrene, vinyltoluene, acrylamide, acrylonitrile, N-methylol(meth)acrylamide, N-methylol(meth)acrylamide; and N,N-diethylaminoethylmethacrylate.

The unsaturated monomer containing epoxy group is not specifically limited if only the unsaturated monomer has an epoxy group and a polymerizable unsaturated group, such as glycidylmethacrylate, glycidylacrylate, 3,4-epoxycyclohexylmethyl(meth)acrylate.

The acrylic-base copolymer resin copolymerized with the epoxy group contained monomer may be a resin which was modified by polyester resin, an epoxy resin, a phenol resin, or the like.

A particularly preferable epoxy resin described above is a resin of a reaction product between Bisphenol A and epihalohydrin, having a chemical structure expressed by the formula (1). That type of epoxy resin is particularly preferred owing to the excellent corrosion resistance.

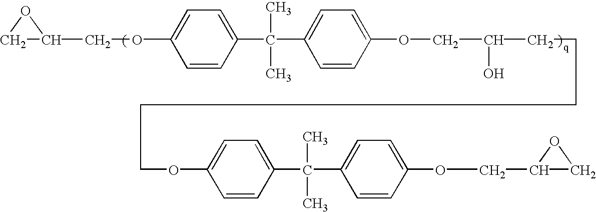

The method for manufacturing that type of Bisphenol A type epoxy resin is widely known in the related industries. In the above-given chemical structural formula, q denotes from 0 to 50, preferably from 1 to 40, more preferably from 2 to 20.

The film-forming organic resin (A) may be organic solvent dissolving type, organic solvent dispersion type, water-soluble type, or water dispersing type.

The present invention aims at the addition of a hydrazine derivative to the molecule of film-forming organic resin (A). To do this, at least a part of (preferably whole of) the compound (B) containing activated hydrogen shall be a hydrazine derivative (C) containing activated hydrogen.

When the film-forming organic resin (A) is an epoxy group containing resin, applicable compound (B) containing activated hydrogen reacting with the epoxy group includes the following-listed ones, one or more of them can be applied. In this case, also, at least a part of (preferably whole of) the compound (B) containing activated hydrogen is necessary a hydrazine derivative containing activated hydrogen.

A hydrazine derivative containing activated hydrogen

A primary or secondary amine compound containing activated hydrogen

Ammonia and an organic acid such as carboxylic acid

A halogenized hydrogen such as hydrogen chloride

An alcohol, a thiol

A hydrazine derivative containing no activated hydrogen or a quaternary chlorinating agent of a mixture of ternary amine and acid

Examples of the above-described hydrazine derivative (C) containing activated hydrogen are the following.

(1) A hydrazide compound such as carbohydrazide, hydrazide propionate, hydrazide salicylate, dihydrazide adipate, dihydrazide cebacylate, dihydrazide dodecanate, dihydrazide isophthalate, thiocarbohydrazide, 4,4′-oxybisbenzenesulfonylhydrazide, benzophenone hydrazone, and aminopolyacrylamide.

(2) A pyrazole compound such as pyrazole, 3,5-dimethylpyrazole, 3-methyl-5-pyrazolone, and 3-amino-5-methylpyrazole.

(3) A triazole compound such as 1,2,4-triazole, 3-amino-1,2,4-triazole, 4-amino-1,2,4-triazole, 3-mercapto-1,2,4-triazole, 5-amino-3-mercapto-1,2,4-triazole, 2,3-dihydro-3-oxo-1,2,4-triazole, 1H-benzotriazole, 1-hydroxydibenzotriazole (mono-hydrate), 6-methyl-8-hydroxytriazolopyridazine, 6-phenyl-8-hydroxytriazolopyridazine, and 5-hydrox-7-methyl-1,3,8-triazaindolyzine.

(4) A tetrazole compound such as 5-phenyl-1,2,3,4-tetrazole and 5-mercapto-1-phenyl-1,2,3,4-tetrazole.

(5) A thiadiazole compound such as 5-amino-2-mercapto-1,3,4-thiadiazole and 2.5-dimercapto-1,3,4-thiadiazole.

(6) A pyridazine compound such as hydrazide maleate, 6-methyl-3-pyridazone, 4,5-dichloro-3-pyridazone, 4,5-dibromo-3-pyridazone, and 6-methyl-4,5-dihydro-3-pyridazone.

As of these, particularly suitable ones are pyrazole compounds and triazole compounds having five-membered ring structure or six-membered ring structure and having nitrogen atom in the cyclic structure.

These hydrazine derivatives may be used separately or in mixture of two or more of them.

Typical examples of above-described amine compound having activated hydrogen that can be used as a part of the compound (B) containing activated hydrogen are the following.

(1) A compound prepared by modifying a primary amino group in an amine compound containing one secondary amino group and one or more of primary amino group, such as diethylenetriamine, hydroxyethylaminoethylamine, ethylaminoethylamine, and methylaminopropylamine, reacting with a ketone, an aldehyde, or a carboxylic acid, by heating to, for example, about 100 to 230° C., thus forming aldimine, ketimine, oxazoline, or imidazoline.

(2) A secondary monoamine such as diethylamine, diethanolamine, di-n- or -iso-propanolamine, N-methylethanolamine, and N-ethylethanolamine.

(3) A secondary amine containing compound such as the one prepared by the Michael addition reaction of a mono-alkanol such as monoethanolamine with dialkyl(meth)acrylic amide.

(4) A compound prepared by modifying primary amino group of an alkanol amine such as monoethanolamine, neopentanolamine, 2-aminopropanol, 3-aminopropanol, and 2-hydroxy-2′(aminopropoxy)ethylether into ketimine.

The above-described quaternary chlorinating agent which can be used as a part of the compound (B) containing activated hydrogen is formed in a mixture with an acid to let the agent react with epoxy group, because the hydrazine derivative containing no activated hydrogen or the ternary amine do not have reactivity with epoxy group. The quaternary chlorinating agent reacts with epoxy group under the presence of water, at need, to form a quaternary salt with an epoxy group containing resin.

The acid used to obtain the quaternary chlorinating agent may be an organic acid such as butylic acid, acetic acid, and lactic acid, or may be an inorganic acid such as hydrochloric acid. An example of the hydrazine derivative containing activated hydrogen used to obtain the quaternary chlorinating agent is 3,6-dichloropyridazine. Examples of the ternary amine are dimethylethanolamine, triethylamine, trimethylamine, truisopropylamine, and methyldiethanolamine.

The reaction product (X) obtained from the reaction between the film-forming organic resin (A) and the compound (B) containing activated hydrogen consisting of the hydrazine derivative (C) a part of or whole of the compound thereof having activated hydrogen is prepared by reacting the film-forming organic resin (A) with the compound (B) containing activated hydrogen for about 1 to 8 hours at temperatures of from 10 to 300° C., preferably from 50 to 150° C.

The reaction may be conducted adding an organic solvent, and the kind of the applied organic solvent is not specifically limited. Examples of the organic solvent are: ketones such as acetone, methylethylketone, methylisobutylketone, dibutylketone, and cyclohexanone; alcohols and ethers containing hydroxyl group, such as ethanol, butanol, 2-ethylhexylalcohol, benzylalcohol, ethyleneglycol, ethyleneglycolmonoisopropylether, ethyleneglycolmonobutylether, ethyleneglycolmonohexylether, propyleneglycol, propyleneglycolmonomethylether, diethyleneglycol, diethyleneglycolmonoethylether, and diethyleneglycolmonobutylether; esters such as ethylacetate, butylacetate, and ethyleneglycolmonobutylether acetate; and aromatic hydrocarbons such as toluene and xylene. These solvents may be used separately or as a mixture of two or more of them. As of these solvents, ketones or ethers are particularly preferred in view of solubility in epoxy resin and of coating formability.

The blending ratio of the film-forming organic resin (A) to the compound (B) containing activated hydrogen consisting of the hydrazine derivative (C) a part of or whole of the compound thereof containing activated hydrogen is preferably 0.5 to 20 parts by weight (solid matter) of the compound (B) containing activated hydrogen to 100 parts by weight (solid matter) of the film-forming organic resin (A), more preferably from 1.0 to 10 parts by weight.

When the film-forming organic resin (A) is an epoxy group containing resin (D), the blending ratio of the epoxy group containing resin (D) to the compound (B) containing activated hydrogen is 0.01 to 10 of the number of activated hydrogen groups in the compound (B) containing activated hydrogen to the number of epoxy groups of the epoxy group containing resin (D), [the number of activated hydrogen groups/the number of epoxy groups], more preferably from 0.1 to 8, and most preferably from 0.2 to 4, in view of corrosion resistance.

The percentage of the hydrazine derivative (C) containing activated hydrogen in the compound (B) containing activated hydrogen is 10 to 100 mole %, preferably 30 to 100 mole %, and most preferably 40 to 100 mole %. If the percentage of the hydrazine derivative (C) containing activated hydrogen is less than 10 mole %, the organic coating cannot attain sufficient rust-preventive function, and the obtained rust-preventive effect is not so different from that obtained from a simple mixture of a film-forming organic resin with a hydrazine derivative.

According to the present invention, it is preferable that a curing agent is blended in the resin composition, and that the organic coating is heated to cure to form a dense barrier coating.

Adequate methods for curing to form a resin composition coating include (1) a curing method utilizing the urethanation reaction between isocyanate and hdyroxyl group in the base resin, and (2) a curing method utilizing the etherification reaction between hydroxyl group in the base resin and an alkyletherified amino resin prepared by reacting a monohydric alcohol having 1 through 5 carbon atoms with a part or whole of a methylol compound obtained from the reaction between formaldehyde and at least one compound selected from the group consisting of melamine, urea, and benzoguanamine. As of these methods, it is particularly preferable that the urethanation reaction between isocyanate and hydroxyl group in the base resin is selected as the main reaction.

The polyisocyanate compound used in the above-described curing method (1) may be an aliphatic, alicyclic (including heterocyclic), or aromatic isocyanate compound, which contains at least two isocyanate groups in a single molecule, or a compound prepared by partially reacting the compound with polyalcohol. Examples of that type of polyisocyanate compound are the following.

(1) m- or p-Phenylenediisocyanate, 2,4- or 2,6-trilenediisocyanate, o- or p-xylylenediisocyanate, hexamethylenediisocyanate, dimer acid diisocyanate, and isophoronediisocyanate.

(2) Reaction product obtained from the reaction between separate or mixture of the above-given (1) compounds and a polyalcohol (dihydric alcohol such as ethyleneglycol and propyleneglycol; trihydric alcohol such as glycerin and trimethylolpropane; tetrahydric alcohol such as pentaerithritol, and hexahydric alcohol such as dipentaerithritol), leaving at least two isocyanates in a single molecule.

These polyisocyanate compounds may be used separately or mixing two or more of them together.

Examples of the protective agent (block agent) of the polyisocyanate compounds are the following.

(1) Aliphatic monoalcohols such as methanol, ethanol, propanol, butanol, and octylalcohol.

(2) Monoethers such as ethyleneglycol and/or diethyleneglycol, including monoethers of methyl, ethyl, propyl (n-, iso), and butyl (n-, iso, sec).

(3) Aromatic alcohols such as phenol and cresol.

(4) Oximes such as acetoxime and methylethylketone oxime.

By reacting one or more of these protective agents with the above-described polyisocyanate compounds, the polyisocyanate compounds which are stably protected at least at normal temperature are obtained.

That kind of polyisocyanate compound (E) is preferably blended as the curing agent into the film-forming organic resin (A) at ratios, (A)/(E), of from 95/5 to 55/45 (weight ratio of non-volatile matter),more preferably from90/10 to 65/35. Since polyisocyanate compounds are hygroscopic, the blending ratio exceeding (A)/(E) of 55/45 degrades the adhesiveness of the organic coating. Furthermore, coating on the organic film induces migration of non-reacted polyisocyanate compounds into the coating to result in hindrance of curing of the coating and in insufficient adhesiveness of the coating. Therefore, the blending ratio of the polyisocyanate compound (E) is preferably not more than (A)/(E)=55/45.

The film-forming organic resin (A) sufficiently crosslinks by the addition of the above-described crosslinking agent (curing agent). To further increase the low temperature crosslinking performance, it is preferred to use a known curing enhancing catalyst. Examples of the curing enhancing catalyst are N-ethylmorphorine, dibutyltindilaurate, cobalt naphthanate, tin(II)chloride, zinc naphthenate, and bismuth nitrate.

For example, when an epoxy group containing resin is used as the film-forming organic resin (A), a known resin such as that of acrylic, alkyd, and polyester, as well as the epoxy group containing resin, can be used aiming at the improvement of physical properties such as adhesiveness to some degree.

According to the present invention, the organic coating contains a rust-preventive additive (Y), which is a self-repairing material, either one of (a) through (f) given below.

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate,

(f) at least one organic compound selected from the group consisting of a triazole, a thiol, a thiadiazole, a thiazole, and a thiuram, or

(e) and/or (f) further containing other component.

The mechanism of corrosion prevention owing to these components (a) through (f) is described before.

The Ca ion exchanged silica contained in the above-given components (a) and (b) is prepared by fixing calcium ions onto porous silica gel powder. The Ca ions are released under a corrosive environment to form a precipitate film.

The Ca ion exchanged silica may be arbitrary one. The average particle size thereof is preferably 6 μm or smaller, more preferably 4 μm or smaller. For example, the Ca ion exchanged silica having average particle sizes of from 2 to 4 μm can be applied. If the average particle size of the Ca ion exchanged silica exceeds 6 μm, the corrosion resistance degrades and the dispersion stability in a coating composition degrades.

A preferable Ca concentration in the Ca ion exchanged silica is 1 wt. % or more, and more preferably from 2 to 8 wt. %. If the Ca concentration is less than 1 wt. %, the rust-preventive effect by the Ca release cannot fully be attained. The surface area, pH, and oil absorption capacity of the Ca ion exchanged silica are not specifically limited.

Examples of the above-described Ca ion exchanged silica are: the products of W. R. Grace & Co., namely, SHIELDEX C303 (average particle sizes of from 2.5 to 3.5 μm, Ca concentration of 3 wt. %), SHIELDEX AC3 (average particle sizes of from 2.3 to 3.1 μm, Ca concentration of 6 wt. %), and SHIELDEX AC5 (average particle sizes of from 3.8 to 5.2 μm, Ca concentration of 6 wt. %); the products of Fuji Silicia Chemical Co., Ltd., namely, SHIELDEX (average particle size of 3 μm, Ca concentrations of from 6 to 8 wt. %), and SHIELDEX SY710 (average particle sizes of from 2.2 to 2.5 μm, Ca concentrations of from 6.6 to 7.5 wt. %).

The phosphate contained in the above-described components (a), (b), and (d) includes all kinds of salt such as simple salt and double salt. The metallic cations structuring the salt is not limited, and they may be a metallic cation of zinc phosphate, magnesium phosphate, calcium phosphate, and aluminum phosphate. The skeleton and the degree of condensation of the phosphoric ion are also not limited, and they may be normal salt, dihydrogen salt, monohydrogen salt, or phosphite. Furthermore, the normal salt includes orthophosphate, and all kinds of condensation phosphate such as polyphosphate.

The calcium compound included in the above-described components (c) and (d) may be any one of calcium oxide, calcium hydroxide, and calcium salt, and one or more of them can be applied. The kind of the calcium salt is not limited, and it may be a simple salt containing only calcium as cation, such as calcium silicate, calcium carbonate, and calcium phosphate, or may be double salt containing calcium and other cation such as zinc-calcium phosphate and magnesium-calcium phosphate.

The silicon oxide contained in the above-described components (b), (c), and (d) may be either one of colloidal silica and dry silica. When a water base film-forming resin is used as the basis, examples of the colloidal silica are: the products of Nissan Chemical Industries, Ltd., namely, Snowtex O, Snowtex N, Snowtex 20, Snowtex 30, Snowtex 40, Snowtex C, and Snowtex S; the products of Catalysts & Chemicals Ind. Co., Ltd., namely, Cataloyd S, Cataloyd SI-350, Cataloyd SI-40, Cataloyd SA, and Cataloyd SN; and the products of Asahi Denka Kogyo KK., namely, Adelite AT-20 through 50, Adelite AT-20N, Adelite AT-300, Adelite AT-300S, and Adelite AT20Q.

When a solvent base film-forming resin is used as the basis, examples of the colloidal silica are: the products of Nissan Chemical Industries, Ltd., namely, Organosilica sol MA-ST-M, Organosilica sol IPA-ST, Organosilica sol EG-ST, Organosilica sol E-ST-ZL, Organosilica sol NPC-ST, Organosilica sol DMAC-ST, Organosilica sol DMAC-ST-ZL, Organosilica sol XBA-ST, and Organosilica sol MIBK-ST; the products of Catalysts & Chemicals Ind. Co., Ltd., namely, OSCAL-1132, OSCAL-1232, OSCAL-1332, OSCAL-1432, OSCAL-1532, OSCAL-1632, and OSCAL-1722.

In particular, the organic solvent dispersion type silica sol gives excellent dispersibility, and gives superior corrosion resistance to that of fumed silica sol.

Examples of the fumed silica sol are: the products of Nippon Aerosil Co., Ltd., namely, AEROSIL R971, AEROSIL R812, AEROSIL R811, AEROSIL R974, AEROSIL R202, AEROSIL R805, AEROSIL 130, AEROSIL 200, AEROSIL 300, and AEROSIL 300CF.

The fine particle silica contributes to the formation of dense and stable corrosion products under a corrosive environment. It is presumed that the corrosion products are formed densely on the surface of plating to suppress the enhancement of corrosion.

From the viewpoint of corrosion resistance, a preferable range of the particle size of the fine particle silica is from 5 to 50 nm, more preferably from 5 to 20 nm, and most preferably from 5 to 15 nm.

The molybdenate of the above-described component (e)is not limited in its skeleton and degree of condensation. Examples of the molybdenate are orthomolybdenate, paramolybdenate, and methamolybdenate. The molybdenate includes all kinds of salt such as simple salt and double salt. An example of the double salt is phosphoric molybdenate.

As of the organic compounds of the above-described component (f), examples of the triazoles are 1,2,4-triazole, 3-amino-1,2,4-triazole, 3-mercapto-1,2,4-triazole, 5-amino-3-mercapto-1,2,4-triazole, and 1H-benzotriazole, examples of thiols are 1,3,5-triazine-2,4,6-trithiol and 2-mercaptobenzimidazole, examples of thiadiazoles are 5-amino-2-mercapto-1,3,4-thiadiazole and 2,5-dimercapto-1,3,4-thiadiazole, examples of thiazoles are 2-N,N-diethylthiobenzothiazloe and 2-mercaptobenzothiazole, and an example of thiurams is tetraethylthiuramdisulfide.

In the above-described component (a), an adequate blending ratio of the Ca ion exchanged silica (a1) to the phosphate (a2), (a1)/(a2), is in a range of from 1/99 to 99/1, preferably from 10/90 to 90/1, and more preferably from 20/80 to 80/20. If the ratio (a1) (a2) is less than 1/99, the elution of calcium becomes less, failing in forming a protective coating to seal the origin of corrosion. If the ratio (a1)/(a2) exceeds 99/1, the calcium elution exceeds the necessary amount for forming the protective coating, and further the quantity of phosphoric acid ions necessary to induce the complex-forming reaction with the calcium cannot be satisfied, so that the corrosion resistance degrades.

In the above-described component (b), an adequate blending ratio between the Ca ion exchanged silica (b1), the phosphate (b2), and the silicon oxide (b3) is: [(b1)/{(b2)+(b3)}] of from 1/99 to 99/1 by weight ratio of solid matter, preferably from 10/90 to 90/10, more preferably from 20/80 to 80/20; and [(b2)/(b3)] of from 1/99 to 99/1, more preferably from 10/90 to 90/10, and most preferably from 20/80 to 80/20. If the [(b1)/{(b2)+(b3)}] is less than 1/99 or the [(b2)/(b3)] is less than 1/99, the amount of calcium elution and the amount of phosphoric acid ions are less, failing in forming the protective coating to seal the origin of corrosion. On the other hand, if the [(b1)/{(b2)+(b3)}] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied. If the [(b2)/(b3)] exceeds 99/1, the necessary amount of silicon oxide to adsorb the eluted calcium cannot be supplied. For both cases, the corrosion resistance degrades.

In the above-described component (c), an adequate blending ratio between the calcium compound (c1) and the silicon oxide (c2) is: (c1)/(c2) of from 1/99 to 99/1 by weight ratio of solid matter, preferably from 10/90 to 90/10, and more preferably from 20/80 to 80/20. If the (c1)/(c2) is less than 1/99, the amount of eluted calcium is less, failing in forming the protective coating to seal the origin of corrosion. If the (c1)/(c2) exceeds 99/1, the calcium elution exceeds the necessary amount for forming the protective coating, and further the quantity of silicon oxide necessary to adsorb the calcium cannot be supplied, thus failing in corrosion resistance.

In the above-described component (d), an adequate blending ratio between the Ca compound (d1), the phosphate (d2), and the silicon oxide (d3) is: [(d1)/{(d2)+(d3)}] of from 1/99 to 99/1 by weight ratio of solid matter, preferably from 10/90 to 90/10, more preferably from 20/80 to 80/20; and [(d2)/(d3)] of from 1/99 to 99/1, more preferably from 10/90 to 90/10, and most preferably from 20/80 to 80/20. If the [(d1)/{(d2)+(d3)})] is less than 1/99 or the [(d2)/(d3)] is less than 1/99, the amount of calcium elution and the amount of phosphoric acid ions are less, failing in forming the protective coating to seal the origin of corrosion. On the other hand, if the [(d1)/{(d2)+(d3)}] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied. If the [(d2)/(d3)] exceeds 99/1, the necessary amount of silicon oxide to adsorb the eluted calcium cannot be supplied. For both cases, the corrosion resistance degrades.

As described before, the rust-preventive additive components (a) through (f) form respective protective coatings under corrosive environments by the precipitation effect (for the components of (a) through (d)), the passivation effect (for the component (e)), and the adsorption effect (for the component (f)).

In particular, according to the present invention, by blending any one of the above-described components (a) through (f) into a specific chelete-forming resin as the base resin, extremely strong corrosion preventive effect is attained by the combination of the barrier effect of the chelete-forming resin and the self-repairing effect of the above-described components (a) through (f).

Owing to the self-repairing effect (above-described three types of preventive coating forming effect) obtained from each of the above-described components (a) through (d), (e), and (f), to attain stronger self-repairing performance, it is preferable to adjust (blend) the rust-prevention additive component (Y) which has a combination described below and which contains combined addition of the above-described (e) and/or (f) further of other component. In particular, the highest self-repairing performance (that is, white rust prevention performance) in the case of (6) and of (7) described below is obtained.

(1) A rust-preventive additive component blended with (e) a molybdenate, (g) calcium and/or a calcium compound, and (h) a phosphate and/or a silicon oxide.

(2) A rust-preventive additive component blended with (e) a molybdenate and (i) a Ca ion exchanged silica.

(3) A rust-preventive additive component blended with (f) at least one organic compound selected from the group consisting of a triazole, a thiol, a thiadiazole, a thiazole, and a thiuram, (g) calcium and/or calcium compounds, and (h) a phosphate and/or a silicon oxide.

(4) A rust-preventive additive component blended with (f) at least one organic compound selected from the group consisting of a triazole, a thiol, a thiadiazole, a thiazole, and a thiuram and (i) a Ca ion exchanged silica.

(5) A rust-preventive additive component blended with (e) a molybdenate and (f) at least one organic compound selected from the group consisting of a triazole, a thiol, a thiadiazole, a thiazole, and a thiuram.

(6) A rust-preventive additive component blended with (e) a molybdenate, (f) at least one organic compound selected from the group consisting of a triazole, a thiol, a thiadiazole, a thiazole, and a thiuram, (g) calcium and/or a calcium compound, and (h) a phosphate and/or a silicon oxide.

(7) A rust-preventive additive component blended with (e) a molybdenate, (f) at least one organic compound selected from the group consisting of a triazole, a thiol, a thiadiazole, a thiazole, and a thiuram, and (i) a Ca ion exchanged silica.

Applicable calcium compound, phosphate, silicon oxide, and Ca ion exchanged silica are the same with those described before relating to the components (a) through (d).

For the above-described (1), the rust-preventive additive components blended with (e) a molybdenate, (g) calcium and/or a calcium compound, and (h) a phosphate and/or a silicon oxide preferably give the blending ratio in solid matter weight base of [(e)/{(g)+(h)}] from 1/99 to 99/1, more preferably from 10/90 to 90/10, and most preferably from 20/80 to 80/20, and of [(g)/(h)] from 1/99 to 99/1, more preferably from 10/90 to 90/10, and most preferably from 20/80 to 80/20.

If the [(e)/{(g)+(h))] is less than 1/99 or more than 99/1, combining different self-repairing effects cannot fully be attained. If [(g)/(h)] is less than 1/99, the amount of eluted calcium is less to fail in forming a protective coating for sealing the origin of corrosion. If [(g)/(h)] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied, thus failing in attaining satisfactory self-repairing effect.

For the above-described (2), the rust-preventive additive components blended with (e) a molybdenate and (i) a Ca ion exchanged silica preferably give the blending ratios in weight base of [(e)/(i)] from 1/99 to 99/1, more preferably from 10/90 to 90/10, and most preferably from 20/80. to 80/20.

If the [(e)/(i)] is less than 1/99 or more than 99/1, the effect of combination of different self-repairing effects cannot fully be attained.

For the above-described (3), the rust-preventive additive components blended with (f) at least one organic compound selected from the group consisting of a triazole, a thiol, a thiadiazole, a thiazole, and a thiuram, (g) calcium and/or calcium compounds, and (h) a phosphate and/or a silicon oxide preferably give the blending ratios in solid matter weight base of [(f)/{(g)+(h)}] from 1/99to99/1, more preferably from 10/90 to90/10, and most preferably from 20/80 to 80/20, and of [(g)/(h)] from 1/99 to 99/1, more preferably from 10/90 to 90/10, and most preferably from 20/80 to 80/20.

If the [(f)/{(g)+(h)}] is less than 1/99 or more than 99/1, the effect of combining different self-repairing effects cannot fully be attained. If [(g)/(h)] is less than 1/99, the amount of eluted calcium is less to fail in forming a protective coating for sealing the origin of corrosion. If [(g)/(h)] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied, thus failing in attaining satisfactory self-repairing effect.

For the above-described (4), the rust-preventive additive components blended with (f) at least one organic compound selected from the group consisting of a triazole, a thiol, a thiadiazole, a thiazole, and a thiuram, (i) a Ca ion exchanged silica preferably give the blending ratios in solid matter weight base of [(f)/(i)] from 1/99 to 99/1, more preferably from 10/90 to 90/10, and most preferably from 20/80 to 80/20.

If the [(f)/(i)] is less than 1/99 or more than 99/1, the effect of combination of different self-repairing effects cannot fully be attained.

For the above-described (5), the rust-preventive additive components blended with (e) a molybdate and (f) at least one organic compound selected from the group consisting of a triazole, a thiol, a thiadiazole, a thiazole, and a thiuram preferably give the blending ratios in solid matter weight base of [(e)/ (f)] from 1/99 to 99/1, more preferably from 10/90 to 90/10, and most preferably from 20/80 to 80/20.

If the [(e)/(f)] is less than 1/99 or more than 99/1, the effect of combination of different self-repairing effects cannot fully be attained.

For the above-described (6), the rust-preventive additive components blended with (e) a molybdate, (f) at least one organic compound selected from the group consisting of a triazole, a thiol, a thiadiazole, a thiazole, and a thiuram, (g) calcium and/or a calcium compound, and (h) a phosphate and/or a silicon oxide preferably give the blending ratios in solid matter weight base of [(e)/(f)] from 1/99 to 99/1, more preferably from 10/90 to 90/10, and most preferably from 20/80 to 80/20, [(e)/{(g)+(h)] from 1/99 to 99/1, more preferably from 10/90 to 90/10, and most preferably from 20/80 to 80/20, [(f)/{(g)+(h)] from 1/99 to 99/1, more preferably from 10/90 to 90/10, and most preferably from 20/80 to 80/20,and of [(g)/(h)] from 1/99 to 99/1, more preferably from 10/90 to 90/10, and most preferably from 20/80 to 80/20.

If the value of respective [(e)/(f)], [(e)/{(g)+(h)], and [(f)/{(g)+(h)] is less than 1/99 or more than 99/1, the effect of combination of different self-repairing effects cannot fully be attained.

If [(g)/(h)] is less than 1/99, the amount of eluted calcium is less to fail in forming a protective coating for sealing the origin of corrosion. If [(g)/(h)] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied, thus failing in attaining satisfactory self-repairing effect.

For the above-described (7), the rust-preventive additive components blended with (e) a molybdate, (f) at least one organic compound selected from the group consisting of a triazole, a thiol, a thiadiazole, a thiazole, and a thiuram, and (i)a Ca ion exchanged silica preferably give the blending ratios in solid matter weight base of [(e)/(f)] from 1/99 to 99/1, more preferably from 10/90 to 90/10, and most preferably from 20/80 to 80/20, [(e)/(i)] from 1/99 to 99/1, more preferably from 10/90 to 90/10, and most preferably from 20/80 to 80/20, [(f)/(i)] from 1/99 to 99/1, more preferably from 10/90 to 90/10, and most preferably from 20/80 to 80/20.

If the value of respective [(e)/(f)], [(e)/(i)], and [(f)/(i)] is less than 1/99 or more than 99/1, the effect of combination of different self-repairing effects cannot fully be attained.

The blending amount of the above-described rust-preventive component (Y), (the total blending amount of self-repairing substance consisting of the blending amount of either one of above-described (a) through (f), or the above-described (e) and/or (f) with combined additive of other component) in the organic resin coating is in a range of from 1 to 100 parts by weight (solid matter), preferably from 5 to 80 parts by weight (solid matter), more preferably from 10 to 50 parts by weight (solid matter) to 100 parts by weight (solid matter) of the reaction product (X), (the reaction product of the reaction between the film-forming organic resin (A) and the compound (B) containing activated hydrogen consisting of the hydrazine derivative (C) of which a part of or whole of the compound thereof contains activated hydrogen) as the resin composition to form the coating. If the blending amount of the rust-preventive component (Y) is less than 1 part by weight, the effect of improvement in corrosion resistance is less. If the blending amount of the rust-preventive component (Y) exceeds 100 parts by weight, the corrosion resistance degrades, which is not favorable.

Adding to the above-described rust-preventive component, the organic coating may further contain, as the corrosion suppressing agent, one or more of other oxide fine particles (for example, aluminum oxide, zirconium oxide, titanium oxide, cerium oxide, and antimony oxide), molybdenum phosphate (for example, aluminum-molybdenum phosphate), organic phosphoric acid and its salt (for example, phytic acid, phytiate, phosphonic acid, phosphonate, and their metallic salt, alkali metal salt, alkali earth metallic salt), organic inhibitor (for example, hydrazine derivative, thiol compound, and dithiocarbamate).

The organic coating may further blend a solid lubricant (Z) to improve the workability of the coating.

Examples of the applicable solid lubricant (Z) according to the present invention are the following, either separately or mixing two or more of them.

(1) Polyolefin wax, paraffin wax: for example, polyethylene wax, synthetic paraffin, natural paraffin, microwax, and chlorinated hydrocarbon.

(2) Fluororesin fine particles: for example, those of polyfluoroethylene resin (for example, polytetrafluoroethylene resin), polyvinylfluororesin, and polyvinylidenefluororesin.

Adding to these compounds, one or more of the compounds listed below may be applied: fatty amide-base compound (for example, stearyl amide, parmitic amide, methylenebis-stearyl amide, ethylenebis-stearyl amide, oleic amide, ethyl acid amide, and alkylenebis-fatty acid amide), metal soap (for example, calcium stearate, lead stearate, calcium laurate, and calcium parmitate), metal sulfide (for example, molybdenum disulfide and tungsten disulfide), graphite, graphite fluoride, boron nitride, polyalkyleneglycol, and alkali metal sulfide.

As of these solid lubricants, particularly suitable ones are polyethylene wax and fluororesin fine particles (in particular, polytetrafluoroethylene resin fine particles).

Examples of the polyethylene wax are: the products of Hoechst AG., namely, Seridust 9615A, Seridust 3715, Seridust 3620, and Seridust 3910; the products of Sanyo Chemical Industries, Ltd., namely, Sun wax 131-P and Sun wax 161-P; the products of Mitsui Petrochemical Industries, Ltd., namely, Chemipearl W-100, Chemipearl W-200, Chemipearl W500, Chemipearl W-800, and Chemipearl W-950.

As for the fluororesin fine particles, tetrafluoroethylene fine particles are the most favorable. Examples of the tetrafluoroethylene are: the products of Daikin Industries, Ltd., namely, Lubron L-2 and Lubron L-5; the products of Mitsui DuPont Co., Ltd., namely, MP 1100 and MP 1200; the products of Asahi ICI Fluoropolymers Co., Ltd., namely, Fluon dispersion AD1, Fluon dispersion AD2, Fluon L141J, Fluon L150J, and Fluon L155J.

Among these, combined use of polyolefin wax with tetrafluoroethylene fine particles is expected to provide particularly high lubrication effect.

The blending amount of the solid lubricant (Z) in the organic coating is in a range of from 1 to 80 parts by weight (solid matter), preferably from 3 to 40 parts by weight (solid matter) to 100 parts by weight (solid matter) of the reaction product (X), (the reaction product of the reaction between the film-forming organic resin (A) and the compound (B) containing activated hydrogen consisting of the hydrazine derivative (C) of which a part of or whole of the compound thereof contains activated hydrogen) as the resin composition to form the coating. If the blending amount of the solid lubricant (Z) is less than 1 part by weight, the effect of lubrication is less. If the blending amount of the solid lubricant (Z) exceeds 80 parts by weight, the coatability degrades, which is not favorable.

The organic coating on the steel sheet with organic coating according to the present invention normally consists mainly of a reaction product (X), (a resin composition), yielded from the reaction between a film-forming organic resin (A) and a compound (B) containing activated hydrogen consisting of a hydrazine derivative (C) a part or whole of the compound thereof having activated hydrogen, and a rust-preventive additive component (Y), as a self-repairing material, of either one of the following-given (a) through (f), or a rust-preventive additive component (Y) blending other components to the above-given (e) and/or (f), further, at need, a solid lubricant (Z), a curing agent, and the like:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one compound selected from the group consisting of a triazole, a thiol, a thiadiazole, a thiazole, and a thiuram.

Furthermore, there may be added one or more of additives such as an organic colored pigment (for example, condensation polycyclic-base organic pigment and phthalocyanine-base organic pigment), a colored dye (for example,,organic solvent-soluble azo- base dye, water-soluble azo-base metallic dye), an inorganic pigment (for example, titanium oxide), a cheleting agent (for example, thiol), a conductive pigment (for example, metallic powder such as that of zinc, aluminum, and nickel, iron phosphide, antimony dope type tin oxide), a coupling agent (for example, silane coupling agent and titanium coupling agent), and a melamine-cyanuric acid additive.

The coating composition for film-formation containing above-described main components and additive components normally contains a solvent (organic solvent and/or water), and further contains, at need, a neutralizer and the like.

The above-given organic solvent is not specifically limited if only it can dissolve or disperse the reaction product (X) yielded from the reaction between the above-described film-forming organic resin (A) and the compound (B), and can be prepared as a coating composition. For example, various kinds of organic solvent described above can be used.

The above-given neutralizers are blended to neutralize the film-forming organic resin (A) and form aqueous state, at need. When the film-forming organic resin (A) is a cationic resin, acids such as acetic acid, lactic acid, and formic acid can be used.

The above-described organic coating is formed on the above-described composite oxide coating.

The dry thickness of the organic coating is in a range of from 0.1 to 5 μm, preferably from 0.3 to 3 μm, and more preferably from 0.5 to 2 μm. If the thickness of the organic coating is less than 0.1 μm, the corrosion resistance is insufficient. If the thickness exceeds 5 μm, the conductivity and the workability degrade.

The following is the description of the method for manufacturing steel sheet with organic coating according to the present invention.

The steel sheet with organic coating according to the present invention is manufactured by the steps of: treating the surface, (applying a treating liquid), of a zinc-base plated steel sheet or an aluminum-base plated steel sheet using the treating liquid containing the above-described components of composite oxide coating; heating to dry the steel sheet with coating; applying on the dried coating with a coating composition consisting mainly of a reaction product (X), (preferably as the main composition), yielded from the reaction between a film-forming organic resin (A) and a compound (B) containing activated hydrogen consisting of a hydrazine derivative (C) a part or whole of the compound thereof having activated hydrogen, and a rust-preventive additive component (Y), of either one of the following-given (a) through (f), or a rust-preventive additive component (Y) blending other components to the above-given (e) and/or (f), further, at need, a solid lubricant (Z), and the like, followed by heating to dry the coating composition:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one organic compound selected from the group consisting of a triazole, a thiol, a thiadiazole, a thiazole, and a thiuram.

The surface of the plated steel sheet may be subjected to preliminary treatment, at need, before applying the above-described treating liquid, such as alkali degreasing treatment, and surface adjusting treatment to improve coating adhesiveness and corrosion resistance.

To treat the surface of the zinc-base plated steel sheet or the aluminum-base plated steel sheet with a treating liquid to form a composite oxide coating, it is preferable to conduct the treatment with a treating liquid (aqueous solution) containing (i) oxide fine particles, (ii) a phosphate and/or a phosphoric acid compound, (iii) either one metallic ion of Mg, Mn, and Al, a compound containing at least one of these metals, and a composite compound containing at least one of these metals; further, at need, to conduct the treatment with a treating liquid (aqueous solution) containing above-described additive components (an organic resin component, an iron base metallic ion, a rust-preventive additive, and other additive), then to apply heating to dry.

The above-described treating liquid is adjusted so as the molar concentration of the above-described additive component (i), the total molar concentration of the above-described additive component (ii) converted to P₂O₅, and the total molar concentration of the above-described additive component (iii) converted to the quantity of above-described metal, to satisfy the molar ratio (i)/(iii)=0.1 to 20, preferably 0.1 to 10, and the molar ratio (iii)/(ii)=0.1 to 1.5.

If the molar ratio (i)/(iii) is less than 0.1, the effect of the addition of the oxide fine particles cannot be fully obtained. If the molar ratio (i)/(iii) exceeds 20, the oxide fine particles hinder the densification of the coating.

If the molar ratio (iii)/(ii) is less than 0.1, the effect of the addition of metal such as Mg cannot fully be attained. If the molar ratio (iii)/(ii) exceeds 1.5, the stability of treating liquid degrades.

As for the oxide fine particles as the additive component (i), those of silicon oxide (SiO₂ fine particles) are most preferable. The silicon oxide may be silica fine particles which are water-dispersible and stable in the treating liquid. Commercially available silica sols and water-dispersible oligomers of silicate can be used as the oxide fine particles. However, fluorides such as hexafluorosilicate are strongly corrosive and give significant influence to human body, so that fluorides are not suitable in view of influence on work environment.

Adequate adding amount of the oxide fine particles (for the case of silicon oxide, the adding amount as SiO₂) to the treating liquid is in a range of from 0.001 to 3.0 mole/l, preferably from 0.05 to 1.0 mole/l, more preferably from 0.1 to 0.5 mole/l. If the adding amount of the oxide fine particles is less than 0.001 mole/l, the effect of the addition is not sufficient, and the corrosion resistance tends to degrade. If the adding amount of the oxide fine particles exceeds 3.0 mole/l, the water resistance of the coating degrades, resulting in degradation tendency of corrosion resistance.

The phosphate and/or phosphoric acid compound as the additive component (ii) may be any mode including: a mode existing a compound containing phosphoric acid in a form of complex ion with anion or metallic cation generated on dissolving in an aqueous solution, which compound containing phosphoric acid includes polyphosphoric acids such as orthophosphoric acid, pyrophosphoric acid, and tripolyphosphoric acid, methaphosphoric acid, and their inorganic salt (for example, primary aluminum phosphate), phosphorous acid, phosphite, hypophosphorous acid, and hypophosphite; and a mode in which the above-given compounds exist as free acids; and a mode in which the above-given compounds exist as inorganic salts dispersing in water. According to the present invention, the total amount of the phosphoric acid components existing in the treating liquid in all modes is defined as that converted to P₂O₅.

Adequate adding amount of the phosphoric acid and/or phosphoric acid compound to the treating liquid is in a range of from 0.001 to 6.0 mole/l converted to P₂O₅ preferably from 0.02 to 1.0 mole/l, more preferably from 0.1 to 0.8 mole/l. If the adding amount of the phosphoric acid and/or phosphoric acid compound is less than 0.001 mole/l, the effect of the addition is not sufficient, and the corrosion resistance tends to degrade. If the adding amount of the phosphoric acid and/or phosphoric acid compound exceeds 6.0 mole/l, excess amount of the phosphoric acid ions react with the plated coating under a humid environment, and, depending on the corrosion environment, the corrosion of plating base material may be enhanced to cause discoloration and generation of stain-like rust.

As the additive component (ii), use of ammonium phosphate is effective because the compound provides a composite oxide giving excellent corrosion resistance. Preferred ammonium phosphate includes separate or combined use of primary ammonium phosphate, secondary ammonium phosphate, or the like.

The existing mode of the above-described additive component (iii) may be a compound or a composite compound. To obtain particularly strong corrosion resistance, it is preferred to use a mode of metallic ion such as Mg, Mn, and Al, or water-soluble ion containing metal such as Mg, Mn, and Al.

To supply ions of the additive component (iii) as metallic salts, anions such as chlorine ion, nitric acid ion, sulfuric acid ion, acetic acid ion, and boric acid ion may be added to the treating liquid. The amount of the Mg, Mn, and Al components according to the present invention is defined as the sum of all modes existing in the treating liquid converted to the corresponding metal.

Adequate adding amount of the above-described additive component (iii) to the treating liquid is in a range of from 0.001 to 3.0 mole/l converted to metal, preferably from 0.01 to 0.5 mole/l. If the adding amount of the additive component (iii) is less than 0.001 mole/l, the effect of the addition is not sufficient. If the adding amount of the additive component (iii) exceeds 3.0 mole/l, the component hinders the network-formation in the coating to fail in forming a dense coating. Furthermore, the metallic components are likely eluted from the coating, and, in some environments, defects such as discoloration of appearance occur.

The treating liquid may further contain an additive component (iv), which component (iv) consists mainly of a metallic ion of Ni, Fe, or Co, and at least one water-soluble ion containing at least one of these metals, at an adequate amount. By adding that kind of iron-base metal, blacking phenomenon caused from corrosion on the uppermost layer of the plating under a humid environment can be avoided, which phenomenon is observed when no iron base metal is added. Among these iron-base metals, the effect of Ni gives the highest effect even with a trace amount thereof. Excess amount of iron-base metal such as Ni and Co, however, causes the degradation of corrosion resistance, so the addition thereof should be at an adequate amount.

Adequate adding amount of the above-described additive component (iv) is in a range of from 1/10,000 to 1 mole converted to metal, preferably from 1/10,000 to 1/100 mole, to 1 mole of the additive component (iii) converted to metal. If the adding amount of the additive component (iv) is less than 1/10,000 mole to 1 mole of the additive component (iii), the effect of the addition is not sufficient. If the adding amount of the additive component (iv) exceeds 1 mole, the corrosion resistance degrades, as described above.

The treating liquid may further contain an adequate amount of above-described additive components to the coating, other than the above-described additive components (i) through (iv).

Adequate pH range of the treating liquid (aqueous solution) is from 0.5 to 5, preferably from 2 to 4. If the pH value is less than 0.5, the reactivity of the treating liquid becomes excessively strong, which forms fine defects in the coating to degrade the corrosion resistance. If the pH value of the treating liquid exceeds 5, the reactivity of the treating liquid becomes poor, which induces insufficient bonding of interface of plating film and composite oxide film, which also tends to degrade the corrosion resistance.

Method to coat the treating liquid onto the surface of the plated steel sheet may be either one of applying method, dipping method, and spray method. The applying method may use roll coater (three roll method, two roll method, and the like), squeeze coater, or die coater. After the treatment of applying by a squeeze coater, dipping, and spraying, it is possible to give adjustment of applied volume by air knife method or by roll squeeze method, uniformizing appearance, and uniformizing film thickness.

Although the temperature of treating liquid is not specifically limited, it is adequate in a range of from normal temperature to around 60° C. Temperature below normal temperature is uneconomical because additional facilities such as those for cooling are required. Temperature above 60° C. makes the control of treating liquid difficult because water likely evaporates.

After the treating liquid is coated as described above, normally heating to dry is applied without washing with water. The treating liquid according to the present invention, however, forms a insoluble salt by the reaction with the base material plated steel sheet, so that washing with water may be conducted after the treatment.

Any method can be applied to heat to dry the coated treating liquid. Examples of the method are use of a drier, a hot air furnace, a high frequency induction heating furnace, and an infrared furnace. A favorable temperature range of the heating to dry treatment is from 50 to 300° C., more preferably from 80 to 200° C., and most preferably from 80 to 160° C. If the heating to dry temperature is lower than 50° C., large amount of water is left in the coating, thus giving insufficient corrosion resistance. Above 300° C. of the heating to dry temperature is uneconomical, and tends to generate defects in the coating, which degrades the corrosion resistance.

After forming a composite oxide coating on the surface of the zinc-base plated steel sheet or the aluminum-base plated steel sheet, as described above, a coating composition for forming an organic coating is applied thereon. Method to coat the coating composition may be either one of applying method, dipping method, and spray method. The applying method may use roll coater (three roll method, two roll method, and the like), squeeze coater, or die coater. After the treatment of applying by a squeeze coater, dipping, and spraying, it is possible to give adjustment of applied volume by air knife method or by roll squeeze method, uniformizing appearance, and uniformizing film thickness.

After the coating composition is coated, normally heating to dry is applied without washing with water. However, the step of washing with water may be implemented after applying the coating composition.

The heating to dry treatment may be conducted by a drier, a hot air furnace, a high frequency induction heating furnace, and an infrared furnace. The heating treatment is preferred to conduct at the ultimate temperatures of from 50 to 350° C., more preferably from 80 to 250° C. If the heating temperature is lower than 50° C., large amount of water is left in the coating, thus giving insufficient corrosion resistance. Above 350° C. of the heating temperature is uneconomical, and tends to generate defects in the coating, which may degrade the corrosion resistance.

The present invention includes the steel sheets with above-described coating on both sides or single side surface thereof. Therefore, examples of the modes of the steel sheet according to the present invention are the following.

(1) One side: Plated coating—Composite oxide coating—Organic coating

Other side: Plated coating

(2) One side: Plated coating—Composite oxide coating—Organic coating

Other side: Plated coating—Known phosphate treated coating or the like

(3) Both sides: Plated coating—Composite oxide coating—Organic coating

(4) One side: Plated coating—Composite oxide coating—Organic coating

Other side: Plated coating—Composite oxide coating

(5) One side: Plated coating—Composite oxide coating—Organic coating

Other side: Plated coating—Organic coating

### EXAMPLES

Treating liquids (film-forming compositions) for forming the first layer coating, shown in Table 2 and Table 3, were prepared.

Resin compositions (reaction products) for forming the second layer coating were synthesized conforming to the procedures given below.

[Synthesis Example 1]

A 1870 parts of EP828 (manufactured by Yuka Shell Epoxy Co., Ltd.; epoxy equivalent of 187), 912 parts of Bisphenol A, 2 parts of tetraethylammoniumbromide, and 300 parts of methylisobutylketone were charged in a four-neck flask. The contents were heated to 140° C. to let them react for 4 hours. Thus an epoxy resin having an epoxy equivalent of 1391 with a solid content of 90% was obtained. A 1,500 parts of ethyleneglycol monobutylether was added to the reaction product, then the mixture was cooled to 100° C. A 96 parts of 3,5-dimethylpyrazole (molecular weight of 96) and 129 parts of dibutylamine (molecular weight of 129) were added to the cooled mixture to react for 6 hours until the epoxy groups were vanished. Then, 205 parts of methylisobutylketone was added while cooling the mixture to obtain a pyrazole-modified epoxy resin with 60% of solid content. The resin was defined as the resin composition (1). The resin composition (1) is a reaction product obtained from the reaction between the film-forming organic resin (A) and a compound, containing activated hydrogen, containing 50 mole % of a hydrazine derivative (C) containing activated hydrogen.

[Synthesis Example 2]

A 4,000 parts of EP1007 (manufactured by Yuka Shell Epoxy Co., Ltd.; epoxy equivalent of 2,000) and 2,239 parts of ethyleneglycol monobutylether were charged in a four-neck flask. The contents were heated to 120° C. to fully dissolve epoxy resin in one hour. The mixture was cooled to 100° C. A 168 parts of 3-amino-1,2,4-triazole (molecular weight of 84) was added to the cooled mixture to react for 6 hours to let epoxy groups vanish. Then, 540 parts of methylisobutylketone was added to the mixture while cooling the mixture, thus obtained a triazole-modified epoxy resin with 60% of solid content. The resin was defined as the resin composition (2). The resin composition (2) is a reaction product obtained from the reaction between the film-forming organic resin (A) and a compound, containing activated hydrogen, containing 100 mole % of a hydrazine derivative (C) containing activated hydrogen.

[Synthesis Example 3]

A 222 parts of isophorone diisocyanate (isocyanate equivalent of 111) and 34 parts of methylisobutylketone were charged to a four-neck flask. The contents were held to temperatures of from 30 to 40° C. A 87 parts of methylethylketoxime (molecular weight of 87) was added dropwise to the mixture for 3 hours. Then the mixture was held to 40° C. for 2 hours to obtain a part-block isocyanate having an isocyanate equivalent of 309 and a solid content of 90%.

Next, 1,496 parts of EP828 (manufactured by Yuka Shell Epoxy Co., Ltd.; epoxy equivalent of 187), 684 parts of Bisphenol A, 1 part of tetraethylammonium bromide, and 241 parts of methylisobutylketone were charged to a four-neck flask. The contents were heated to 140° C. to react for 4 hours, thus obtained an epoxy resin with epoxy equivalent of 1,090 and solid content of 90%. Then, 1,000 parts of methylisobutylketone was added to the mixture, followed by cooling the mixture to 100° C. Furthermore, 202 parts of 3-mercapto-1,2,4-triazole (molecular weight of 101) was added to the mixture to react them for 6 hours until epoxy groups were vanished. Then, 230 parts of the above-described part-block isocyanate with 90% of solid content was added to the mixture to react them at 100° C. for 3 hours, and the vanish of isocyanate group was confirmed. Furthermore, 461 parts of ethyleneglycol monobutylether was added to the mixture to obtain a triazole-modified epoxy resin with 60% of solid content. The resin was defined as the resin composition (3). The resin composition (3) is a reaction product obtained from the reaction between the film-forming organic resin (A) and a compound, containing activated hydrogen, containing 100 mole % of a hydrazine derivative (C) containing activated hydrogen.

[Synthesis Example 4]

A 1,870 parts of EP828(manufactured by Yuka Shell Epoxy Co., Ltd.; epoxy equivalent of 187), 912 parts of Bisphenol A, 2 parts of tetraethylammoniumbromide, and 300 parts of methylisobutylketone were charged in a four-neck flask. The contents were heated to 140° C. to react them, thus obtained an epoxy resin giving an epoxy equivalent of 1,391 and a solid content of 90%. A 1,500 parts of ethyleneglycol monobutylether was added to the mixture, then the mixture was cooled to 100° C. A 258 parts of dibutylamine (molecular weight of 129) was added to the mixture to let them react for 6 hours until epoxy groups were vanished. Then 225 parts of methylisobutylketone was added to the mixture to obtain an epoxyamine additive giving a solid content of 60%. The epoxyamine additive was defined as the resin composition (4). The resin composition (4) is a reaction product obtained from the reaction between the film-forming organic resin (A) and a compound, containing activated hydrogen, containing no hydrazine derivative (C) containing activated hydrogen.

A curing agent was blended with respective synthesized resin compositions (1) through (4) to prepare the resin compositions (coating compositions) shown in Table 4.

The (1) through (4) in the column of base resin kind in Table 4 are the respective resin compositions synthesized in the above-described Synthesis Example 1 through 4. (*1 of Table 4).

The A and B in the column of the kind of curing agent given in Table 4 are the following. (*2 of Table 4).

A: MEK oxime block body of IPDI: manufactured by Takeda Chemical Industries, Ltd. “Takenate B-870N”

B: Isocyanulate type: manufactured by Bayer AG. “DESMODUR BL-3175”

C: MEK oxime block body of HMDI: manufactured by Asahi Chemical Co., Ltd. “Duranate MF-B80M”

D: Imino group type melamine resin: manufactured by Mitsui Cytec Co., Ltd. “Cymel 325”

To these coating compositions, the rust-preventive additive components (self-repairing materials) shown in Table 5, and the solid lubricants shown in Table 6 were adequately added to disperse for a necessary time using a coating disperser (a sandgrinder) to obtain the wanted coating compositions.

To obtain steel sheets with organic coating for household electric appliances, building materials, and automobile parts, cold-rolled steel sheets having a thickness of 0.8 mm and a surface roughness Ra of 1.0 μm were separately applied with various kinds of zinc-base plating or aluminum-base plating, thus preparing the plated steel sheets shown in Table 1. These plated steel sheets were used as the base plates for treatment. The surface of these steel sheets was subjected to alkali degreasing and water washing, then was applied with the treating liquids (coating compositions) shown in Table 2 and Table 3 using a roll coater, followed by heating to dry to form the first coating layer. The thickness of the first coating layer was adjusted by controlling the solid content (heating residue) or the applying conditions (pressing force of the roll, rotation speed, and the like) of the treating liquid. Then, the coating compositions shown in Table 4 were applied using a roll coater, and the coating compositions were heated to dry to form the second coating layer, thus obtained the steel sheets with organic coating of the Examples according to the present invention and the Comparative Example. The thickness of the second coating layer was adjusted by controlling the solid content (heating residue) or the applying conditions (pressing force of the roll, rotation speed, and the like) of the treating liquid.

Thus obtained steel sheets with organic coating were evaluated in terms of quality performance (coating appearance, white rust resistance, white rust resistance after alkali degreasing, coating adhesiveness, and workability). The results are given in Tables 7 through 39, along with the coating structure of the first coating and the second coating.

The evaluation of the quality performance of the steel sheets with organic coating were conducted as described below.

(1) Appearance of coating

For each sample, visual evaluation was given on the uniformity of coating appearance, (presence/absence of irregularity). The criteria for the evaluation are given below.

◯: Uniform appearance free of irregularity

Δ: Somewhat significant irregularity

x: Significant irregularity

(2) White rust resistance

For each sample, a combined corrosion test (CCT) given below was applied, and the evaluation was given on the area rate of generated white rust after specific number of cycles.

[Content of 1 cycle of the combined corrosion test (CCT)]

3 wt. % salt water spray test (30° C., 0.5 hour)

↓

Humid test (30° C., 95% RH, 1.5 hours)

↓

Hot air drying test (50° C., 20% RH, 2.0 hours)

↓

Hot air drying test (30° C., 20% RH, 2.0 hours)

The criteria of evaluation are the following.

⊚: no white rust generated

◯+: white rust generated area: less than 5%

◯: white rust generated area: 5% or more and less than 10%

◯−: white rust generated area: 10% or more and less than 25%

Δ: white rust generated area: 25% or more and less than 50%

X: white rust generated area: 50% or more

(3) White rust resistance after alkali degreasing

For each sample, alkali degreasing was applied using the Alkali degreasing liquid CLN-364S manufactured by Nippon Parkerizing Co., Ltd., (60° C., spray 2 minutes), followed by the above-described combined corrosion test (CCT). The evaluation was given on the area rate of generated white rust after specific number of cycles. The criteria of evaluation are the following.

⊚: no white rust generated

◯+: white rust generated area: less than 5%

◯: white rust generated area: 5% or more and less than 10%

◯−: white rust generated area: 10% or more and less than 25%.

Δ: white rust generated area: 25% or more and less than 50%

X: white rust generated area: 50% or more

(4) Coating adhesiveness

For each sample, a melamine-base baking coating (film thickness of 30 μm) was applied. The sample was immersed in boiling water for 2 hours. Immediately after brought out from the boiling water, the sample was cut on the surface thereof with grid pattern (10×10 stripes with 1 mm spacing). Then, the tacking and peeling test with an adhesive tape was given. The evaluation was given on the area rate of peeled coating film. The criteria of the evaluation are the following.

⊚: no peeling occurred

◯: peeled area: less than 5%

Δ: peeled area: 5% or more and less than 20%

X: peeled area: 20% or more

(5) Workability

A deep drawing (non-lubricant condition) was applied using a blank diameter of 120 mm and a die diameter of 50 mm. The evaluation was given on the formed height that generates break. The criteria of the evaluation are the following.

⊚: completely drawn

◯: formed height: 30 mm or more

Δ: formed height: 20 or more and less than 30 mm

X: formed height: less than 20 mm

In the following Tables 7 through 39, the notes *1 through *7 expresses the following.

*1: Plated steel sheet No. given in Table 1.

*2: Composition No. for forming the first coating layer, given in Table 2 and Table 3.

*3: The component (β) is a coating weight converted to P₂O₅; and the component (γ) is a coating weight converted to metal (Mg, Mn, or Al).

*4: Composition No. for forming the second coating layer, given in Table 4.

*5: Rust-preventive additive component No. given in Table

*6: Solid lubricant No. given in Table 6.

*7: Amount of blending (weight parts) to 100 parts by weight of resin composition.

TABLE 1

| | | Coating |
|---|---|---|
| | | weight |
| No. | Kind | (g/m²) |
| 1 | Electrolytic galvanized steel sheet | 20 |
| 2 | Hot dip galvanized steel sheet | 60 |
| 3 | Alloyed hot dip galvanized steel sheet (Fe: 10 wt %) | 60 |
| 4 | Hot dip Zn—Al alloy plated steel sheet (Al: 55 wt %) | 90 |
| 5 | Hot dip Zn-5 wt. % Al-0.5 wt. % Mg alloy plated steel | 90 |
| | sheet | |
| 6 | Hot dip aluminum plated steel sheet (Al-6 wt. % Si alloy | 60 |
| | plating) | |

TABLE 2

| | | | | | Phosphoric acid, phosphoric acid | | | |
|---|---|---|---|---|---|---|---|---|
| | Oxide fine particles (i) | | Mg, Mn, Al (iii) | | compound (ii) | | Organic resin | |
| | | Concentration | | Concentration | | Concentration | | Concentration |
| No. | Kind | (M/L) | Kind | (M/L) *1 | Kind | (M/L) *2 | Kind | (g/l) |
| 1 | Colloidal silica | 0.3 | Mn | 0.10 | Orthophosphoric acid | 0.20 | — | — |
| 2 | Colloidal silica | 0.04 | Mn | 0.10 | Orthophosphoric acid | 0.20 | — | — |
| 3 | Colloidal silica | 0.3 | Mn | 0.10 | Orthophosphoric acid | 0.50 | — | — |
| 4 | Colloidal silica | 0.33 | Mn | 0.11 | Orthophosphoric acid | 0.10 | — | — |
| 5 | Colloidal silica | 1.8 | Mn | 0.10 | Orthophosphoric acid | 0.20 | — | — |
| 6 | Colloidal silica | 0.3 | Mn | 0.10 | Orthophosphoric acid | 0.20 | Acrylic-styrene base | 180 |
| | | | | | | | water-dispersible resin | |
| 7 | Colloidal silica | 0.3 | Al | 0.10 | Orthophosphoric acid | 0.20 | — | — |
| 8 | Colloidal silica | 0.04 | Al | 0.10 | Orthophosphoric acid | 0.20 | — | — |
| 9 | Colloidal silica | 0.3 | Al | 0.10 | Orthophosphoric acid | 0.50 | — | — |
| 10 | Colloidal silica | 0.3 | Al | 0.10 | Orthophosphoric acid | 0.20 | — | — |
| 11 | Colloidal silica | 0.33 | AJ | 0.11 | Orthophosphoric acid | 0.10 | — | — |
| 12 | Alumina sol | 0.3 | AJ | 0.10 | Orthophosphoric acid | 0.20 | — | — |
| 13 | Colloidal silica | 0.3 | Mg | 0.10 | Orthophosphoric acid | 0.20 | — | — |
| 14 | — | — | Mn | 0.10 | Orthophosphoric acid | 0.20 | — | — |
| 15 | — | — | Al | 0.10 | Orthophosphoric acid | 0.20 | — | — |
| 16 | — | — | Mg | 0.10 | Orthophosphoric acid | 0.20 | — | — |
| 17 | Colloidal silica | 0.3 | — | — | Orthophosphoric acid | 0.20 | — | — |
| 18 | Colloidal silica | 0.3 | Mn | 0.10 | — | — | — | — |
| 19 | Colloidal silica | 0.3 | Al | 0.10 | — | — | — | — |
| 20 | Colloidal silica | 0.3 | Mg | 0.10 | — | — | — | — |
| 21 | Lithium silicate | 1.0 | — | — | — | — | — | — |

*1 Total molar concentration converted to metals of Mg, Mn, and Al.
*2 Total molar concentration converted to P₂O₅.

TABLE 3

| | Mole ratio | Mole ratio | Applicability of the condition of the |
|---|---|---|---|
| No. | (i)/(iii) | (iii)/(ii) | invention *3 |
| 1 | 3.0 | 0.5 | ◯ |
| 2 | 0.4 | 0.5 | ◯ |
| 3 | 3.0 | 0.2 | ◯ |
| 4 | 3.0 | 1.1 | ◯ |
| 5 | 18.0 | 0.5 | ◯ |
| 6 | 3.0 | 0.5 | ◯ |
| 7 | 3.0 | 0.5 | ◯ |
| 8 | 0.4 | 0.5 | ◯ |
| 9 | 3.0 | 0.2 | ◯ |
| 10 | 3.0 | 1.1 | ◯ |
| 11 | 18.0 | 0.5 | ◯ |
| 12 | 3.0 | 0.5 | ◯ |
| 13 | 3.0 | 0.5 | ◯ |
| 14 | — | 0.5 | X |
| 15 | — | 0.5 | X |
| 16 | — | 0.5 | X |
| 17 | — | — | X |
| 18 | 3.0 | — | X |
| 19 | 3.0 | — | X |
| 20 | 3.0 | — | X |
| 21 | — | — | X |

*3
◯: Satisfies the condition of the invention.
X: Dissatisfies the condition of the invention.

TABLE 4

| | Base resin | | Curing agent | | | | Applicability of the condition |
|---|---|---|---|---|---|---|---|
| No. | Kind *1 | Blend ratio | Kind *2 | Blend ratio | Catalyst | | of the invention |
| 1 | (1) | 100 parts | A | 5 parts | Dibutyltin dilaurate | (0.2 part) | Satisfied |
| 2 | (1) | 100 parts | B | 25 parts | Dibutyltin dilaurate | (1.0 part) | Satisfied |
| 3 | (1) | 100 parts | C | 25 parts | — | | Satisfied |
| 4 | (2) | 100 parts | A | 50 parts | Dibutyltin dilaurate | (2.0 part) | Satisfied |
| 5 | (2) | 100 parts | B | 50 parts | Dibutyltin dilaurate | (3.0 part) | Satisfied |
| 6 | (2) | 100 parts | C | 80 parts | Dibutyltin dilaurate | (4.0 part) | Satisfied |
| 7 | (3) | 100 parts | A | 25 parts | Cobalt naphthenate | (1.0 part) | Satisfied |
| 8 | (3) | 100 parts | B | 10 parts | Tin(II) chloride | (1.0 part) | Satisfied |
| 9 | (3) | 100 parts | C | 50 parts | N-ethylmolpholine | (1.0 part) | Satisfied |
| 10 | (1) | 100 parts | D | 25 parts | — | | Satisfied |
| 11 | (3) | 100 parts | D | 30 parts | — | | Satisfied |
| 12 | (4) | 100 parts | B | 25 parts | Dibutyltin dilaurate | (1.0 part) | Dissatisfied |

| | | |
|---|---|---|
| 13 | Aqueous solution of a hydrazine derivative (5 wt. % aqueous | Dissatisfied |
| | solution of 3,5-dimethylpyrazole) | |
| 14 | Mixture of an epoxy amine additive and a hydrazine derivative | Dissatisfied |
| | (prepared by mixing 100 parts by weight of the resin | |
| | composition No. 12 (base resin) with 3 parts by weight of | |
| | 3,5-dimethylpyrazole, then by agitating the mixture). | |

TABLE 5

| | Rust-preventive additive component | | | | |
|---|---|---|---|---|---|
| | (a) Ca ion exchanged silica + Phosphate | | | | |
| | (b) Ca ion exchanged silica + Phosphate + Silicon oxide | | (f) One or more organic compounds | | Blend ratio *1 |
| | (c) Calcium compound + Silicon oxide | | selected from the group consisting | | (a) to (d), |
| | (d) Calcium compound + Phosphate + Silicon oxide | | of triazoles, thiols, thiodiazoles, | | (g) to (i): |
| No. | (g), (h), (i) Other components | (e) Molybdenate | thiazoles, and thiurams | | (e):(f) |
| 1 | Ca ion exchanged silica + Zn phosphate | — | — | | — |
| | (Blend ratio of 1:1 *1) | | | | |
| 2 | Ca ion exchanged silica + Zn phosphate + Silica | — | — | | — |
| | (Blend ratio of 1:1:1 *1) | | | | |
| 3 | Ca oxide + Silica + Dihydrogen Al tripolyphosphate | — | — | | — |
| | (Blend ratio of 1:1:1 *1) | | | | |
| 4 | Ca oxide + Silica | — | — | | — |
| 5 | — | Molybdenum Al | — | | — |
| | | phosphate | | | |
| 6 | — | Molybdenum CaZn | — | | — |
| | | phosphate | | | |
| 7 | — | — | 5-Amino-3-mercapto- | Triazoles | — |
| | | | 1,2,4-triazole | | |
| 8 | — | — | 1,3,5-Triazine-2,4,6- | Thiols | — |
| | | | trithyol | | |
| 9 | — | — | 5-Amino-2-mercapto- | Thiadiazoles | — |
| | | | 1,3,4-thiadiazole | | |
| 10 | — | — | 2-Mercaptobenzothiazole | Thiazoles | — |
| 11 | — | — | Tetraethylthiuramdisulfide | Thiurams | — |
| 12 | Ca silicate + Dihydrogen Al tripolyphosphate | Molybdenum Al | — | | 10:10:0 |
| | (Blend ratio of 1:1 *1) | phosphate | | | |
| 13 | Ca ion exchanged silica | — | Tetratehylthiuramdisulfide | Thiurams | 10:0:10 |
| 14 | — | Molybdenum Al | Tetratehylthiuramdisulfide | Thiurams | 0:10:10 |
| | | phosphate | | | |
| 15 | Ca silicate + Dihydrogen Al tripolyphosphate | Molybdenum Al | Tetratehylthiuramdisulfide | Thiurams | 10:10:10 |
| | (Blend ratio of 1:1 *1) | phosphate | | | |
| 16 | Ca oxide + Silica | Molybdenum Al | — | | 10:10:0 |
| | (Blend ratio of 1:1 *1) | phosphate | | | |
| 17 | Ca ion exchanged silica | Molybdenum Al | — | | 10:10:0 |
| | | phosphate | | | |
| 18 | Ca oxide + Zn phosphate | — | Tetratehylthiuramdisulfide | Thiurams | 10:0:10 |
| | (Blend ratio of 1:1 *1) | | | | |
| 19 | Ca oxide + Silica | — | Tetratehylthiuramdisulfide | Thiurams | 10:0:10 |
| | (Blend ratio of 1:1 *1) | | | | |
| 20 | Ca oxide + Silica | Molybdenum Al | Tetratehylthiuramdisulfide | Thiurams | 10:10:10 |
| | (Blend ratio of 1:1 *1) | phosphate | | | |
| 21 | Ca ion exchanged silica | Molybdenum Al | Tetratehylthiuramdisulfide | Thiurams | 10:10:10 |
| | | phosphate | | | |

*1 Weight ratio

TABLE 6

| No. | Kind | Trade name |
|---|---|---|
| 1 | Polyethylene wax | Nippon Seiro Co., Ltd. |
| | | “LUVAX 1151” |
| 2 | Polyethylene wax | Ceridust Co., Ltd. “3620” |
| 3 | Polyethylene wax | Mitsui Petrochemical Industries, |
| | | Ltd. “Chemipearl W-100” |
| 4 | Tetrafluoroethylene resin | Mitsui-DuPont Co., Ltd. “MP 1100” |
| 5 | Tetrafluoroethylene resin | Daikin Industries, Ltd. “L-2” |
| 6 | Mixture of No. 1 and No. 4 | — |
| | (Blend ratio of 1:1) | |

TABLE 7

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 1 | 1 | 1 | 140 | 0.3 | 359 | 150 | 163 | 46 | 3.0 | 0.5 | E |
| 2 | 1 | 1 | 140 | 0.3 | 359 | 150 | 163 | 46 | 3.0 | 0.5 | E |
| 3 | 1 | 1 | 140 | 0.3 | 359 | 150 | 163 | 46 | 3.0 | 0.5 | E |
| 4 | 1 | 1 | 140 | 0.3 | 359 | 150 | 163 | 46 | 3.0 | 0.5 | E |
| 5 | 1 | 1 | 140 | 0.3 | 359 | 150 | 163 | 46 | 3.0 | 0.5 | E |
| 6 | 1 | 1 | 140 | 0.3 | 359 | 150 | 163 | 46 | 3.0 | 0.5 | E |
| 7 | 1 | 1 | 140 | 0.3 | 359 | 150 | 163 | 46 | 3.0 | 0.5 | E |
| 8 | 1 | 1 | 140 | 0.3 | 359 | 150 | 163 | 46 | 3.0 | 0.5 | E |
| 9 | 1 | 1 | 140 | 0.3 | 359 | 150 | 163 | 46 | 3.0 | 0.5 | E |
| 10 | 1 | 1 | 140 | 0.3 | 359 | 150 | 163 | 46 | 3.0 | 0.5 | E |
| 11 | 1 | 1 | 140 | 0.3 | 359 | 150 | 163 | 46 | 3.0 | 0.5 | E |
| 12 | 1 | 1 | 140 | 0.3 | 359 | 150 | 163 | 46 | 3.0 | 0.5 | C |
| 13 | 1 | 1 | 140 | 0.3 | 359 | 150 | 163 | 46 | 3.0 | 0.5 | C |
| 14 | 1 | 1 | 140 | 0.3 | 359 | 150 | 163 | 46 | 3.0 | 0.5 | C |

E: Example
C: Comparative example

TABLE 8

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 1 | 1 | 15 | 15 | — | — | 140 | 1.0 | Example |
| 2 | 2 | 15 | 15 | — | — | 140 | 1.0 | Example |
| 3 | 3 | 15 | 15 | — | — | 140 | 1.0 | Example |
| 4 | 4 | 15 | 15 | — | — | 140 | 1.0 | Example |
| 5 | 5 | 15 | 15 | — | — | 140 | 1.0 | Example |
| 6 | 6 | 15 | 15 | — | — | 140 | 1.0 | Example |
| 7 | 7 | 15 | 15 | — | — | 140 | 1.0 | Example |
| 8 | 8 | 15 | 15 | — | — | 140 | 1.0 | Example |
| 9 | 9 | 15 | 15 | — | — | 140 | 1.0 | Example |
| 10 | 10 | 15 | 15 | — | — | 140 | 1.0 | Example |
| 11 | 11 | 15 | 15 | — | — | 140 | 1.0 | Example |
| 12 | 12 | 15 | 15 | — | — | 140 | 1.0 | Comparative |
| | | | | | | | | example |
| 13 | 13 | 15 | 15 | — | — | 140 | 1.0 | Comparative |
| | | | | | | | | example |
| 14 | 14 | 15 | 15 | — | — | 140 | 1.0 | Comparative |
| | | | | | | | | example |

TABLE 9

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 1 | ◯ | ⊚ | ⊚ | ⊚ | — | Example |
| 2 | ◯ | ⊚ | ⊚ | ⊚ | — | Example |
| 3 | ◯ | ⊚ | ⊚ | ⊚ | — | Example |
| 4 | ◯ | ⊚ | ⊚ | ⊚ | — | Example |
| 5 | ◯ | ⊚ | ⊚ | ⊚ | — | Example |
| 6 | ◯ | ⊚ | ⊚ | ⊚ | — | Example |
| 7 | ◯ | ⊚ | ⊚ | ⊚ | — | Example |
| 8 | ◯ | ⊚ | ⊚ | ⊚ | — | Example |
| 9 | ◯ | ⊚ | ⊚ | ⊚ | — | Example |
| 10 | ◯ | ⊚ | ⊚ | ⊚ | — | Example |
| 11 | ◯ | ⊚ | ⊚ | ⊚ | — | Example |
| 12 | ◯ | Δ | X | ⊚ | — | Comparative |
| | | | | | | example |
| 13 | ◯ | X | X | X | — | Comparative |
| | | | | | | example |
| 14 | ◯ | Δ | X | ⊚ | — | Comparative |
| | | | | | | example |

TABLE 10

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 15 | 1 | 2 | 140 | 0.3 | 344 | 30 | 245 | 69 | 0.4 | 0.5 | E |
| 16 | 1 | 3 | 140 | 0.3 | 363 | 90 | 245 | 28 | 3.0 | 0.2 | E |
| 17 | 1 | 4 | 140 | 0.3 | 360 | 200 | 99 | 61 | 3.0 | 1.1 | E |
| 18 | 1 | 5 | 140 | 0.3 | 358 | 290 | 53 | 15 | 18.0 | 0.5 | E |
| 19 | 1 | 6 | 140 | 0.3 | 600 | 150 | 163 | 46 | 3.0 | 0.5 | E |
| 20 | 1 | 7 | 140 | 0.3 | 358 | 160 | 174 | 24 | 3.0 | 0.5 | E |
| 21 | 1 | 8 | 140 | 0.3 | 360 | 35 | 286 | 39 | 0.4 | 0.5 | E |
| 22 | 1 | 9 | 140 | 0.3 | 349 | 90 | 245 | 14 | 3.0 | 0.2 | E |
| 23 | 1 | 10 | 140 | 0.3 | 362 | 220 | 109 | 33 | 3.0 | 1.1 | E |
| 24 | 1 | 11 | 140 | 0.3 | 362 | 300 | 54 | 8 | 18.0 | 0.5 | E |

E: Example
C: Comparative example

TABLE 11

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 15 | 1 | 15 | 15 | — | — | 140 | 1.0 | Example |
| 16 | 1 | 15 | 15 | — | — | 140 | 1.0 | Example |
| 17 | 1 | 15 | 15 | — | — | 140 | 1.0 | Example |
| 18 | 1 | 15 | 15 | — | — | 140 | 1.0 | Example |
| 19 | 1 | 15 | 15 | — | — | 140 | 1.0 | Example |
| 20 | 1 | 15 | 15 | — | — | 140 | 1.0 | Example |
| 21 | 1 | 15 | 15 | — | — | 140 | 1.0 | Example |
| 22 | 1 | 15 | 15 | — | — | 140 | 1.0 | Example |
| 23 | 1 | 15 | 15 | — | — | 140 | 1.0 | Example |
| 24 | 1 | 15 | 15 | — | — | 140 | 1.0 | Example |

TABLE 12

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 15 | ◯ | ⊚ | ⊚ | ⊚ | — | Example |
| 16 | ◯ | ⊚ | ⊚ | ⊚ | — | Example |
| 17 | ◯ | ⊚ | ⊚ | ⊚ | — | Example |
| 18 | ◯ | ⊚ | ⊚ | ⊚ | — | Example |
| 19 | ◯ | ⊚ | ⊚ | ⊚ | — | Example |
| 20 | ◯ | ⊚ | ⊚ | ⊚ | — | Example |
| 21 | ◯ | ⊚ | ⊚ | ⊚ | — | Example |
| 22 | ◯ | ⊚ | ⊚ | ⊚ | — | Example |
| 23 | ◯ | ⊚ | ⊚ | ⊚ | — | Example |
| 24 | ◯ | ⊚ | ⊚ | ⊚ | — | Example |

TABLE 13

| | | Primary coating film | | | | | | | | | |
|---|---|---|---|---|---|---|---|---|---|---|---|
| | Plated | | | | Film coating weight *3 | | | | Mole ratio of film | | |
| | steel | Film | Drying | Film | Total coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 25 | 1 | 12 | 140 | 0.3 | 358 | 160 | 174 | 24 | 3.0 | 0.5 | E |
| 26 | 1 | 13 | 140 | 0.3 | 355 | 160 | 174 | 21 | 3.0 | 0.5 | E |
| 27 | 1 | 14 | 140 | 0.3 | 362 | — | 283 | 79 | — | 0.5 | C |
| 28 | 1 | 15 | 140 | 0.3 | 360 | — | 316 | 44 | — | 0.5 | C |
| 29 | 1 | 16 | 140 | 0.3 | 355 | — | 316 | 39 | — | 0.5 | C |
| 30 | 1 | 17 | 140 | 0.3 | 358 | 334 | 24 | — | — | — | C |
| 31 | 1 | 18 | 140 | 0.3 | 353 | 270 | — | 83 | 3.0 | — | C |
| 32 | 1 | 19 | 140 | 0.3 | 357 | 310 | — | 47 | 3.0 | — | C |
| 33 | 1 | 20 | 140 | 0.3 | 363 | 320 | — | 43 | 3.0 | — | C |
| 34 | 1 | 21 | 140 | 0.3 | 360 | — | — | — | — | — | C |

E: Example
C: Comparative example

TABLE 14

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 25 | 1 | 15 | 15 | — | — | 140 | 1.0 | Example |
| 26 | 1 | 15 | 15 | — | — | 140 | 1.0 | Example |
| 27 | 1 | 15 | 15 | — | — | 140 | 1.0 | Comparative |
| | | | | | | | | example |
| 28 | 1 | 15 | 15 | — | — | 140 | 1.0 | Comparative |
| | | | | | | | | example |
| 29 | 1 | 15 | 15 | — | — | 140 | 1.0 | Comparative |
| | | | | | | | | example |
| 30 | 1 | 15 | 15 | — | — | 140 | 1.0 | Comparative |
| | | | | | | | | example |
| 31 | 1 | 15 | 15 | — | — | 140 | 1.0 | Comparative |
| | | | | | | | | example |
| 32 | 1 | 15 | 15 | — | — | 140 | 1.0 | Comparative |
| | | | | | | | | example |
| 33 | 1 | 15 | 15 | — | — | 140 | 1.0 | Comparative |
| | | | | | | | | example |
| 34 | 1 | 15 | 15 | — | — | 140 | 1.0 | Comparative |
| | | | | | | | | example |

TABLE 15

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 25 | ◯ | ◯+ | ◯+ | ⊚ | — | Example |
| 26 | ◯ | ◯ | ◯ | ◯ | — | Example |
| 27 | ◯ | Δ | Δ | Δ | — | Comparative |
| | | | | | | example |
| 28 | ◯ | Δ | Δ | Δ | — | Comparative |
| | | | | | | example |
| 29 | ◯ | Δ | Δ | Δ | — | Comparative |
| | | | | | | example |
| 30 | ◯ | Δ | Δ | ◯ | — | Comparative |
| | | | | | | example |
| 31 | ◯ | Δ | X | ◯ | — | Comparative |
| | | | | | | example |
| 32 | ◯ | Δ | X | ◯ | — | Comparative |
| | | | | | | example |
| 33 | ◯ | Δ | X | ◯ | — | Comparative |
| | | | | | | example |
| 34 | ◯ | Δ | X | Δ | — | Comparative |
| | | | | | | example |

TABLE 16

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 35 | 1 | 1 | 140 | 0.3 | 359 | 150 | 163 | 46 | 3.0 | 0.5 | C |
| 36 | 1 | 1 | 140 | 0.3 | 359 | 150 | 163 | 46 | 3.0 | 0.5 | E |
| 37 | 1 | 1 | 140 | 0.3 | 359 | 150 | 163 | 46 | 3.0 | 0.5 | E |
| 38 | 1 | 1 | 140 | 0.3 | 359 | 150 | 163 | 46 | 3.0 | 0.5 | E |
| 39 | 1 | 1 | 140 | 0.3 | 359 | 150 | 163 | 46 | 3.0 | 0.5 | E |
| 40 | 1 | 1 | 140 | 0.3 | 359 | 150 | 163 | 46 | 3.0 | 0.5 | E |
| 41 | 1 | 1 | 140 | 0.3 | 359 | 150 | 163 | 46 | 3.0 | 0.5 | C |
| 42 | 2 | 1 | 140 | 0.3 | 359 | 150 | 163 | 46 | 3.0 | 0.5 | E |
| 43 | 3 | 1 | 140 | 0.3 | 359 | 150 | 163 | 46 | 3.0 | 0.5 | E |
| 44 | 4 | 1 | 140 | 0.3 | 359 | 150 | 163 | 46 | 3.0 | 0.5 | E |
| 45 | 5 | 1 | 140 | 0.3 | 359 | 150 | 163 | 46 | 3.0 | 0.5 | E |
| 46 | 6 | 1 | 140 | 0.3 | 359 | 150 | 163 | 46 | 3.0 | 0.5 | E |

E: Example
C: Comparative example

TABLE 17

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 35 | 1 | — | — | — | — | 140 | 1.0 | Comparative |
| | | | | | | | | example |
| 36 | 1 | 15 | 1 | — | — | 140 | 1.0 | Example |
| 37 | 1 | 15 | 5 | — | — | 140 | 1.0 | Example |
| 38 | 1 | 15 | 25 | — | — | 140 | 1.0 | Example |
| 39 | 1 | 15 | 50 | — | — | 140 | 1.0 | Example |
| 40 | 1 | 15 | 100 | — | — | 140 | 1.0 | Example |
| 41 | 1 | 15 | 150 | — | — | 140 | 1.0 | Comparative |
| | | | | | | | | example |
| 42 | 1 | 15 | 15 | — | — | 140 | 1.0 | Example |
| 43 | 1 | 15 | 15 | — | — | 140 | 1.0 | Example |
| 44 | 1 | 15 | 15 | — | — | 140 | 1.0 | Example |
| 45 | 1 | 15 | 15 | — | — | 140 | 1.0 | Example |
| 46 | 1 | 15 | 15 | — | — | 140 | 1.0 | Example |

TABLE 18

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 35 | ◯ | Δ | Δ | ⊚ | — | Comparative |
| | | | | | | example |
| 36 | ◯ | ◯ | ◯ | ⊚ | — | Example |
| 37 | ◯ | ◯+ | ◯+ | ⊚ | — | Example |
| 38 | ◯ | ⊚ | ⊚ | ⊚ | — | Example |
| 39 | ◯ | ⊚ | ⊚ | ⊚ | — | Example |
| 40 | ◯ | ◯ | ◯ | ⊚ | — | Example |
| 41 | ◯ | Δ | Δ | ⊚ | — | Comparative |
| | | | | | | example |
| 42 | ◯ | ⊚ | ⊚ | ⊚ | — | Example |
| 43 | ◯ | ⊚ | ⊚ | ⊚ | — | Example |
| 44 | ◯ | ⊚ | ⊚ | ⊚ | — | Example |
| 45 | ◯ | ⊚ | ⊚ | ⊚ | — | Example |
| 46 | ◯ | ⊚ | ⊚ | ⊚ | — | Example |

TABLE 19

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 47 | 1 | 1 | 140 | 0.3 | 359 | 150 | 163 | 46 | 3.0 | 0.5 | C |
| 48 | 1 | 1 | 140 | 0.3 | 359 | 150 | 163 | 46 | 3.0 | 0.5 | E |
| 49 | 1 | 1 | 140 | 0.3 | 359 | 150 | 163 | 46 | 3.0 | 0.5 | E |
| 50 | 1 | 1 | 140 | 0.3 | 359 | 150 | 163 | 46 | 3.0 | 0.5 | E |
| 51 | 1 | 1 | 140 | 0.3 | 359 | 150 | 163 | 46 | 3.0 | 0.5 | E |
| 52 | 1 | 1 | 140 | 0.3 | 359 | 150 | 163 | 46 | 3.0 | 0.5 | E |
| 53 | 1 | 1 | 140 | 0.3 | 359 | 150 | 163 | 46 | 3.0 | 0.5 | E |
| 54 | 1 | 1 | 140 | 0.3 | 359 | 150 | 163 | 46 | 3.0 | 0.5 | E |
| 55 | 1 | 1 | 140 | 0.3 | 359 | 150 | 163 | 46 | 3.0 | 0.5 | E |
| 56 | 1 | 1 | 140 | 0.3 | 359 | 150 | 163 | 46 | 3.0 | 0.5 | C |

E: Example
C: Comparative example

TABLE 20

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 47 | 1 | 15 | 15 | — | — | 140 | 0.001 | Comparative |
| | | | | | | | | example |
| 48 | 1 | 15 | 15 | — | — | 140 | 0.1 | Example |
| 49 | 1 | 15 | 15 | — | — | 140 | 0.5 | Example |
| 50 | 1 | 15 | 15 | — | — | 140 | 0.7 | Example |
| 51 | 1 | 15 | 15 | — | — | 140 | 2.0 | Example |
| 52 | 1 | 15 | 15 | — | — | 140 | 2.5 | Example |
| 53 | 1 | 15 | 15 | — | — | 140 | 3.0 | Example |
| 54 | 1 | 15 | 15 | — | — | 140 | 4.0 | Example |
| 55 | 1 | 15 | 15 | — | — | 140 | 5.0 | Example |
| 56 | 1 | 15 | 15 | — | — | 140 | 20.0 | Comparative |
| | | | | | | | | example |

TABLE 21

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 47 | ◯ | X | X | Δ | — | Comparative |
| | | | | | | example |
| 48 | ◯ | ◯− | ◯− | ⊚ | — | Example |
| 49 | ◯ | ◯ | ◯ | ⊚ | — | Example |
| 50 | ◯ | ◯+ | ◯+ | ⊚ | — | Example |
| 51 | ◯ | ⊚ | ⊚ | ⊚ | — | Example |
| 52 | ◯ | ⊚ | ⊚ | ⊚ | — | Example |
| 53 | ◯ | ⊚ | ⊚ | ⊚ | — | Example |
| 54 | ◯ | ⊚ | ⊚ | ⊚ | — | Example |
| 55 | ◯ | ⊚ | ⊚ | ⊚ | — | Example |
| 56 | ◯ | ⊚ | ⊚ | ⊚ | — | Comparative |
| | | | | | | example ※1 |

※1 Welding impossible

TABLE 22

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 57 | 1 | 1 | 140 | 0.3 | 359 | 150 | 163 | 46 | 3.0 | 0.5 | C |
| 58 | 1 | 1 | 140 | 0.3 | 359 | 150 | 163 | 46 | 3.0 | 0.5 | E |
| 59 | 1 | 1 | 140 | 0.3 | 359 | 150 | 163 | 46 | 3.0 | 0.5 | E |
| 60 | 1 | 1 | 140 | 0.3 | 359 | 150 | 163 | 46 | 3.0 | 0.5 | E |
| 61 | 1 | 1 | 140 | 0.3 | 359 | 150 | 163 | 46 | 3.0 | 0.5 | E |
| 62 | 1 | 1 | 140 | 0.3 | 359 | 150 | 163 | 46 | 3.0 | 0.5 | E |
| 63 | 1 | 1 | 140 | 0.3 | 359 | 150 | 163 | 46 | 3.0 | 0.5 | E |
| 64 | 1 | 1 | 140 | 0.3 | 359 | 150 | 163 | 46 | 3.0 | 0.5 | E |
| 65 | 1 | 1 | 140 | 0.3 | 359 | 150 | 163 | 46 | 3.0 | 0.5 | E |
| 66 | 1 | 1 | 140 | 0.3 | 359 | 150 | 163 | 46 | 3.0 | 0.5 | C |

E: Example
C: Comparative example

TABLE 23

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 57 | 1 | 15 | 15 | — | — | 40 | 1.0 | Comparative |
| | | | | | | | | example |
| 58 | 1 | 15 | 15 | — | — | 50 | 1.0 | Example |
| 59 | 1 | 15 | 15 | — | — | 80 | 1.0 | Example |
| 60 | 1 | 15 | 15 | — | — | 120 | 1.0 | Example |
| 61 | 1 | 15 | 15 | — | — | 180 | 1.0 | Example |
| 62 | 1 | 15 | 15 | — | — | 200 | 1.0 | Example |
| 63 | 1 | 15 | 15 | — | — | 230 | 1.0 | Example |
| 64 | 1 | 15 | 15 | — | — | 250 | 1.0 | Example |
| 65 | 1 | 15 | 15 | — | — | 350 | 1.0 | Example |
| 66 | 1 | 15 | 15 | — | — | 380 | 1.0 | Comparative |
| | | | | | | | | example |

TABLE 24

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 57 | ◯ | X | X | X | — | Comparative |
| | | | | | | example |
| 58 | ◯ | ◯− | ◯− | ◯ | — | Example |
| 59 | ◯ | ◯ | ◯− | ◯+ | — | Example |
| 60 | ◯ | ⊚ | ◯ | ⊚ | — | Example |
| 61 | ◯ | ⊚ | ⊚ | ⊚ | — | Example |
| 62 | ◯ | ⊚ | ⊚ | ⊚ | — | Example |
| 63 | ◯ | ⊚ | ⊚ | ⊚ | — | Example |
| 64 | ◯ | ⊚ | ⊚ | ⊚ | — | Example |
| 65 | ◯ | ⊚ | ⊚ | ⊚ | — | Example |
| 66 | ◯ | Δ | Δ | ⊚ | — | Comparative |
| | | | | | | example |

TABLE 25

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 67 | 1 | 1 | 140 | 0.3 | 359 | 150 | 163 | 46 | 3.0 | 0.5 | E |
| 68 | 1 | 1 | 140 | 0.3 | 359 | 150 | 163 | 46 | 3.0 | 0.5 | E |
| 69 | 1 | 1 | 140 | 0.3 | 359 | 150 | 163 | 46 | 3.0 | 0.5 | E |
| 70 | 1 | 1 | 140 | 0.3 | 359 | 150 | 163 | 46 | 3.0 | 0.5 | E |
| 71 | 1 | 1 | 140 | 0.3 | 359 | 150 | 163 | 46 | 3.0 | 0.5 | E |
| 72 | 1 | 1 | 140 | 0.3 | 359 | 150 | 163 | 46 | 3.0 | 0.5 | E |
| 73 | 1 | 1 | 140 | 0.3 | 359 | 150 | 163 | 46 | 3.0 | 0.5 | E |
| 74 | 1 | 1 | 140 | 0.3 | 359 | 150 | 163 | 46 | 3.0 | 0.5 | E |
| 75 | 1 | 1 | 140 | 0.3 | 359 | 150 | 163 | 46 | 3.0 | 0.5 | E |
| 76 | 1 | 1 | 140 | 0.3 | 359 | 150 | 163 | 46 | 3.0 | 0.5 | E |
| 77 | 1 | 1 | 140 | 0.3 | 359 | 150 | 163 | 46 | 3.0 | 0.5 | E |
| 78 | 1 | 1 | 140 | 0.3 | 359 | 150 | 163 | 46 | 3.0 | 0.5 | E |
| 79 | 1 | 1 | 140 | 0.3 | 359 | 150 | 163 | 46 | 3.0 | 0.5 | E |
| 80 | 1 | 1 | 140 | 0.3 | 359 | 150 | 163 | 46 | 3.0 | 0.5 | E |

E: Example
C: Comparative example

TABLE 26

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 67 | 1 | 1 | 15 | — | — | 140 | 1.0 | Example |
| 68 | 1 | 2 | 15 | — | — | 140 | 1.0 | Example |
| 69 | 1 | 3 | 15 | — | — | 140 | 1.0 | Example |
| 70 | 1 | 4 | 15 | — | — | 140 | 1.0 | Example |
| 71 | 1 | 5 | 15 | — | — | 140 | 1.0 | Example |
| 72 | 1 | 6 | 15 | — | — | 140 | 1.0 | Example |
| 73 | 1 | 7 | 15 | — | — | 140 | 1.0 | Example |
| 74 | 1 | 8 | 15 | — | — | 140 | 1.0 | Example |
| 75 | 1 | 9 | 15 | — | — | 140 | 1.0 | Example |
| 76 | 1 | 10 | 15 | — | — | 140 | 1.0 | Example |
| 77 | 1 | 11 | 15 | — | — | 140 | 1.0 | Example |
| 78 | 1 | 12 | 15 | — | — | 140 | 1.0 | Example |
| 79 | 1 | 13 | 15 | — | — | 140 | 1.0 | Example |
| 80 | 1 | 14 | 15 | — | — | 140 | 1.0 | Example |

TABLE 27

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 67 | ◯ | ◯ | ◯ | ⊚ | — | Example |
| 68 | ◯ | ◯ | ◯ | ⊚ | — | Example |
| 69 | ◯ | ◯ | ◯ | ⊚ | — | Example |
| 70 | ◯ | ◯ | ◯ | ⊚ | — | Example |
| 71 | ◯ | ◯ | ◯ | ⊚ | — | Example |
| 72 | ◯ | ◯ | ◯ | ⊚ | — | Example |
| 73 | ◯ | ◯ | ◯ | ⊚ | — | Example |
| 74 | ◯ | ◯ | ◯ | ⊚ | — | Example |
| 75 | ◯ | ◯ | ◯ | ⊚ | — | Example |
| 76 | ◯ | ◯ | ◯ | ⊚ | — | Example |
| 77 | ◯ | ◯ | ◯ | ⊚ | — | Example |
| 78 | ◯ | ◯+ | ◯+ | ⊚ | — | Example |
| 79 | ◯ | ◯+ | ◯+ | ⊚ | — | Example |
| 80 | ◯ | ◯+ | ◯+ | ⊚ | — | Example |

TABLE 28

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 82 | 1 | 1 | 140 | 0.3 | 359 | 150 | 163 | 46 | 3.0 | 0.5 | E |
| 83 | 1 | 1 | 140 | 0.3 | 359 | 150 | 163 | 46 | 3.0 | 0.5 | E |
| 84 | 1 | 1 | 140 | 0.3 | 359 | 150 | 163 | 46 | 3.0 | 0.5 | E |
| 85 | 1 | 1 | 140 | 0.3 | 359 | 150 | 163 | 46 | 3.0 | 0.5 | E |
| 86 | 1 | 1 | 140 | 0.3 | 359 | 150 | 163 | 46 | 3.0 | 0.5 | E |
| 87 | 1 | 1 | 140 | 0.3 | 359 | 150 | 163 | 46 | 3.0 | 0.5 | E |
| 88a | 1 | 1 | 140 | 0.3 | 359 | 150 | 163 | 46 | 3.0 | 0.5 | E |
| 88b | 1 | 1 | 140 | 0.3 | 359 | 150 | 163 | 46 | 3.0 | 0.5 | E |
| 88c | 1 | 1 | 140 | 0.3 | 359 | 150 | 163 | 46 | 3.0 | 0.5 | E |
| 88d | 1 | 1 | 140 | 0.3 | 359 | 150 | 163 | 46 | 3.0 | 0.5 | E |
| 88e | 1 | 1 | 140 | 0.3 | 359 | 150 | 163 | 46 | 3.0 | 0.5 | E |
| 88f | 1 | 1 | 140 | 0.3 | 359 | 150 | 163 | 46 | 3.0 | 0.5 | E |
| 88g | 1 | 1 | 140 | 0.3 | 359 | 150 | 163 | 46 | 3.0 | 0.5 | E |
| 89 | 1 | 1 | 140 | 0.3 | 359 | 150 | 163 | 46 | 3.0 | 0.5 | E |
| 90 | 1 | 1 | 140 | 0.3 | 359 | 150 | 163 | 46 | 3.0 | 0.5 | E |

E: Example
C: Comparative example

TABLE 29

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 82 | 1 | 16 | 15 | — | — | 140 | 1.0 | Example |
| 83 | 1 | 17 | 15 | — | — | 140 | 1.0 | Example |
| 84 | 1 | 18 | 15 | — | — | 140 | 1.0 | Example |
| 85 | 1 | 19 | 15 | — | — | 140 | 1.0 | Example |
| 86 | 1 | 20 | 15 | — | — | 140 | 1.0 | Example |
| 87 | 1 | 21 | 15 | — | — | 140 | 1.0 | Example |
| 88a | 1 | 1 | 15 | 1 | 10 | 140 | 1.0 | Example |
| 88b | 1 | 5 | 15 | 1 | 10 | 140 | 1.0 | Example |
| 88c | 1 | 7 | 15 | 1 | 10 | 140 | 1.0 | Example |
| 88d | 1 | 12 | 15 | 1 | 10 | 140 | 1.0 | Example |
| 88e | 1 | 13 | 15 | 1 | 10 | 140 | 1.0 | Example |
| 88f | 1 | 14 | 15 | 1 | 10 | 140 | 1.0 | Example |
| 88g | 1 | 15 | 15 | 1 | 10 | 140 | 1.0 | Example |
| 89 | 1 | 1 | 15 | 2 | 10 | 140 | 1.0 | Example |
| 90 | 1 | 1 | 15 | 3 | 10 | 140 | 1.0 | Example |

TABLE 30

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 82 | ◯ | ◯+ | ◯+ | ⊚ | — | Example |
| 83 | ◯ | ◯+ | ◯+ | ⊚ | — | Example |
| 84 | ◯ | ◯+ | ◯+ | ⊚ | — | Example |
| 85 | ◯ | ◯+ | ◯+ | ⊚ | — | Example |
| 86 | ◯ | ⊚ | ⊚ | ⊚ | — | Example |
| 87 | ◯ | ⊚ | ⊚ | ⊚ | — | Example |
| 88a | ◯ | ◯ | ◯ | ⊚ | ⊚ | Example |
| 88b | ◯ | ◯ | ◯ | ⊚ | ⊚ | Example |
| 88c | ◯ | ◯ | ◯ | ⊚ | ⊚ | Example |
| 88d | ◯ | ◯+ | ◯+ | ⊚ | ⊚ | Example |
| 88e | ◯ | ◯+ | ◯+ | ⊚ | ⊚ | Example |
| 88f | ◯ | ◯+ | ◯+ | ⊚ | ⊚ | Example |
| 88g | ◯ | ⊚ | ⊚ | ⊚ | ⊚ | Example |
| 89 | ◯ | ◯ | ◯ | ⊚ | ⊚ | Example |
| 90 | ◯ | ◯ | ◯ | ⊚ | ⊚ | Example |

TABLE 31

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 91 | 1 | 1 | 140 | 0.3 | 359 | 150 | 163 | 46 | 3.0 | 0.5 | E |
| 92 | 1 | 1 | 140 | 0.3 | 359 | 150 | 163 | 46 | 3.0 | 0.5 | E |
| 93 | 1 | 1 | 140 | 0.3 | 359 | 150 | 163 | 46 | 3.0 | 0.5 | E |
| 94 | 1 | 1 | 140 | 0.3 | 359 | 150 | 163 | 46 | 3.0 | 0.5 | E |
| 95 | 1 | 1 | 140 | 0.3 | 359 | 150 | 163 | 46 | 3.0 | 0.5 | E |
| 96 | 1 | 1 | 140 | 0.3 | 359 | 150 | 163 | 46 | 3.0 | 0.5 | E |
| 97 | 1 | 1 | 140 | 0.3 | 359 | 150 | 163 | 46 | 3.0 | 0.5 | E |
| 98 | 1 | 1 | 140 | 0.3 | 359 | 150 | 163 | 46 | 3.0 | 0.5 | C |

E: Example
C: Comparative example

TABLE 32

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 91 | 1 | 15 | 15 | 4 | 10 | 140 | 1.0 | Example |
| 92 | 1 | 15 | 15 | 5 | 10 | 140 | 1.0 | Example |
| 93 | 1 | 15 | 15 | 6 | 10 | 140 | 1.0 | Example |
| 94 | 1 | 15 | 15 | 1 | 1 | 140 | 1.0 | Example |
| 95 | 1 | 15 | 15 | 1 | 3 | 140 | 1.0 | Example |
| 96 | 1 | 15 | 15 | 1 | 40 | 140 | 1.0 | Example |
| 97 | 1 | 15 | 15 | 1 | 80 | 140 | 1.0 | Example |
| 98 | 1 | 15 | 15 | 1 | 100 | 140 | 1.0 | Comparative |
| | | | | | | | | example |

TABLE 33

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 91 | ◯ | ⊚ | ⊚ | ⊚ | ⊚ | Example |
| 92 | ◯ | ⊚ | ⊚ | ⊚ | ⊚ | Example |
| 93 | ◯ | ⊚ | ⊚ | ◯ | ⊚ | Example |
| 94 | ◯ | ⊚ | ⊚ | ⊚ | ◯ | Example |
| 95 | ◯ | ⊚ | ⊚ | ⊚ | ⊚ | Example |
| 96 | ◯ | ⊚ | ⊚ | ⊚ | ⊚ | Example |
| 97 | ◯ | ⊚ | ⊚ | ◯ | ⊚ | Example |
| 98 | ◯ | ⊚ | ⊚ | X | ⊚ | Comparative |
| | | | | | | example |

TABLE 34

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 99 | 1 | 1 | 140 | 0.001 | 1.2 | 0.5 | 0.5 | 0.2 | 3.0 | 0.5 | C |
| 100 | 1 | 1 | 140 | 0.005 | 6 | 2.5 | 2.5 | 1 | 3.0 | 0.5 | E |
| 101 | 1 | 1 | 140 | 0.01 | 12 | 5 | 5 | 2 | 3.0 | 0.5 | E |
| 102 | 1 | 1 | 140 | 0.1 | 120 | 51 | 54 | 15 | 3.0 | 0.5 | E |
| 103 | 1 | 1 | 140 | 0.5 | 599 | 250 | 272 | 77 | 3.0 | 0.5 | E |
| 104 | 1 | 1 | 140 | 1.0 | 1197 | 500 | 544 | 153 | 3.0 | 0.5 | E |
| 105 | 1 | 1 | 140 | 2 | 2395 | 1000 | 1089 | 306 | 3.0 | 0.5 | E |
| 106 | 1 | 1 | 140 | 3 | 3591 | 1500 | 1633 | 458 | 3.0 | 0.5 | E |
| 107 | 1 | 1 | 140 | 5 | 5986 | 2500 | 2722 | 764 | 3.0 | 0.5 | C |

E: Example
C: Comparative example

TABLE 35

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 99 | 1 | 15 | 15 | — | — | 140 | 1.0 | Comparative |
| | | | | | | | | example |
| 100 | 1 | 15 | 15 | — | — | 140 | 1.0 | Example |
| 101 | 1 | 15 | 15 | — | — | 140 | 1.0 | Example |
| 102 | 1 | 15 | 15 | — | — | 140 | 1.0 | Example |
| 103 | 1 | 15 | 15 | — | — | 140 | 1.0 | Example |
| 104 | 1 | 15 | 15 | — | — | 140 | 1.0 | Example |
| 105 | 1 | 15 | 15 | — | — | 140 | 1.0 | Example |
| 106 | 1 | 15 | 15 | — | — | 140 | 1.0 | Example |
| 107 | 1 | 15 | 15 | — | — | 140 | 1.0 | Comparative |
| | | | | | | | | example |

TABLE 36

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 99 | ◯ | X | X | ⊚ | — | Comparative |
| | | | | | | example |
| 100 | ◯ | ◯− | ◯− | ⊚ | — | Example |
| 101 | ◯ | ◯ | ◯ | ⊚ | — | Example |
| 102 | ◯ | ◯+ | ◯+ | ⊚ | — | Example |
| 103 | ◯ | ⊚ | ⊚ | ⊚ | — | Example |
| 104 | ◯ | ⊚ | ⊚ | ⊚ | — | Example |
| 105 | ◯ | ⊚ | ⊚ | ⊚ | — | Example |
| 106 | ◯ | ⊚ | ⊚ | ⊚ | — | Example |
| 107 | ◯ | ⊚ | ⊚ | ⊚ | — | Comparative |
| | | | | | | example ※1 |

※1 Welding impossible

TABLE 37

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of | | |
| | steel | Film | Drying | Film | coating | Composition | Composition | Composition | film components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 108 | 1 | 1 | 30 | 0.3 | 359 | 150 | 163 | 46 | 3.0 | 0.5 | C |
| 109 | 1 | 1 | 50 | 0.3 | 359 | 150 | 163 | 46 | 3.0 | 0.5 | E |
| 110 | 1 | 1 | 80 | 0.3 | 359 | 150 | 163 | 46 | 3.0 | 0.5 | E |
| 111 | 1 | 1 | 120 | 0.3 | 359 | 150 | 163 | 46 | 3.0 | 0.5 | E |
| 112 | 1 | 1 | 180 | 0.3 | 359 | 150 | 163 | 46 | 3.0 | 0.5 | E |
| 113 | 1 | 1 | 200 | 0.3 | 359 | 150 | 163 | 46 | 3.0 | 0.5 | E |
| 114 | 1 | 1 | 300 | 0.3 | 359 | 150 | 163 | 46 | 3.0 | 0.5 | E |
| 115 | 1 | 1 | 350 | 0.3 | 359 | 150 | 163 | 46 | 3.0 | 0.5 | C |

E: Example
C: Comparative example

TABLE 38

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 108 | 1 | 15 | 15 | — | — | 140 | 1.0 | Comparative |
| | | | | | | | | example |
| 109 | 1 | 15 | 15 | — | — | 140 | 1.0 | Example |
| 110 | 1 | 15 | 15 | — | — | 140 | 1.0 | Example |
| 111 | 1 | 15 | 15 | — | — | 140 | 1.0 | Example |
| 112 | 1 | 15 | 15 | — | — | 140 | 1.0 | Example |
| 113 | 1 | 15 | 15 | — | — | 140 | 1.0 | Example |
| 114 | 1 | 15 | 15 | — | — | 140 | 1.0 | Example |
| 115 | 1 | 15 | 15 | — | — | 140 | 1.0 | Comparative |
| | | | | | | | | example |

TABLE 39

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 108 | ◯ | X | X | X | — | Comparative |
| | | | | | | example |
| 109 | ◯ | ◯− | ◯− | ◯ | — | Example |
| 110 | ◯ | ⊚ | ⊚ | ⊚ | — | Example |
| 111 | ◯ | ⊚ | ⊚ | ⊚ | — | Example |
| 112 | ◯ | ⊚ | ⊚ | ⊚ | — | Example |
| 113 | ◯ | ⊚ | ⊚ | ⊚ | — | Example |
| 114 | ◯ | ⊚ | ⊚ | ⊚ | — | Example |
| 115 | ◯ | X | X | ⊚ | — | Comparative |
| | | | | | | example |

### Embodiment 2

The inventors of the present invention found a method to obtain a steel sheet with organic coating that induces no pollution and that has extremely strong corrosion resistance without applying chromate treatment which may give bad influence on environment and on human body. The method is to form a specific oxide coating as the first coating layer on the surface of a zinc-base plated steel sheet or an aluminum-base plated steel sheet, then to form an organic coating as the second coating layer consisting mainly of a specific organic polymer resin as the base resin, which base resin contains an adequate amount of specific self-repairing material (rust-preventive additive component) substituting hexavalent chromium.

Basic features of the present invention are: forming a composite oxide coating as the first coating layer which contains, (preferably contains as the major component), (α) oxide fine particles, (β) at least one substance selected from the group consisting of a phosphate and/or a phosphoric acid compound, and (γ) at least one metal selected from the group consisting of Mg, Mn, and Al, (including the case of being contained as a compound and/or a composite compound); further forming an organic coating as the second coating layer on the first layer, which second coating layer contains a film-forming polymer resin (A) having OH group and/or COOH group as the base resin, (preferably a thermosetting resin, more preferably an epoxy resin and/or a modified epoxy resin), and a rust-preventive additive component (B) as the self-repairing material (rust-preventive additive component) consisting mainly of (a) a Ca ion exchanged silica and a phosphate, (b) a Ca ion exchanged silica, a phosphate, and a silicon oxide, (c) a calcium compound and a silicon oxide, (d) a calcium compound, a phosphate, and a silicon oxide, (e) a molybdenate, (f) at least one organic compound selected from the group consisting of a triazole, a thiol, a thiadiazole, a thiazole, and a thiuram, or (e) and/or (f) blended with other component.

The corrosion resistance mechanism of the two layer coating structure consisting of that kind of specific composite oxide coating and the organic coating is not fully analyzed. However, the excellent corrosion resistance equivalent to that of chromate film is attained even with a thin coating owing to the combination of the effect of corrosion suppression by the composite oxide coating of the first coating layer and the effect of barrier by the film-forming resin as the second coating layer, which is described below.

The corrosion resistance mechanism of the composite oxide coating as the above-described first coating layer is not fully analyzed. However, the excellent corrosion resistance is attained presumably from the effects that (1) the dense and insoluble composite oxide coating seals the corrosion cause elements as a barrier film; (2) the fine oxide particles such as those of silicon oxide form a stable and dense barrier film together with phosphoric acid and/or a phosphoric acid compound and at least one metal selected from the group consisting of Mg, Mn, and Al; and (3) if the fine oxide particles are those of silicon oxide, the silicate ion enhances the formation of basic zinc chloride under a corrosion environment, thus improving the barrier performance.

The corrosion resistance mechanism of the organic coating as the above-described second coating layer is not fully analyzed. However, the excellent corrosion resistance (barrier performance) is attained presumably because the organic polymer resin (A) containing OH group and/or COOH group, (preferably a thermosetting resin, more preferably an epoxy resin and/or a modified epoxy resin) reacts with a crosslinking agent to form a dense barrier coating, which barrier coating has excellent performance to suppress transparency of corrosion causes such as oxygen, and because the OH group and COOH group in molecule provide strong bonding force with the base material.

Furthermore, particularly superior corrosion resistance performance (self-repairing effect) is obtained with the above-described organic coating consisting essentially of a specific organic polymer resin, which coating contains an adequate amount of a rust-preventive additive component (B), (self-repairing substance) consisting any one of:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate,

(f) at least one organic compound selected from the group consisting of a triazole, a thiol, a thiadiazole, a thiazole, and a thiuram;

or (e) and/or (f) further containing other component. The corrosion preventive mechanism obtained by blending the above-described components (a) through (f) into the specific organic coating is supposedly the following.

The above-given components (a) through (d) give the self-repairing performance by their precipitation action, and the reaction mechanism presumably proceeds in a sequence of the following-described steps.

[First step]

Under a corrosive environment, calcium which is less noble than zinc and aluminum, which are the plating metals, preferentially dissolves.

[Second step]

For the case of phosphate, the phosphoric acid ion dissociated by hydrolysis induces a complex-forming reaction with the calcium ion preferentially dissolved in the first step. For the case of silicon oxide, the calcium ion preferentially dissolved in the first step is adsorbed to the surface of the silicon oxide, which then electrically neutralizes the surface charge to coagulate the silicon oxide particles. As a result, for both cases, a dense and insoluble protective film is formed to seal the origin of corrosion, thus to suppress the corrosion reactions.

The above-given component (e) generates the self-repairing performance by the passivation effect. That is, under a corrosion environment, the component (e) forms a dense oxide on the surface of the plated coating together with the dissolved oxygen, which dense oxide seals the origin of corrosion to suppress the corrosion reactions.

The above-given component (f) generates the self-repairing performance by the adsorption effect. That is, zinc and aluminum eluted by corrosion are adsorbed by polar groups containing nitrogen and sulfur, existing in the component (f), to form an inert film, which film seals the origin of corrosion to suppress the corrosion reactions.

Also for the case that above-described components (a) through (f) are blended in ordinary organic coating, corrosion preventive effect can be obtained to some extent. However, by blending the self-repairing materials of above-described (a) through (f) in the organic coating consisting of a specific chelete-modified resin having excellent barrier performance, as in the case of the present invention, the effect of both of the barrier performance and the self-repairing effect presumably combines to give very strong corrosion preventive effect.

Considering the self-repairing effect obtained by each component of above-given (a) through (d), (e), and (f), to obtain stronger self-repairing performance, it is preferable to adopt the above-given (e) and/or (f) as the essential component and to blend a rust-preventive component (Y) consisting of compounds given below. In particular, the cases of (6) and (7) provide the highest self-repairing performance (or white rust resistance).

(1) A rust-preventive component prepared by blending (e) a molybdenate, (g) at least one substance selected from the group consisting of calcium and calcium compounds, and (h) at least one compound selected from the group consisting of a phosphate and a silicon oxide.

(2) A rust-preventive component prepared by blending (e) a molybdenate, and (i) a Ca ion exchanged silica.

(3) A rust-preventive component prepared by blending (f) at least one compound selected from the group consisting of a triazole, a thiol, a thiadiazole, a thiazole, and a thiuram, (g) at least one substance selected from the group consisting of calcium and calcium compounds, (h) at least one compound selected from the group consisting of a phosphate and a silicon oxide.

(4) A rust-preventive component prepared by blending (f) at least one compound selected from the group consisting of a triazole, a thiol, a thiadiazole, a thiazole, and a thiuram, and (i) a Ca ion exchanged silica.

(5) A rust-preventive component prepared by blending (e) a molybdenate, and (f) at least one organic compound selected from the group consisting of a triazole, a thiol, a thiadiazole, a thiazole, and a thiuram.

(6) A rust-preventive component prepared by blending (e) a molybdenate, (f) at least one organic compound selected from the group consisting of a triazole, a thiol, a thiadiazole, a thiazole, and a thiuram, (g) at least one substance selected from the group consisting of calcium and a calcium compound, and (h) at least one compound selected from the group consisting of a phosphate and a silicon oxide.

(7) A rust-preventive component prepared by blending (e) a molybdenate, (f) at least one organic compound selected from the group consisting of a triazole, a thiol, a thiadiazole, a thiazole, and a thiuram, and (i) a Ca ion exchanged silica.

The following is the detail description of the present invention and the description about the reason to limit the conditions.

The following is the description of the composite oxide coating as the first layer coating formed on the surface of a zinc-base plated steel sheet or an aluminum-base plated steel sheet.

The composite oxide coating is quite different from the alkali silicate treated coating represented by a conventional coating composition consisting of lithium oxide and silicon oxide, the composite oxide coating contains (preferably contains as the main components):

(α) oxide fine particles (preferably those of silicon oxide),

(β) a phosphate and/or a phosphoric acid compound, and

(γ) at least one metal selected from the group consisting of Mg, Mn, and Al, (including the case of containing as a compound and/or a composite compound).

The oxide fine particles as the above-described (α) are preferably those of silicon oxide (SiO₂ fine particles). As of the silicon oxide, colloidal silica is most preferable.

A preferable silicon oxide is that having particle sizes of 14 nm or less, more preferably 8 nm or less, from the viewpoint of corrosion resistance.

The silicon oxide may be the one prepared by dispersion dry silica fine particles in a solution of coating composition. Examples of preferable dry silica are the products of Nippon Aerosil Co., Ltd., namely, Aerosil 200, Aerosil 3000, Aerosil 300CF, and Aerosil 380, and the one having particle sizes of 12 nm or smaller is preferable, and 7 nm or smaller is more preferable.

Applicable examples of the oxide fine particles are, other than the above-described silicon oxide, a colloidal solution and a fine particles of aluminum oxide, zirconium oxide, titanium oxide, cerium oxide, and antimony oxide.

From the standpoint of corrosion resistance and of weldability, preferable coating weight of the above-described component (α) is in a range of from 0.10 to 3,000 mg/m², more preferably from 0.1 to 1,000 mg/m², and most preferably from 1 to 500 mg/m².

The phosphoric acid and/or phosphoric acid compound as the above-described component (β) can be prepared, for example, by adding one or more of metallic salt or compound of orthophosphoric acid, diphosphoric acid, metha-phosphoric acid, or the like to the coating composition as the blend of coating components. Furthermore, one or more of organic phosphoric acid and its salt (for example, phytic acid, phytic acid salt, phsophonic acid, phosphonic acid salt, and their metallic salt) may be added to the coating composition. Among them, primary phosphates are preferable in view of stability of the solution of coating composition.

The existing mode of phosphoric acid and phosphoric acid compound in the coating is not specifically limited, and they may be crystal or amorphous state. Also the ionicity and solubility of the phosphoric acid and phosphoric acid compound in the coating are not specifically limited.

From the viewpoint of corrosion resistance and of weldability, a preferable coating weight of the above-described component (β) is in a range of from 0.01 to 3,000 mg/m² as P₂O₅ converted value, more preferably from 0.1 to 1,000 mg/m², and most preferably from 1 to 500 mg/m².

The existing mode of one or more of the metals selected from the group consisting of Mg, Mn, and Al, which is the above-described component (γ) is not specifically limited, and they may be in a form of metal, or compound or composite compound of oxide, hydroxide, hydrate, phosphoric acid compound, or coordinated compound. The ionicity and solubility of these compound, oxide, hydroxide, hydrate, phosphoric acid compound, and coordinated compound are also not specifically limited.

The method to introduce the component (γ) into the coating may be the addition of Mg, Mn, and Al as a phosphate, a sulfate, a nitrate, and a chloride to the coating composition.

From the standpoint of corrosion resistance and prevention of reduction in appearance, a preferable coating weight of the above-described component (γ) is in a range of from 0.01 to 1,000 mg/m² as metal converted value, more preferably from 0.1 to 500 mg/m², and most preferably from 1 to 100 mg/m².

A preferable molar ratio of the (α) oxide fine particles and (γ) one or more metal (including the case of contained as a compound and/or composite compound) selected from the group consisting of Mn, Mn, and Al, (α)/(γ), as the structure components of composite oxide coating, (the component (γ) is the metal converted value of the above-described metal), is in a range of from 0.1 to 20, more preferably from 0.1 to 10. If the molar ratio (α)/(γ) is less than 0.1, the effect of addition of the oxide fine particles are not fully attained. If the ratio (α)/(γ) exceeds 20, the oxide fine particles hinder the densification of the coating.

A preferable molar ratio of the (β) phosphoric acid and/or a phosphoric acid compound to (γ) at least one metal selected from the group consisting of Mg, Mn, and Al, (including the case of existence in a form of compound and/or composite compound), (γ)/(β), (the component (β) is as P₂O₅ converted value, and the component (γ) is as metal converted value of the above-given metal), is in a range of from 0.1 to 1.5. If the molar ratio is less than 0.1, the soluble phosphoric acid damages the insolubility of the composite oxide coating, and degrades the corrosion resistance thereof, which is unfavorable. If the molar ratio exceeds 1.5, stability of the treating liquid significantly decreases, which is also unfavorable.

Aiming at the improvement of workability and corrosion resistance of coating, the composite oxide coating may further contain an organic resin. Examples of the organic resin are one or more of epoxy resin, urethane resin, acrylic resin, acrylic-ethylene resin, acrylic-styrene copolymer, alkyd resin, polyester resin, and ethylene resin. They can be introduced to the coating in a form of water-soluble resin and/or water-dispersible resin.

Adding to these water-base resins, parallel use of a water-soluble epoxy resin, a water-soluble phenol resin, a water-soluble butadiene rubber (SBR, NBR, MBR), a melamine resin, a block isocyanate compound, and an oxazoline compound, as the crosslinking agent is effective.

As an additive to further improving the corrosion resistance, the composite oxide coating may further contain one or more of a polyphosphate, a phosphate (for example, zinc phosphate, dihydrogen aluminum phosphate, and zinc phosphate), a molybdenate, a phosphomolybdate (for example, aluminum phosphomolybdate), an organic acid and a salt thereof (for example, phitic acid, phitic acid salt, phosphonic acid, phosphonate, metallic salt of them, and alkali metal salt), an organic inhibitor (for example, hydrazine derivative, thiol compound, dithiocarbamate), and an organic compound (for example, polyethyleneglycol).

Examples of other additive are one or more of an organic colored pigment (for example, condensation polycyclic-base organic pigment, phthalocyanine base organic pigment), a colored dye (for example, organic solvent soluble azo-base dye, water-soluble azo-base metallic dye), an inorganic pigment (for example, titanium oxide), a cheleting agent (for example, thiol), a conductive pigment (for example, metallic powder such as that of zinc, aluminum, and nickel, iron phosphide, antimony dope type tin oxide), a coupling agent (for example, silane coupling agent and titanium coupling agent), and a melamine-cyanuric acid additive.

To prevent blacking (a kind of oxidization phenomena on the surface of plating) of a steel sheet with an organic coating under use environments, the composite oxide coating may further contain one or more of iron-base metallic ions (Ni ion, Co ion, Fe ion). Among these metallic ions, Ni ion is most preferable. In that case, favorable effect is attained at 1/10,000 M or more of the iron-base metallic ion concentration to 1 M (metal converted value) of the component (γ) in the treating composition. Although the upper limit of the iron-base ion concentration is not specifically specified, a favorable level thereof is to a degree that does not give influence on the corrosion resistance under increasing concentration condition. And, a preferable level thereof is 1 M to the component (γ) (metal converted value), more preferably around 1/100 M.

A preferable thickness of the composite oxide coating is in a range of from 0.005 to 3 μm, more preferably from 0.01 to 2 μm, still further preferably from 0.1 to 1 μm, and most preferably from 0.2 to 5 μm. If the thickness of the composite oxide coating is less than 0.005 μm, the corrosion resistance degrades. If the thickness thereof exceeds 3 μm, the conductivity including weldability degrades. When the composite oxide coating is defined by the coating weight thereof, it is adequate to select the total coating weight of the above-described component (α), the above-described component (β) converted to P₂O₅, and above-described component (γ) converted to metal, in a range of from 6 to 3,600 mg/m², more preferably from 10 to 1,000 mg/m², still more preferably from 50 to 500 mg/m², still further preferably from 100 to 500 mg/m², and most preferably from 200 to 400 mg/². If the total coating weight is less than 6 mg/m², the corrosion resistance degrades. If the total coating weight exceeds 3,600 mg/m², the conductivity reduces to degrade the weldability.

The following is the description of the organic coating formed as the second coating layer on the above-described composite oxide coating.

According to the present invention, the organic coating formed on the composite oxide coating is the one having thicknesses of from 0.1 to 5 μm, comprising a reaction product (X) obtained from the reaction between a film-forming organic resin (A) and a compound (B) containing activated hydrogen consisting of a hydrazine derivative (C) a part or whole of the compound thereof having activated hydrogen, and a self-repairing material of rust-preventive additive component (Y) of either one of the following-given (a) through (f), or a rust-preventive additive component (Y) blending other components to the above-given (e) and/or (f), further, at need, a solid lubricant:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one organic compound selected from the group consisting of a triazole, a thiol, a thiadiazole, a thiazole, and a thiuram.

The base resin of the organic coating uses the organic polymer resin (A) containing OH group and/or COOH group. As of the organic polymer resin (A), a thermosetting resin is preferred, and particularly an epoxy resin or a modified epoxy resin is particularly favorable.

Examples of the organic polymer resin containing OH group and/or COOH group are epoxy resin, polyhydropolyether resin, acrylic base copolymer resin, ethylene-acrylic acid copolymer resin, alkyd resin, polybutadiene resin, phenol resin, polyurethane resin, polyamine resin, polyphenylene resin, and a mixture or an addition polymerization product of two or more thereof.

(1) Epoxy resin

Examples of applicable epoxy resin are: epoxy resin prepared by glycidyl-etherified Bisphenol A, Bisphenol F, novolak, or the like; epoxy resin prepared by adding propylene oxide, ethylene oxide, or polyalkylene glycol to Bisphenol A, then by glycidyl-etherized them; aliphatic epoxy resin; alicyclic epoxy resin; and polyether base epoxy resin.

When particularly low temperature curing is required, these epoxy resins preferably have 1,500 or higher number average molecular weight. The above-described epoxy resins may be used separately or mixing two or more of them.

The modified epoxy resin may be the one prepared by reacting the epoxy group or the hydroxyl group in the above-described epoxy resins with various kinds of modifiers. Examples of them are: epoxy-ester resin prepared by reacting the carboxylic group in a dry oil fatty acid; epoxy-acrylate resin modified by acrylic acid, methacrylic acid, or the like; urethane-modified epoxy resin prepared by reacting with isocyanate compound; and amine-added urethane-modified epoxy resin prepared by adding alkanolamine to urethane-modified epoxy resin prepared by reacting epoxy resin with isocyanate compound.

The above-described hydroxy-polyether resin is a polymer prepared by polycondensation of divalent phenol of mononuclear or dinuclear type, or divalent phenol of a mixture of mononuclear type and dinuclear type, with almost equal moles of epihalohydrin under the presence of an alkali catalyst. Typical examples of the mononuclear type divalent phenol are resorcin and catechol. Typical example of the dinuclear type phenol is Bisphenol A. They may be used separately or mixing of two or more thereof.

(2) Urethance resin

Examples of the urethane resin are: oil-modified polyurethane resin, alkyd-base polyurethane resin; polyester base polyurethane resin; polyether base polyurethane resin; and polycarbonate base polyurethane resin.

(3) Alkyd resin

Examples of the alkyd resin are: oil-modified alkyd resin; resin-modified alkyd resin; phenol-modified alkyd resin; styrenated alkyd resin; silicon-modified alkyd resin; acrylic-modified alkyd resin; oil-free alkyd resin; and high molecular weight oil-free alkyd resin.

(4) Acrylic resin

Examples of the acrylic resin are: polyacrylic acid and a copolymer thereof; polyacrylate and copolymer thereof; polymethacrylate and copolymer thereof; polymethacrylate and copolymer thereof; urethane-acrylic acid copolymer (or urethane-modified acrylic resin); and styrene-acrylic acid copolymer. Furthermore, resins of above-given modified by other alkyd resins, epoxy resins, phenol resins, or the like may be used.

(5) Ethylene resin (polyolefin resin)

Examples of the ethylene resin are: ethylene-base copolymer such as ethylene-acrylic acid copolymer, ethylene-methacrylic acid copolymer, and carboxylic-modified polyolefin resin; ethylene-unsaturated carboxylic acid copolymer; and ethylene base ionomer. Furthermore, resins of above-given modified by other alkyd resins, epoxy resins, phenol resins, or the like may be used.

(6) Acrylic-silicon resin

Example of the acrylic-silicon resin is the one containing a hydrolyzing alkoxysilyl at side chain or terminal of molecule of an acrylic-base copolymer as the main component, further containing a curing agent. With use of that kind of acrylic-silicon resin, excellent weather resistance is expected.

(7) Fluororesin

Applicable fluororesin includes fluoro-olefin-base copolymer. The fluoro-olefin-base copolymer may be copolymerized with a monomer such as alkylvinylether, cycloalkylvinylether, carboxylic acid modified vinylester, hydroxyalkylallylether, and tetrafluoropropylvinylether, and with fluorine monomer (fluoro-olefin). With use of that kind of fluororesin, excellent weather resistance and hydrophobicity are expected.

Aiming at the reduction of drying temperature of resin, resins having different kinds thereof between the core and the shell of the resin particles, or core-shell type water dispersible resins structured by different glass transition temperatures can be used.

Furthermore, by use of a water-dispersible resin having self-crosslinking performance, and by, for example, adding alkosilane group to the resin particles to utilize the interparticle crosslink using the generation of silanol group yielded from the hydrolysis of alkoxysilane during the resin heating and drying and using the dehydration condensation reaction between resin particles.

As the resin used in the organic coating, an organic composite silicate prepared by combining the organic resin with silica using a silane coupling agent is also preferable.

Aiming at the improvement of corrosion resistance and workability of the organic coating, the present invention particularly prefers to use thermosetting resins. In that case, curing agents may be blended to the organic coating. Examples of the curing agent are: amino resin such as urea resin (butylated urea resin, and the like), melamine resin (butylated melamine resin, and the like), and butylated urea melamine resin; block isocyanate oxazolin compound; and phenol resin.

From the point of corrosion resistance, workability, and coatability, epoxy resins and ethylene-base resins are preferred among the above-described organic resins. In particular, thermosetting epoxy resins and modified epoxy resins, which have excellent sealing performance to corrosion causes such as oxygen, are suitable. Examples of these thermosetting resins are: thermosetting epoxy resin; thermosetting modified epoxy resin; acrylic-base copolymer resin copolymerized with epoxy group containing monomer; poylbutadiene resin containing epoxy group; poyurethane resin containing epoxy group; and additives and condensates of these resins. These epoxy resins may be used separately or as a mixture of two or more thereof.

According to the present invention, the organic coating contains a rust-preventive additive (γ), which is a self-repairing material, either one of (a) through (f) given below.

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate,

(f) at least one organic compound selected from the group consisting of a triazole, a thiol, a thiadiazole, a thiazole, and a thiuram; or

(e) and/or (f) further containing other component.

The mechanism of corrosion prevention owing to these components (a) through (f) is described before.

The Ca ion exchanged silica contained in the above-given components (a) and (b) is prepared by fixing calcium ions onto porous silica gel powder. The Ca ions are released under a corrosive environment to form a precipitate film.

The Ca ion exchanged silica may be arbitrary one. The average particle size thereof is preferably 6 μm or smaller, more preferably 4 μm or smaller. For example, the Ca ion exchanged silica having average particle sizes of from 2 to 4 μm can be applied. If the average particle size of the Ca ion exchanged silica exceeds 6 μm, the corrosion resistance degrades and the dispersion stability in a coating composition degrades.

A preferable Ca concentration in the Ca ion exchanged silica is 1 wt. % or more, and more preferably from 2 to 8 wt. %. If the Ca concentration is less than 1 wt. %, the rust-preventive effect by the Ca release cannot fully be attained. The surface area, pH, and oil absorption capacity of the Ca ion exchanged silica are not specifically limited.

The phosphate contained in the above-described components (a), (b), and (d) includes all kinds of salt such as simple salt and double salt. The metallic cations structuring the salt is not limited, and they may be a metallic cation of zinc phosphate, magnesium phosphate, calcium phosphate, and aluminum phosphate. The skeleton and the degree of condensation of the phosphoric ion are also not limited, and they may be normal salt, dihydrogen salt, monohydrogen salt, or phosphate. Furthermore, the normal salt includes orthophosphate, and all kinds of condensation phosphate such as polyphosphate.

The calcium compound included in the above-described components (c) and (d) may be any one of calcium oxide, calcium hydroxide, and calcium salt, and one or more of them can be applied. The kind of the calcium salt is not limited, and it may be a simple salt containing only calcium as cation, such as calcium silicate, calcium carbonate, and calcium phosphate, or may be double salt containing calcium and other cation such as zinc-calcium phosphate and magnesium-calcium phosphate.

The silicon oxide contained in the above-described compounds (b), (c), and (d) may be either one of colloidal silicon and dry silica.

In particular, the organic solvent dispersion type silica sol gives excellent dispersibility, and gives superior corrosion resistance to that of fumed silica sol.

The fine particle silica contributes to the formation of dense and stable corrosion products under a corrosive environment. It is presumed that the corrosion products are formed densely on the surface of plating to suppress the enhancement of corrosion.

From the viewpoint of corrosion resistance, preferable range of the particle size of the fine particle silica is from 5 to 50 nm, more preferably from 5 to 20 nm, and most preferably from 5 to 15 nm.

The molybdenate of the above-described component (e) is not limited in its skeleton and degree of condensation. Examples of the molybdenate are orthomolybdenate, paramolybdenate, and methamolybdenate. The molybdenate includes all kinds of salt such as simple salt and double salt. An example of the double salt is phosphoric molybdenate.

As of the organic compounds of the above-described component (f), examples of the triazoles are 1,2,4-triazole, 3-amino-1,2,4-triazole, 3-mercapto-1,2,4-triazole, 5-amino-3-mercapto-1,2,4-triazole, and 1H-benzotriazole, examples of thiols are 1,3,5-triazine-2,4,6-trithiol and 2-mercaptobenzimidazole, examples of thiadiazoles are 5-amino-2-mercapto-1,3,4-thiadiazole and 2,5-dimercapto-1,3,4-thiadiazole, examples of thiazoles are 2-N,N-diethylthiobenzothiazloe and 2-mercaptobenzothiazole, and an example of thiurams is tetraethylthiuramdisulfide.

In the above-described component (a), an adequate blending ratio of the Ca ion exchanged silica (a1) to the phosphate (a2), (a1)/(a2), is in a range of from 1/99 to 99/1, preferably from 10/90 to 90/1, and more preferably from 20/80 to 80/20. If the ratio (a1) /(a2) is less than 1/99, the elution of calcium becomes less, failing in forming a protective coating to seal the origin of corrosion. If the ratio (a1)/(a2) exceeds 99/1, the calcium elution exceeds the necessary amount for forming the protective coating, and further the quantity of phosphoric acid ions necessary to induce the complex-forming reaction with the calcium cannot be satisfied, so that the corrosion resistance degrades.

In the above-described component (b), an adequate blending ratio between the Ca ion exchanged silica (b1), the phosphate (b2), and the silicon oxide (b3) is: [(b1)/{(b2)+(b3)}] of from 1/99 to 99/1 by weight ratio of solid matter, preferably from 10/90 to 90/10, more preferably from 20/80 to 80/20; and [(b2)/(b3)] of from 1/99 to 99/1, more preferably from 10/90 to 90/10, and most preferably from 20/80 to 80/20. If the [(b1)/{(b2)+(b3)}] is less than 1/99 or the [(b2)/(b3)] is less than 1/99, the amount of calcium elution and the amount of phosphoric acid ions are less, failing in forming the protective coating to seal the origin of corrosion. On the other hand, if the [(b1)/{(b2)+(b3)}] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied. If the [(b2)/(b3)] exceeds 99/1, the necessary amount of silicon oxide to adsorb the eluted calcium cannot be supplied. For both cases, the corrosion resistance degrades.

In the above-described component (c), an adequate blending ratio of the calcium compound (c1) to the silicon oxide (c2) is: (c1)/(c2) of from 1/99 to 99/1 by weight ratio of solid matter, preferably from 10/90 to 90/10, and more preferably from 20/80 to 80/20. If the (c1)/(c2) is less than 1/99, the amount of eluted calcium is less, failing in forming the protective coating to seal the origin of corrosion. If the (c1)/(c2) exceeds 99/1, the calcium elution exceeds the necessary amount for forming the protective coating, and further the quantity of silicon oxide necessary to adsorb the calcium cannot be supplied, thus failing in corrosion resistance.

In the above-described component (d), an adequate blending ratio between the Ca compound (d1), the phosphate (d2), and the silicon oxide (d3) is: [(d1)/{(d2)+(d3)}] of from 1/99 to 99/1 by weight ratio of solid matter, preferably from 10/90 to 90/10, more preferably from 20/80 to 80/20; and [(d2)/(d3)] of from 1/99 to 99/1, more preferably from 10/90 to 90/10, and most preferably from 20/80 to 80/20. If the [(d1)/{(d2)+(d3)}] is less than 1/99 or the [(d2)/(d3)] is less than 1/99, the amount of calcium elution and the amount of phosphoric acid ions are less, failing in forming the protective coating to seal the origin of corrosion. On the other hand, if the [(d1)/{(d2)+(d3)}] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied. If the [(d2)/(d3)] exceeds 99/1, the necessary amount of silicon oxide to adsorb the eluted calcium cannot be supplied. For both cases, the corrosion resistance degrades.

As described before, the rust-preventive additive components (a) through (f) form respective protective coating under corrosive environments by the precipitation effect (for the components of (a) through (d)), the passivation effect (for the component (e)), and the adsorption effect (for the component (f)).

In particular, according to the present invention, by blending any one of the above-described components (a) through (f) on to a specific chelete-forming resin as the base resin, extremely strong corrosion preventive effect is attained by the combination of the barrier effect of the chelete-forming resin and the self-repairing effect of the above-described components (a) through (f).

Owing to the self-repairing effect (above-described three types of preventive coating forming effect) obtained from each of the above-described components (a) through (d), (e), and (f), to attain stronger self-repairing performance, it is preferable to adjust (blend) the rust-prevention additive component (Y) which has a combination described below and which contains combined addition of the above-described (e) and/or (f) further of other component. In particular, the highest self-repairing performance (that is, white rust prevention performance) in the case of (6) and of (7) described below.

(1) A rust-preventive additive component blended with (e) a molybdenate, (g) calcium and/or calcium compound, and (h) a phosphate and/or a silicon oxide is obtained.

(2) A rust-preventive additive component blended with (e) a molybdenate and (i) a Ca ion exchanged silica.

(3) A rust-preventive additive component blended with (f) at least one organic compound selected from the group consisting of a triazole, a thiol, a thiadiazole, a thiazole, and a thiuram, (g) calcium and/or a calcium compound, and (h) a phosphate and/or a silicon oxide.

(4) A rust-preventive additive component blended with (f) at least one organic compound selected from the group consisting of a triazole, a thiol, a thiadiazole, a thiazole, and a thiuram and (i) a Ca ion exchanged silica.

(5) A rust-preventive additive component blended with (e) a molybdenate and (f) at least one organic compound selected from the group consisting of a triazole, a thiol, a thiadiazole, a thiazole, and a thiuram.

(6) A rust-preventive additive component blended with (e) a molybdenate, (f) at least one organic compound selected from the group consisting of a triazole, a thiol, a thiadiazole, a thiazole, and a thiuram, (g) calcium and/or a calcium compound, and (h) a phosphate and/or a silicon oxide.

(7) A rust-preventive additive component blended with (e) a molybdenate, (f) at least one organic compound selected from the group consisting of a triazole, a thiol, a thiadiazole, a thiazole, and a thiuram, and (i) a Ca ion exchanged silica.

Applicable calcium compound, phosphate, silicon oxide, and Ca ion exchanged silica are the same with those described before relating to the components (a) through (d).

For the above-described (1), the rust-preventive additive components blended with (e) a molybdenate, (g) calcium and/or calcium compound, and (h) a phosphate and/or a silicon oxide preferably give the blending ratio in solid matter weight base of [(e)/{(g)+(h)}] from 1/99 to 99/1, more preferably from 10/90 to 90/10, and most preferably from 20/80 to 80/20, and of [(g)/(h)] from 1/99 to 99/1, more preferably from 10/90 to 90/10, and most preferably from 20/80 to 80/20.

If the [(e)/{(g)+(h)})] is less than 1/99 or more than 99/1, the combining different self-repairing effects cannot fully be attained. If [(g)/(h)] is less than 1/99, the amount of eluted calcium is less to fail in forming a protective coating for sealing the origin of corrosion. If [(g)/(h)] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied, thus failing in attaining satisfactory self-repairing effect.

For the above-described (2), the rust-preventive additive components blended with (e) a molybdenate and (i) a Ca ion exchanged silica preferably give the blending ratios in weight base of [(e)/(i)] from 1/99 to 99/1, more preferably from 10/90 to 90/10, and most preferably from 20/80 to 80/20.

If the [(e)/(i)] is less than 1/99 or more than 99/1, the effect of combination of different self-repairing effects cannot fully be attained.

For the above-described (3), the rust-preventive additive components blended with (f) at least one organic compound selected from the group consisting of a triazole, a thiol, a thiadiazole, a thiazole, and a thiuram, (g) calcium and/or a calcium compound, and (h) a phosphate and/or a silicon oxide preferably give the blending ratios in solid matter weight base of [(f)/{(g)+(h)}] from 1/99 to 99/1, more preferably from 10/90 to 90/10, and most preferably from 20/80 to 80/20, and of [(g)/(h)] from 1/99 to 99/1, more preferably from 10/90 to 90/10, and most preferably from 20/80 to 80/20.

If the [(f)/{(g)+(h)}] is less than 1/99 or more than 99/1, the effect of combining different self-repairing effects cannot fully be attained. If [(g)/(h)] is less than 1/99, the amount of eluted calcium is less to fail in forming a protective coating for sealing the origin of corrosion. If [(g)/(h)] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied, thus failing in attaining satisfactory self-repairing effect.

For the above-described (4), the rust-preventive additive components blended with (f) at least one organic compound selected from the group consisting of a triazole, a thiol, a thiadiazole, a thiazole, and a thiuram, (i) a Ca ion exchanged silica preferably give the blending ratio in solid matter weight base of [(f)/(i)] from 1/99 to 99/1, more preferably from 10/90 to 90/10, and most preferably from 20/80 to 80/20.

If the [(f)/(i)] is less than 1/99 or more than 99/1, the effect of combination of different self-repairing effects cannot fully be attained.

For the above-described (5), the rust-preventive additive components blended with (e) a molybdate and (f) at least one organic compound selected from the group consisting of a triazole, a thiol, a thiadiazole, a thiazole, and a thiuram preferably give the blending ratio in solid matter weight base of [(e)/(f)] from 1/99 to 99/1, more preferably from 10/90 to 90/10, and most preferably from 20/80 to 80/20.

If the [(e)/(f)] is less than 1/99 or more than 99/1, the effect of combination of different self-repairing effects cannot fully be attained.

For the above-described (6), the rust-preventive additive components blended with (e) a molybdate, (f) at least one organic compound selected from the group consisting of a triazole, a thiol, a thiadiazole, a thiazole, and a thiuram, (g) calcium and/or a calcium compound, and (h) a phosphate and/or a silicon oxide preferably give the blending ratio in solid matter weight base of [(e)/(f)] from 1/99 to 99/1, more preferably from 10/90 to 90/10, and most preferably from 20/80 to 80/20, [(e)/{(g)+(h)] from 1/99 to 99/1, more preferably from 10/90 to 90/10, and most preferably from 20/80 to 80/20, [(f)/((g)+(h)] from 1/99 to 99/1, more preferably from 10/90 to 90/10, and most preferably from 20/80 to 80/20,and of [(g)/(h)] from 1/99 to 99/1, more preferably from 10/90 to 90/10, and most preferably from 20/80 to 80/20.

If the value of respective [(e)/(f)], [(e)/{(g)+(h)], and [(f)/((g)+(h)] is less than 1/99 or more than 99/1, the effect of combination of different self-repairing effects cannot fully be attained. If [(g)/(h)] is less than 1/99, the amount of eluted calcium is less to fail in forming a protective coating for sealing the origin of corrosion. If [(g)/(h)] exceeds 99/1, the calcium elution exceeds the necessary amount for forming the protective coating, and further the quantity of phosphoric acid ions necessary to induce the complex-forming reaction with the calcium cannot be supplied, and the quantity of silicon oxide necessary to adsorb the calcium cannot be supplied, thus failing in attaining satisfactory self-repairing effect.

For the above-described (7), the rust-preventive additive components blended with (e) a molybdate, (f) at least one organic compound selected from the group consisting of a triazole, a thiol, a thiadiazole, a thiazole, and a thiuram, and (i) a Ca ion exchanged silica preferably give the blending ratio in solid matter weight base of [(e)/(f)] from 1/99 to 99/1, more preferably from 10/90 to 90/10, and most preferably from 20/80 to 80/20, [(e)/(i)] from 1/99 to 99/1, more preferably from 10/90 to 90/10, and most preferably from 20/80 to 80/20, [(f)/(i)] from 1/99 to 99/1, more preferably from 10/90 to 90/10, and most preferably from 20/80 to 80/20.

If the value of respective [(e)/(f)], [(e)/(i)], and [(f)/(i)] is less than 1/99 or more than 99/1, the effect of combination of different self-repairing effects cannot fully be attained.

The blending amount of the above-described rust-preventive component (Y), (the total blending amount of self-repairing substance consisting of the blending amount of either one of above-described (a) through (f), or the above-described (e) and/or (f) with combined additive of other component) in the organic resin coating is in a range of from 1 to 100 parts by weight (solid matter), preferably from 5 to 80 parts by weight (solid matter), more preferably from 10 to 50 parts by weight (solid matter) to 100 parts by weight (solid matter) of the reaction product (X), (the reaction product of the reaction between the film-forming organic resin (A) and the compound (B) containing activated hydrogen consisting of the hydrazine derivative (C) of which a part of or whole of the compound thereof contains activated hydrogen) as the resin composition to form the coating. If the blending amount of the rust-preventive component (Y) is less than 1 part by weight, the effect of improvement in corrosion resistance is less. If the blending amount of the rust-preventive component (Y) exceeds 100 parts by weight, the corrosion resistance degrades, which is not favorable.

Adding to the above-described rust-preventive component, the organic coating may further contain, as the corrosion suppressing agent, one or more of other oxide fine particles (for example, aluminum oxide, zirconium oxide, titanium oxide, cerium oxide, and antimony oxide), molybdenum phosphate (for example, aluminum-molybdenum phosphate), organic phosphoric acid and its salt (for example, phytic acid, phytiate, phosphonic acid, phosphonate, and their metallic salt, alkali metal salt, alkali earth metallic salt), organic inhibitor (for example, hydrazine derivative, thiol compound, and dithiocarbamate).

The organic coating may further blend a solid lubricant (C) to improve the workability of the coating.

Examples of the applicable solid lubricant (C) according to the present invention are the following, either separately or mixing two or more of them.

(1) Polyolefin wax, paraffin wax: for example, polyethylene wax, synthetic paraffin, natural paraffin, microwax, and chlorinated hydrocarbon.

(2) Fluororesin fine particles: for example, those of polyfluoroethylene resin (for example, polytetrafluoroethylene resin), polyvinylfluororesin, and polyvinylidenefluororesin.

Adding to these compounds, one or more of the compounds listed below may be applied: fatty amide-base compound (for example, stearyl amide, parmitic amide, methylenebis-stearyl amide, ethylenebis-stearyl amide, oleic amide, ethyl acid amide, and alkylenebis-fatty acid amide), metal soap (for example, calcium stearate, lead stearate, calcium laurate, and calcium parmitate), metal sulfide (for example, molybdenum disulfide and tungsten disulfide), graphite, graphite fluoride, boron nitride, polyalkyleneglycol, and alkali metal sulfide.

As of these solid lubricants, particularly suitable ones are polyethylene wax and fluororesin fine particles (in particular, polytetrafluoroethylene resin fine particles).

Examples of the polyethylene wax are: the products of Hoechst AG., namely, Seriduct 9615A, Seridust 3715, Seridust 3620, and Seridust 3910; the products of Sanyo Chemical Industries, Ltd., namely, Sun wax 131-P and Sun wax 161-P; the products of Mitsui Petrochemical Industries, Ltd., namely, Chemipearl W-100, Chemipearl W-200, Chemipearl W500, Chemipearl W-800, and Chemipearl W-950.

As for the fluororesin fine particles, tetrafluoroethylene fine particles are the most favorable. Examples of the tetrafluoroethylene are: the products of Daikin Industries, Ltd., namely, Lubron L-2 and Lubron L-5; the products of Mitsui DuPont Co., Ltd., namely, MP 1100 and MP 1200; the products of Asahi ICI Fluoropolymers Co., Ltd., namely, Fluon dispersion AD1, Fluon dispersion AD2, Fluon L141J, Fluon L150J, and Fluon L155J.

Among these, combined use of polyolefin wax with tetrafluoroethylene fine particles is expected to provide particularly high lubrication effect.

The content of the solid lubricant (C) in the organic coating is from 1 to 80 parts by weight (solid matter), preferably from 3 to 40 parts by weight (solid matter), to 100 parts by weight (solid matter) of the base resin. If the content of the solid lubricant (C) is less than 1 part by weight, the lubrication effect is poor, and, if the content thereof exceeds 80 parts by weight, the coatability degrades, both of which cases are unfavorable.

The organic coating on the steel sheet with organic coating according to the present invention normally consists mainly of a specific polymer resin (A) as the base resin, and a rust-preventive additive component (B), as a self-repairing material, of either one of the following-given (a) through (f), or combined additives of (e) and/or (f) with other component, and, at need, a solid lubricant (C), a curing agent, and the like:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one organic compound selected from the group consisting of a triazole, a thiol, a thiadiazole, a thiazole, and a thiuram.

Furthermore, there may be added one or more of additives such as an organic colored pigment (for example, condensation polycyclic-base organic pigment, phthalocyanine-base organic pigment), a colored dye (for example, organic solvent soluble azo-base dye, water-soluble azo-base metallic dye), an inorganic pigment (for example, titanium oxide), a cheleting agent (for example, thiol), a conductive pigment (for example, metallic powder such as that of zinc, aluminum, and nickel, iron phosphide, antimony dope type tin oxide), a coupling agent (for example, silane coupling agent and titanium coupling agent), and a melamine-cyanuric acid additive.

The coating composition for film-formation containing above-described main components and additive components normally contains a solvent (organic solvent and/or water), and further contains, at need, a neutralizer and the like.

The above-described organic coating is formed on the above-described composite oxide coating.

The dry thickness of the organic coating is in a range of from 0.1 to 5 μm, preferably from 0.3 to 3 μm, and more preferably from 0.5 to 2 μm. If the thickness of the organic coating is less than 0.1 μm, the corrosion resistance is insufficient. If the thickness exceeds 5 μm, the conductivity and the workability degrade.

The following is the description of the method for manufacturing steel sheet with organic coating according to the present invention.

The steel sheet with organic coating according to the present invention is manufactured by the steps of: treating the surface, (applying a treating liquid), of a zinc-base plated steel sheet or an aluminum-base plated steel sheet using the treating liquid containing the above-described components of composite oxide coating; heating to dry the steel sheet with coating; applying on the dried coating with a coating composition consisting mainly of a reaction product (X), (preferably as the main composition), yielded from the reaction between a film-forming organic resin (A) and a compound (B) containing activated hydrogen consisting of a hydrazine derivative (C) a part or whole of the compound thereof having activated hydrogen, and a rust-preventive additive component (Y), of either one of the following-given (a) through (f), or a rust-preventive additive component (Y) blending other components to the above-given (e) and/or (f), further, at need, a solid lubricant (Z), and the like, followed by heating to dry the coating composition:

(a) a Ca ion exchanged silica and a phosphate,

(b) a Ca ion exchanged silica, a phosphate, and a silicon oxide,

(c) a calcium compound and a silicon oxide,

(d) a calcium compound, a phosphate, and a silicon oxide,

(e) a molybdenate, and

(f) at least one organic compound selected from the group consisting of a triazole, a thiol, a thiadiazole, a thiazole, and a thiuram.

The surface of the plated steel sheet may be subjected to preliminary treatment, at need, before applying the above-described treating liquid, such as alkali degreasing treatment, and surface adjusting treatment to improve coating adhesiveness and corrosion resistance.

To treat the surface of the zinc-base plated steel sheet or the aluminum-base plated steel sheet with a treating liquid to form a composite oxide coating, it is preferable to conduct the treatment with a treating liquid (aqueous solution) containing (i) oxide fine particles, (ii) a phosphate and/or a phosphoric acid compound, (iii) either one metallic ion of Mg, Mn, and Al, a compound containing at least one of these metals, and a composite compound containing at least one of these metals; further, at need, to conduct the treatment with a treating liquid (aqueous solution) containing above-described additive components (an organic resin component, an iron base metallic ion, a rust-preventive additive, and other additive), then to apply heating to dry.

The above-described treating liquid is adjusted so as the molar concentration of the above-described additive component (i), the total molar concentration of above-described additive component (ii) converted to P₂O₅, and the total molar concentration of above-described additive component (iii) converted to the quantity of above-described metal, to satisfy the molar ratio (i)/(iii)=0.1 to 20, preferably 0.1 to 10, and the molar ratio (iii)/(ii)=0.1 to 1.5.

If the molar ratio (i)/(iii) is less than 0.1, the effect of the addition of the oxide fine particles cannot be fully obtained. If the molar ratio (i)/(iii) exceeds 20, the oxide fine particles hinder the densification of the coating.

If the molar ratio (iii)/(ii) is less than 0.1, the effect of the addition of metal such as Mg cannot fully be attained. If the molar ratio (iii)/(ii) exceeds 1.5, the stability of treating liquid degrades.

As for the oxide fine particles as the additive component (i), those of silicon oxide (SiO₂ fine particles) are most preferable. The silicon oxide may be silica fine particles which are water-dispersible and stable in the treating liquid. Commercially available silica sols and water-dispersible oligomers of silicate can be used as the oxide fine particles. However, fluorides such as hexafluorosilicate are strongly corrosive and give significant influence to human body, so that fluorides are not suitable in view of influence on work environment.

Adequate adding amount of the oxide fine particles (for the case of silicon oxide, the adding amount as SiO₂) to the treating liquid is in a range of from 0.001 to 3.0 mole/l, preferably from 0.05 to 1.0 mole/l, more preferably from 0.1 to 0.5 mole/l. If the adding amount of the oxide fine particles is less than 0.001 mole/l, the effect of the addition is not sufficient, and the corrosion resistance tends to degrade. If the adding amount of the oxide fine particles exceeds 3.0 mole/l, the water resistance of the coating degrades, resulting in degradation tendency of corrosion resistance.

The phosphate and/or phosphoric acid compound as the additive component (ii) may be any mode including: a mode existing a compound containing phosphoric acid in a form of complex ion with anion or metallic cation generated on dissolving in an aqueous solution, which compound containing phosphoric acid includes polyphosphoric acids such as orthophosphoric acid, pyrophosphoric acid, and tripolyphosphoric acid, methaphosphoric acid, and their inorganic salt (for example, primary aluminum phosphate), phosphorous acid, phosphate, hypophosphorous acid, and hypophosphite; and a mode in which the above-given compounds exist as free acids; and a mode in which the above-given compounds exist as inorganic salts dispersing in water. According to the present invention, the total amount of the phosphoric acid components existing in the treating liquid in all modes is defined as that converted to P₂O₅.

Adequate adding amount of the phosphoric acid and/or phosphoric acid compound to the treating liquid is in a range of from 0.001 to 6.0 mole/l converted to P₂O₅, preferably from 0.02 to 1.0 mole/l, more preferably from 0.1 to 0.8 mole/l. If the adding amount of the phosphoric acid and/or phosphoric acid compound is less than 0.001 mole/l, the effect of the addition is not sufficient, and the corrosion resistance tends to degrade. If the adding amount of the phosphoric acid and/or phosphoric acid compound exceeds 6.0 mole/l, excess amount of the phosphoric acid ions react with the plated coating under a humid environment, and, depending on the corrosion environment, the corrosion of plating base material may be enhanced to cause discoloration and generation of stain-like rust.

As the additive component (ii), use of ammonium phosphate is effective because the compound provides a composite oxide giving excellent corrosion resistance. Preferred ammonium phosphate includes separate or combined use of primary ammonium phosphate, secondary ammonium phosphate, or the like.

The existing mode of the above-described additive component (iii) may be a compound or a composite compound. To obtain particularly strong corrosion resistance, it is preferred to use a mode of metallic ion such as Mg, Mn, and Al, or water-soluble ion containing metal such as Mg, Mn, and Al.

To supply ions of the additive component (iii) as metallic salts, anions such as chlorine ion, nitric acid ion, sulfuric acid ion, acetic acid ion, and boric acid ion may be added to the treating liquid. The amount of the Mg, Mn, and Al components according to the present invention is defined as the sum of all modes existing in the treating liquid converted to the corresponding metal.

Adequate adding amount of the above-described additive component (iii) to the treating liquid is in a range of from 0.001 to 3.0 mole/l converted to metal, preferably from 0.01 to 0.5 mole/l. If the adding amount of the additive component (iii) is less than 0.001 mole/l, the effect of the addition is not sufficient. If the adding amount of the additive component (iii) exceeds 3.0 mole/l, the component hinders the network-formation in the coating to fail in forming a dense coating. Furthermore, the metallic components are likely eluted from the coating, and, in some environments, defects such as discoloration of appearance occur.

The treating liquid may further contain an additive component (iv), which component (iv) consists mainly of a metallic ion of Ni, Fe, or Co, and at least one water-soluble ion containing at least one of these metals, at an adequate amount. By adding that kind of iron-base metal, blacking phenomenon caused from corrosion on the uppermost layer of the plating under a humid environment can be avoided, which phenomenon is observed when no iron base metal is added. Among these iron-base metals, the effect of Ni give the highest effect even with a trace amount thereof. Excess amount of iron-base metal such as Ni and Co, however, causes the degradation of corrosion resistance, so the addition thereof should be at an adequate amount.

Adequate adding amount of the above-described additive component (iv) is in a range of from 1/10,000 to 1 mole converted to metal, preferably from 1/10,000 to 1/100 mole, to 1 mole of the additive component (iii) converted to metal. If the adding amount of the additive component (iv) is less than 1/10,000 mole to 1 mole of the additive component (iii), the effect of the addition is not sufficient. If the adding amount of the additive component (iv) exceeds 1 mole, the corrosion resistance degrades, as described above.

The treating liquid may further contain an adequate amount of above-described additive components to the coating, other than the above-described additive components (i) through (iv).

Adequate pH range of the treating liquid (aqueous solution) is from 0.5 to 5, preferably from 2 to 4. If the pH value is less than 0.5, the reactivity of the treating liquid becomes excessively strong, which forms fine defects in the coating to degrade the corrosion resistance. If the pH value of the treating liquid exceeds 5, the reactivity of the treating liquid becomes poor, which induces insufficient bonding of interface of plating film and composite oxide film, which also tends to degrade the corrosion resistance.

Method to coat the treating liquid onto the surface of the plated steel sheet may be either one of applying method, dipping method, and spray method. The applying method may use roll coater (three roll method, two roll method, and the like), squeeze coater, or die coater. After the treatment of applying by a squeeze coater, dipping, and spraying, it is possible to give adjustment of applied volume by air knife method or by roll squeeze method, uniformizing appearance, and uniformizing film thickness.

Although the temperature of treating liquid is not specifically limited, it is adequate in a range of from normal temperature to around 60° C. Temperature below normal temperature is uneconomical because additional facilities such as those for cooling are required. Temperature above 60° C. makes the control of treating liquid difficult because water likely evaporates.

After the treating liquid is coated as described above, normally heating to dry is applied without washing with water. The treating liquid according to the present invention, however, forms a insoluble salt by the reaction with the base material plated steel sheet, so that washing with water may be conducted after the treatment.

Any method can be applied to heat to dry the coated treating liquid. Examples of the method are use of a drier, a hot air furnace, a high frequency induction heating furnace, and an infrared furnace. A favorable temperature range of the heating to dry treatment is from 50 to 300° C., more preferably from 80 to 200° C., and most preferably from 80 to 160° C.; If the heating to dry temperature is lower than 50° C., large amount of water is left in the coating, thus giving insufficient corrosion resistance. Above 300° C. of the heating to dry temperature is uneconomical, and tends to generate defects in the coating, which degrades the corrosion resistance.

After forming a composite oxide coating on the surface of the zinc-base plated steel sheet or the aluminum-base plated steel sheet, as described above, a coating composition for forming an organic coating is applied thereon. Method to coat the coating composition may be either one of applying method, dipping method, and spray method. The applying method may use roll coater (three roll method, two roll method, and the like), squeeze coater, or die coater. After the treatment of applying by a squeeze coater, dipping, and spraying, it is possible to give adjustment of applied volume by air knife method or by roll squeeze method, uniformizing appearance, and uniformizing film thickness.

After the coating composition is coated, normally heating to dry is applied without washing with water. However, the step of washing with water may be implemented after applying the coating composition.

The heating to dry treatment may be conducted by a drier, a hot air furnace, a high frequency induction heating furnace, and an infrared furnace. The heating treatment is preferred to conduct at the ultimate temperatures of from 50 to 350° C., more preferably from 80 to 250° C. If the heating temperature is lower than 50° C., large amount of water is left in the coating, thus giving insufficient corrosion resistance. Above 350° C. of the heating temperature is uneconomical, and tends to generate defects in the coating, which may degrade the corrosion resistance.

The present invention includes the steel sheets with above-described coating on both sides or single side surface thereof. Therefore, examples of the modes of the steel sheet according to the present invention are the following.

(1) One side: Plated coating—Composite oxide coating—Organic coating

Other side: Plated coating

(2) One side: Plated coating—Composite oxide coating—Organic coating

Other side: Plated coating—Known phosphate treated coating or the like

(3) Both sides: Plated coating—Composite oxide coating—Organic coating

(4) One side: Plated coating—Composite oxide coating—Organic coating

Other side: Plated coating—Composite oxide coating

(5) One side: Plated coating—Composite oxide coating—Organic coating

Other side: Plated coating—Organic coating

The treating liquids (coating compositions) for forming the first coating layer, shown in Table 41 and Table 42, and the resin compositions for forming the second coating layer, shown in Table 2, were prepared.

In the following Tables 43, the notes *1 through *7 express the following.

*1: An epoxy resin ptiselobe solution (solid content of 40%), manufactured by Yuka Shell Co., Ltd.

*2: A urea resin (solid content of 60%), manufactured by Dainippon Ink and Chemicals, Inc.

*3: A diethanol-modified epoxy resin (solid content of 50%), manufactured by Kansai Paint Co., Ltd.

*4: A blockurethane resin (solid content of 60%), manufactured by Asahi Chemical Industry, Co., Ltd.

*5: A high molecular weight oil-free alkyd resin (solid content of 60%), manufactured by Dainippon Ink and Chemicals, Inc.

*6: A melamine resin (solid content of 80%), manufactured by Mitsui Cytec, Co., Ltd.

*7: A high molecular weight oil-free alkyd resin (solid content of 40%), manufactured by Toyobo Co., Ltd.

As for the resin compositions shown in Table 43, respective coating compositions were prepared by adding adequate amount of solid lubricants shown in Table 45 to the rust-preventive additive components (self-repairing substances) given in Table 44 (Table 44-1 and 44-2), and by dispersing the solid lubricants for a necessary period using a disperser for coating (a sand grinder).

To obtain steel sheets with organic coating for household electric appliances, building materials, and automobile parts, cold-rolled steel sheets having a thickness of 0.8 mm and a surface roughness Ra of 1.0 μm were separately applied with various kinds of zinc-base plating or aluminum-base plating, thus preparing the plated steel sheets shown in Table 40. These plated steel sheets were used as the base plates for treatment. The surface of these steel sheets was subjected to alkali degreasing and water washing, then was applied with the treating liquids (coating compositions) shown in Table 41 and Table 42 using a roll coater, followed by heating to dry to form the first coating layer. The thickness of the first coating layer was adjusted by controlling the solid content (heating residue) or the applying conditions (pressing force of the roll, rotation speed, and the like) of the treating liquid. Then, the coating compositions shown in Table 43 were applied using a roll coater, and the coating compositions were heated to dry to form the second coating layer, thus obtained the steel sheets with organic coating of the Examples according to the present invention and the Comparative Example. The thickness of the second coating layer was adjusted by controlling the solid content (heating residue) or the applying conditions (pressing force of the roll, rotation speed, and the like) of the treating liquid.

Thus obtained steel sheets with organic coating were evaluated in terms of quality performance (coating appearance, white rust resistance, white rust resistance after alkali degreasing, coating adhesiveness, and workability). The results are given in Tables 46 through 78, along with the coating structure of the first coating and the second coating.

In the following Tables 46 through 78, the notes *1 through *7 expresses the following.

*1: Plated steel sheet No. given in Table 40.

*2: Composition No. for forming the first coating layer, given in Table 41 and Table 42.

*3: The component (β) is a coating weight converted to P₂O₅; and the component (γ) is a coating weight converted to metal (Mg, Mn, or Al).

*4: Composition No. for forming the second coating layer, given in Table 43.

*5: Rust-preventive additive component No. given in Table 44.

*6: Solid lubricant No. given in Table 45.

*7: Amount of blending (weight parts) to 100 parts by weight of resin composition.

TABLE 40

| | | Coating |
|---|---|---|
| | | weight |
| No. | Kind | (g/m²) |
| 1 | Electrolytic galvanized steel sheet | 20 |
| 2 | Hot dip galvanized steel sheet | 60 |
| 3 | Alloyed hot dip galvanized steel sheet (Fe: 10 wt %) | 60 |
| 4 | Hot dip Zn—Al alloy plated steel sheet (Al: 55 wt %) | 90 |
| 5 | Hot dip Zn-5 wt. % Al-0.5 wt. % Mg alloy plated steel | 90 |
| | sheet | |
| 6 | Hot dip aluminum plated steel sheet (Al-6 wt. % Si alloy | 60 |
| | plating) | |

TABLE 41

| | | | | | Phosphoric acid, phosphoric acid | | | |
|---|---|---|---|---|---|---|---|---|
| | Oxide fine particles (i) | | Mg, Mn, Al (iii) | | compound (ii) | | Organic resin | |
| | | Concentration | | Concentration | | Concentration | | Concentration |
| No. | Kind | (M/L) | Kind | (M/L) *1 | Kind | (M/L) *2 | Kind | (g/l) |
| 1 | Colloidal silica | 0.3 | Mn | 0.10 | Orthophosphoric acid | 0.20 | — | — |
| 2 | Colloidal silica | 0.04 | Mn | 0.10 | Orthophosphoric acid | 0.20 | — | — |
| 3 | Colloidal silica | 0.3 | Mn | 0.10 | Orthophosphoric acid | 0.50 | — | — |
| 4 | Colloidal silica | 0.33 | Mn | 0.11 | Orthophosphoric acid | 0.10 | — | — |
| 5 | Colloidal silica | 1.8 | Mn | 0.10 | Orthophosphoric acid | 0.20 | — | — |
| 6 | Colloidal silica | 0.3 | Mn | 0.10 | Orthophosphoric acid | 0.20 | Acrylic-styrene base | 180 |
| | | | | | | | water-dispersible resin | |
| 7 | Colloidal silica | 0.3 | Al | 0.10 | Orthophosphoric acid | 0.20 | — | — |
| 8 | Colloidal silica | 0.04 | Al | 0.10 | Orthophosphoric acid | 0.20 | — | — |
| 9 | Colloidal silica | 0.3 | Al | 0.10 | Orthophosphoric acid | 0.50 | — | — |
| 10 | Colloidal silica | 0.3 | Al | 0.10 | Orthophosphoric acid | 0.20 | — | — |
| 11 | Colloidal silica | 0.33 | Al | 0.11 | Orthophosphoric acid | 0.10 | — | — |
| 12 | Alumina sol | 0.3 | Al | 0.10 | Orthophosphoric acid | 0.20 | — | — |
| 13 | Colloidal silica | 0.3 | Mg | 0.10 | Orthophosphoric acid | 0.20 | — | — |
| 14 | — | — | Mn | 0.10 | Orthophosphoric acid | 0.20 | — | — |
| 15 | — | — | Al | 0.10 | Orthophosphoric acid | 0.20 | — | — |
| 16 | — | — | Mg | 0.10 | Orthophosphoric acid | 0.20 | — | — |
| 17 | Colloidal silica | 0.3 | — | — | Orthophosphoric acid | 0.20 | — | — |
| 18 | Colloidal silica | 0.3 | Mn | 0.10 | — | — | — | — |
| 19 | Colloidal silica | 0.3 | Al | 0.10 | — | — | — | — |
| 20 | Colloidal silica | 0.3 | Mg | 0.10 | — | — | — | — |
| 21 | Lithium silicate | 1.0 | — | — | — | — | — | — |

*1 Total molar concentration converted to metals of Mg, Mn, and Al.
*2 Total molar concentration converted to P₂O₅.

TABLE 42

| | Mole ratio | Mole ratio | Applicability of the condition of the |
|---|---|---|---|
| No. | (i)/(iii) | (iii)/(ii) | invention *3 |
| 1 | 3.0 | 0.5 | ◯ |
| 2 | 0.4 | 0.5 | ◯ |
| 3 | 3.0 | 0.2 | ◯ |
| 4 | 3.0 | 1.1 | ◯ |
| 5 | 18.0 | 0.5 | ◯ |
| 6 | 3.0 | 0.5 | ◯ |
| 7 | 3.0 | 0.5 | ◯ |
| 8 | 0.4 | 0.5 | ◯ |
| 9 | 3.0 | 0.2 | ◯ |
| 10 | 3.0 | 1.1 | ◯ |
| 11 | 18.0 | 0.5 | ◯ |
| 12 | 3.0 | 0.5 | ◯ |
| 13 | 3.0 | 0.5 | ◯ |
| 14 | — | 0.5 | X |
| 15 | — | 0.5 | X |
| 16 | — | 0.5 | X |
| 17 | — | — | X |
| 18 | 3.0 | — | X |
| 19 | 3.0 | — | X |
| 20 | 3.0 | — | X |
| 21 | — | — | X |

*3
◯: Satisfies the condition of the invention.
X: Dissatisfies the condition of the invention.

TABLE 43

| No. | Group | Kind (mother agent/curing agent) | Base resin |
|---|---|---|---|
| 1 | Thermosetting resin | Epoxy resin/urea resin | Epicoat E-1009 (*1)/Bekkamine P196M (*2) = |
| | | | 85/15 |
| 2 | Thermosetting resin | Diethanol modified epoxy resin/Block | ER-007 (*3)/Durante MF-K60X (*4) = 90/10 |
| | | urethane resin | |
| 3 | Thermosetting resin | High molecular weight oil free alkyd resin/ | Bekkolite M-6206 (*5)/Cymel 352 (*6) = 85/15 |
| | | Melamine resin | |
| 4 | Thermosetting resin | High molecular weight oil free alkyd resin/ | Bylon GK-19CS (*7)/Cymel 325 (*6) = 85/15 |
| | | Melamine resin | |
| 5 | Water base resin | Ethylene ionomer resin | Mitsui Chemical Co., Ltd. Chemipearl S-650 |
| | | | (solid matter 27%) |
| 6 | Water base resin | Polyurethane dispersion | Dai-ichi Kogyo Seiyaku Co., Ltd. Superflex 150 |
| | | | (solid matter 30%) |
| 7 | Water base resin | Epoxy dispersion | Mitsui Chemical Co., Ltd. Epomic WR-942 (solid |
| | | | matter 27%) |
| 8 | Water base resin | Vinylidene latex | Kureha Chemical Industry Co., Ltd. Kureharon |
| | | | latex AO (solid matter 48%) |

TABLE 44-1

| | Rust-preventive additive component | | | | |
|---|---|---|---|---|---|
| | (a) Ca ion exchanged silica + Phosphate | | | | |
| | (b) Ca ion exchanged silica + Phosphate + Silicon oxide | | (f) One or more organic compounds | | Blend ratio *1 |
| | (c) Calcium compound + Silicon oxide | | selected from the group consisting | | (a) to (d), |
| | (d) Calcium compound + Phosphate + Silicon oxide | | of triazoles, thiols, thiodiazoles, | | (g) to (i): |
| No. | (g), (h), (i) Other components | (e) Molybdenate | thiazoles, and thiurams | | (e):(f) |
| 1 | Ca ion exchanged silica + Zn phosphate | — | — | | — |
| | (Blend ratio of 1:1 *1) | | | | |
| 2 | Ca ion exchanged silica + Zn phosphate + Silica | — | — | | — |
| | (Blend ratio of 1:1:1 *1) | | | | |
| 3 | Ca oxide + Silica + Dihydrogen Al tripolyphosphate | — | — | | — |
| | (Blend ratio of 1:1:1 *1) | | | | |
| 4 | Ca oxide + Silica | — | — | | — |
| 5 | — | Molybdenum Al | — | | — |
| | | phosphate | | | |
| 6 | — | Molybdenum CaZn | — | | — |
| | | phosphate | | | |
| 7 | — | — | 5-Amino-3-mercapto- | Triazoles | — |
| | | | 1,2,4-triazole | | |
| 8 | — | — | 1,3,5-Triazine-2,4,6- | Thiols | — |
| | | | trithyol | | |
| 9 | — | — | 5-Amino-2-mercapto- | Thiadiazoles | — |
| | | | 1,3,4-thiadiazole | | |
| 10 | — | — | 2-Mercaptobenzothiazole | Thiazoles | — |
| 11 | — | — | Tetraethylthiuramdisulfide | Thiurams | — |

*1 Weight ratio

TABLE 44-2

| | Rust-preventive additive component | | | | |
|---|---|---|---|---|---|
| | (a) Ca ion exchanged silica + Phosphate | | | | |
| | (b) Ca ion exchanged silica + Phosphate + Silicon oxide | | (f) One or more organic compounds | | Blend ratio *1 |
| | (c) Calcium compound + Silicon oxide | | selected from the group consisting | | (a) to (d), |
| | (d) Calcium compound + Phosphate + Silicon oxide | | of triazoles, thiols, thiodiazoles, | | (g) to (i): |
| No. | (g), (h), (i) Other components | (e) Molybdenate | thiazoles, and thiurams | | (e):(f) |
| 12 | Ca silicate + Dihydrogen Al tripolyphosphate | Molybdenum Al | — | | 10:10:0 |
| | (Blend ratio of 1:1 *1) | phosphate | | | |
| 13 | Ca ion exchanged silica | — | Tetratehylthiuramdisulfide | Thiurams | 10:0:10 |
| 14 | — | Molybdenum Al | Tetratehylthiuramdisulfide | Thiurams | 0:10:10 |
| | | phosphate | | | |
| 15 | Ca silicate + Dihydrogen Al tripolyphosphate | Molybdenum Al | Tetratehylthiuramdisulfide | Thiurams | 10:10:10 |
| | (Blend ratio of 1:1 *1) | phosphate | | | |
| 16 | Ca oxide + Silica | Molybdenum Al | — | | 10:10:0 |
| | (Blend ratio of 1:1 *1) | phosphate | | | |
| 17 | Ca ion exchanged silica | Molybdenum Al | — | | 10:10:0 |
| | | phosphate | | | |
| 18 | Ca oxide + Zn phosphate | — | Tetratehylthiuramdisulfide | Thiurams | 10:0:10 |
| | (Blend ratio of 1:1 *1) | | | | |
| 19 | Ca oxide + Silica | — | Tetratehylthiuramdisulfide | Thiurams | 10:0:10 |
| | (Blend ratio of 1:1 *1) | | | | |
| 20 | Ca oxide + Silica | Molybdenum Al | Tetratehylthiuramdisulfide | Thiurams | 10:10:10 |
| | (Blend ratio of 1:1 *1) | phosphate | | | |
| 21 | Ca ion exchanged silica | Molybdenum Al | Tetratehylthiuramdisulfide | Thiurams | 10:10:10 |
| | | phosphate | | | |

*1 Weight ratio

TABLE 45

| No. | Kind | Trade name |
|---|---|---|
| 1 | Polyethylene wax | Nippon Seiro Co., Ltd. |
| | | “LUVAX 1151” |
| 2 | Polyethylene wax | Ceridust Co., Ltd. |
| | | “3620” |
| 3 | Polyethylene wax | Mitsui Petrochemical |
| | | Industries, Ltd. |
| | | “Chemipearl W-100” |
| 4 | Tetrafluoroethylene | Mitsui-Dupont Co., Ltd. |
| | resin | “MP 1100” |
| 5 | Tetrafluoroethylene | Daikin Industries, Ltd. |
| | resin | “L-2” |
| 6 | Mixture of No. 1 and | — |
| | No. 4, (Blend ratio | |
| | of 1:1) | |

TABLE 46

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 1 | 1 | 1 | 140 | 0.3 | 359 | 150 | 163 | 46 | 3.0 | 0.5 | E |
| 2 | 1 | 1 | 140 | 0.3 | 359 | 150 | 163 | 46 | 3.0 | 0.5 | E |
| 3 | 1 | 1 | 140 | 0.3 | 359 | 150 | 163 | 46 | 3.0 | 0.5 | E |
| 4 | 1 | 1 | 140 | 0.3 | 359 | 150 | 163 | 46 | 3.0 | 0.5 | E |
| 5 | 1 | 1 | 140 | 0.3 | 359 | 150 | 163 | 46 | 3.0 | 0.5 | E |
| 6 | 1 | 1 | 140 | 0.3 | 359 | 150 | 163 | 46 | 3.0 | 0.5 | E |
| 7 | 1 | 1 | 140 | 0.3 | 359 | 150 | 163 | 46 | 3.0 | 0.5 | E |
| 8 | 1 | 1 | 140 | 0.3 | 359 | 150 | 163 | 46 | 3.0 | 0.5 | E |

E: Example
C: Comparative example

TABLE 47

| | Secondary coating film | | | | | | | |
|---|---|---|---|---|---|---|---|---|
| | | Rust-preventive | | | | | | |
| | Resin | additive component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 1 | 1 | 15 | 15 | — | — | 140 | 1.0 | Example |
| 2 | 2 | 15 | 15 | — | — | 140 | 1.0 | Example |
| 3 | 3 | 15 | 15 | — | — | 140 | 1.0 | Example |
| 4 | 4 | 15 | 15 | — | — | 140 | 1.0 | Example |
| 5 | 5 | 15 | 15 | — | — | 140 | 1.0 | Example |
| 6 | 6 | 15 | 15 | — | — | 140 | 1.0 | Example |
| 7 | 7 | 15 | 15 | — | — | 140 | 1.0 | Example |
| 8 | 8 | 15 | 15 | — | — | 140 | 1.0 | Example |

TABLE 48

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 1 | ◯ | ⊚ | ⊚ | ⊚ | — | Example |
| 2 | ◯ | ⊚ | ⊚ | ⊚ | — | Example |
| 3 | ◯ | ◯+ | ◯ | ⊚ | — | Example |
| 4 | ◯ | ◯+ | ◯ | ⊚ | — | Example |
| 5 | ◯ | ◯ | ◯− | ⊚ | — | Example |
| 6 | ◯ | ◯ | ◯− | ⊚ | — | Example |
| 7 | ◯ | ◯ | ◯− | ⊚ | — | Example |
| 8 | ◯ | ◯ | ◯− | ⊚ | — | Example |

TABLE 49

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 9 | 1 | 2 | 140 | 0.3 | 344 | 30 | 245 | 69 | 0.4 | 0.5 | E |
| 10 | 1 | 3 | 140 | 0.3 | 363 | 90 | 245 | 28 | 3.0 | 0.2 | E |
| 11 | 1 | 4 | 140 | 0.3 | 360 | 200 | 99 | 61 | 3.0 | 1.1 | E |
| 12 | 1 | 5 | 140 | 0.3 | 358 | 290 | 53 | 15 | 18.0 | 0.5 | E |
| 13 | 1 | 6 | 140 | 0.3 | 600 | 150 | 163 | 46 | 3.0 | 0.5 | E |
| 14 | 1 | 7 | 140 | 0.3 | 358 | 160 | 174 | 24 | 3.0 | 0.5 | E |
| 15 | 1 | 8 | 140 | 0.3 | 360 | 35 | 286 | 39 | 0.4 | 0.5 | E |
| 16 | 1 | 9 | 140 | 0.3 | 349 | 90 | 245 | 14 | 3.0 | 0.2 | E |
| 17 | 1 | 10 | 140 | 0.3 | 362 | 220 | 109 | 33 | 3.0 | 1.1 | E |
| 18 | 1 | 11 | 140 | 0.3 | 362 | 300 | 54 | 8 | 18.0 | 0.5 | E |

E: Example
C: Comparative example

TABLE 50

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 9 | 1 | 15 | 15 | — | — | 140 | 1.0 | Example |
| 10 | 1 | 15 | 15 | — | — | 140 | 1.0 | Example |
| 11 | 1 | 15 | 15 | — | — | 140 | 1.0 | Example |
| 12 | 1 | 15 | 15 | — | — | 140 | 1.0 | Example |
| 13 | 1 | 15 | 15 | — | — | 140 | 1.0 | Example |
| 14 | 1 | 15 | 15 | — | — | 140 | 1.0 | Example |
| 15 | 1 | 15 | 15 | — | — | 140 | 1.0 | Example |
| 16 | 1 | 15 | 15 | — | — | 140 | 1.0 | Example |
| 17 | 1 | 15 | 15 | — | — | 140 | 1.0 | Example |
| 18 | 1 | 15 | 15 | — | — | 140 | 1.0 | Example |

TABLE 51

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 9 | ◯ | ⊚ | ⊚ | ⊚ | — | Example |
| 10 | ◯ | ⊚ | ⊚ | ⊚ | — | Example |
| 11 | ◯ | ⊚ | ⊚ | ⊚ | — | Example |
| 12 | ◯ | ⊚ | ⊚ | ⊚ | — | Example |
| 13 | ◯ | ⊚ | ⊚ | ⊚ | — | Example |
| 14 | ◯ | ⊚ | ⊚ | ⊚ | — | Example |
| 15 | ◯ | ⊚ | ⊚ | ⊚ | — | Example |
| 16 | ◯ | ⊚ | ⊚ | ⊚ | — | Example |
| 17 | ◯ | ⊚ | ⊚ | ⊚ | — | Example |
| 18 | ◯ | ⊚ | ⊚ | ⊚ | — | Example |

TABLE 52

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 19 | 1 | 12 | 140 | 0.3 | 358 | 160 | 174 | 24 | 3.0 | 0.5 | E |
| 20 | 1 | 13 | 140 | 0.3 | 355 | 160 | 174 | 21 | 3.0 | 0.5 | E |
| 21 | 1 | 14 | 140 | 0.3 | 362 | — | 283 | 79 | — | 0.5 | C |
| 22 | 1 | 15 | 140 | 0.3 | 360 | — | 316 | 44 | — | 0.5 | C |
| 23 | 1 | 16 | 140 | 0.3 | 355 | — | 316 | 39 | — | 0.5 | C |
| 24 | 1 | 17 | 140 | 0.3 | 358 | 334 | 24 | — | — | — | C |
| 25 | 1 | 18 | 140 | 0.3 | 353 | 270 | — | 83 | 3.0 | — | C |
| 26 | 1 | 19 | 140 | 0.3 | 357 | 310 | — | 47 | 3.0 | — | C |
| 27 | 1 | 20 | 140 | 0.3 | 363 | 320 | — | 43 | 3.0 | — | C |
| 28 | 1 | 21 | 140 | 0.3 | 360 | — | — | — | — | — | C |

E: Example
C: Comparative example

TABLE 53

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 19 | 1 | 15 | 15 | — | — | 140 | 1.0 | Example |
| 20 | 1 | 15 | 15 | — | — | 140 | 1.0 | Example |
| 21 | 1 | 15 | 15 | — | — | 140 | 1.0 | Comparative |
| | | | | | | | | example |
| 22 | 1 | 15 | 15 | — | — | 140 | 1.0 | Comparative |
| | | | | | | | | example |
| 23 | 1 | 15 | 15 | — | — | 140 | 1.0 | Comparative |
| | | | | | | | | example |
| 24 | 1 | 15 | 15 | — | — | 140 | 1.0 | Comparative |
| | | | | | | | | example |
| 25 | 1 | 15 | 15 | — | — | 140 | 1.0 | Comparative |
| | | | | | | | | example |
| 26 | 1 | 15 | 15 | — | — | 140 | 1.0 | Comparative |
| | | | | | | | | example |
| 27 | 1 | 15 | 15 | — | — | 140 | 1.0 | Comparative |
| | | | | | | | | example |
| 28 | 1 | 15 | 15 | — | — | 140 | 1.0 | Comparative |
| | | | | | | | | example |

TABLE 54

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 19 | ◯ | ◯+ | ◯+ | ⊚ | — | Example |
| 20 | ◯ | ◯ | ◯ | ◯ | — | Example |
| 21 | ◯ | Δ | Δ | Δ | — | Comparative |
| | | | | | | example |
| 22 | ◯ | Δ | Δ | Δ | — | Comparative |
| | | | | | | example |
| 23 | ◯ | Δ | Δ | Δ | — | Comparative |
| | | | | | | example |
| 24 | ◯ | Δ | Δ | ◯ | — | Comparative |
| | | | | | | example |
| 25 | ◯ | Δ | X | ◯ | — | Comparative |
| | | | | | | example |
| 26 | ◯ | Δ | X | ◯ | — | Comparative |
| | | | | | | example |
| 27 | ◯ | Δ | X | ◯ | — | Comparative |
| | | | | | | example |
| 28 | ◯ | Δ | X | Δ | — | Comparative |
| | | | | | | example |

TABLE 55

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 29 | 1 | 1 | 140 | 0.3 | 359 | 150 | 163 | 46 | 3.0 | 0.5 | C |
| 30 | 1 | 1 | 140 | 0.3 | 359 | 150 | 163 | 46 | 3.0 | 0.5 | E |
| 31 | 1 | 1 | 140 | 0.3 | 359 | 150 | 163 | 46 | 3.0 | 0.5 | E |
| 32 | 1 | 1 | 140 | 0.3 | 359 | 150 | 163 | 46 | 3.0 | 0.5 | E |
| 33 | 1 | 1 | 140 | 0.3 | 359 | 150 | 163 | 46 | 3.0 | 0.5 | E |
| 34 | 1 | 1 | 140 | 0.3 | 359 | 150 | 163 | 46 | 3.0 | 0.5 | E |
| 35 | 1 | 1 | 140 | 0.3 | 359 | 150 | 163 | 46 | 3.0 | 0.5 | C |
| 36 | 2 | 1 | 140 | 0.3 | 359 | 150 | 163 | 46 | 3.0 | 0.5 | E |
| 37 | 3 | 1 | 140 | 0.3 | 359 | 150 | 163 | 46 | 3.0 | 0.5 | E |
| 38 | 4 | 1 | 140 | 0.3 | 359 | 150 | 163 | 46 | 3.0 | 0.5 | E |
| 39 | 5 | 1 | 140 | 0.3 | 359 | 150 | 163 | 46 | 3.0 | 0.5 | E |
| 40 | 6 | 1 | 140 | 0.3 | 359 | 150 | 163 | 46 | 3.0 | 0.5 | E |

E: Example
C: Comparative example

TABLE 56

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 29 | 1 | — | — | — | — | 140 | 1.0 | Comparative |
| | | | | | | | | example |
| 30 | 1 | 15 | 1 | — | — | 140 | 1.0 | Example |
| 31 | 1 | 15 | 5 | — | — | 140 | 1.0 | Example |
| 32 | 1 | 15 | 25 | — | — | 140 | 1.0 | Example |
| 33 | 1 | 15 | 50 | — | — | 140 | 1.0 | Example |
| 34 | 1 | 15 | 100 | — | — | 140 | 1.0 | Example |
| 35 | 1 | 15 | 150 | — | — | 140 | 1.0 | Comparative |
| | | | | | | | | example |
| 36 | 1 | 15 | 15 | — | — | 140 | 1.0 | Example |
| 37 | 1 | 15 | 15 | — | — | 140 | 1.0 | Example |
| 38 | 1 | 15 | 15 | — | — | 140 | 1.0 | Example |
| 39 | 1 | 15 | 15 | — | — | 140 | 1.0 | Example |
| 40 | 1 | 15 | 15 | — | — | 140 | 1.0 | Example |

TABLE 57

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 29 | ◯ | Δ | Δ | ⊚ | — | Comparative |
| | | | | | | example |
| 30 | ◯ | ◯ | ◯ | ⊚ | — | Example |
| 31 | ◯ | ◯+ | ◯+ | ⊚ | — | Example |
| 32 | ◯ | ⊚ | ⊚ | ⊚ | — | Example |
| 33 | ◯ | ⊚ | ⊚ | ⊚ | — | Example |
| 34 | ◯ | ◯ | ◯ | ⊚ | — | Example |
| 35 | ◯ | Δ | Δ | ⊚ | — | Comparative |
| | | | | | | example |
| 36 | ◯ | ⊚ | ⊚ | ⊚ | — | Example |
| 37 | ◯ | ⊚ | ⊚ | ⊚ | — | Example |
| 38 | ◯ | ⊚ | ⊚ | ⊚ | — | Example |
| 39 | ◯ | ⊚ | ⊚ | ⊚ | — | Example |
| 40 | ◯ | ⊚ | ⊚ | ⊚ | — | Example |

TABLE 58

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 41 | 1 | 1 | 140 | 0.3 | 359 | 150 | 163 | 46 | 3.0 | 0.5 | C |
| 42 | 1 | 1 | 140 | 0.3 | 359 | 150 | 163 | 46 | 3.0 | 0.5 | E |
| 43 | 1 | 1 | 140 | 0.3 | 359 | 150 | 163 | 46 | 3.0 | 0.5 | E |
| 44 | 1 | 1 | 140 | 0.3 | 359 | 150 | 163 | 46 | 3.0 | 0.5 | E |
| 45 | 1 | 1 | 140 | 0.3 | 359 | 150 | 163 | 46 | 3.0 | 0.5 | E |
| 46 | 1 | 1 | 140 | 0.3 | 359 | 150 | 163 | 46 | 3.0 | 0.5 | E |
| 47 | 1 | 1 | 140 | 0.3 | 359 | 150 | 163 | 46 | 3.0 | 0.5 | E |
| 48 | 1 | 1 | 140 | 0.3 | 359 | 150 | 163 | 46 | 3.0 | 0.5 | E |
| 49 | 1 | 1 | 140 | 0.3 | 359 | 150 | 163 | 46 | 3.0 | 0.5 | E |
| 50 | 1 | 1 | 140 | 0.3 | 359 | 150 | 163 | 46 | 3.0 | 0.5 | C |

E: Example
C: Comparative example

TABLE 59

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 41 | 1 | 15 | 15 | — | — | 140 | 0.001 | Comparative |
| | | | | | | | | example |
| 42 | 1 | 15 | 15 | — | — | 140 | 0.1 | Example |
| 43 | 1 | 15 | 15 | — | — | 140 | 0.5 | Example |
| 44 | 1 | 15 | 15 | — | — | 140 | 0.7 | Example |
| 45 | 1 | 15 | 15 | — | — | 140 | 2.0 | Example |
| 46 | 1 | 15 | 15 | — | — | 140 | 2.5 | Example |
| 47 | 1 | 15 | 15 | — | — | 140 | 3.0 | Example |
| 48 | 1 | 15 | 15 | — | — | 140 | 4.0 | Example |
| 49 | 1 | 15 | 15 | — | — | 140 | 5.0 | Example |
| 50 | 1 | 15 | 15 | — | — | 140 | 20.0 | Comparative |
| | | | | | | | | example |

TABLE 60

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 41 | ◯ | X | X | Δ | — | Comparative |
| | | | | | | example |
| 42 | ◯ | ◯− | ◯− | ⊚ | — | Example |
| 43 | ◯ | ◯ | ◯ | ⊚ | — | Example |
| 44 | ◯ | ◯+ | ◯+ | ⊚ | — | Example |
| 45 | ◯ | ⊚ | ⊚ | ⊚ | — | Example |
| 46 | ◯ | ⊚ | ⊚ | ⊚ | — | Example |
| 47 | ◯ | ⊚ | ⊚ | ⊚ | — | Example |
| 48 | ◯ | ⊚ | ⊚ | ⊚ | — | Example |
| 49 | ◯ | ⊚ | ⊚ | ⊚ | — | Example |
| 50 | ◯ | ⊚ | ⊚ | ⊚ | — | Comparative |
| | | | | | | example ※1 |

※1 Welding impossible

TABLE 61

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 51 | 1 | 1 | 140 | 0.3 | 359 | 150 | 163 | 46 | 3.0 | 0.5 | C |
| 52 | 1 | 1 | 140 | 0.3 | 359 | 150 | 163 | 46 | 3.0 | 0.5 | E |
| 53 | 1 | 1 | 140 | 0.3 | 359 | 150 | 163 | 46 | 3.0 | 0.5 | E |
| 54 | 1 | 1 | 140 | 0.3 | 359 | 150 | 163 | 46 | 3.0 | 0.5 | E |
| 55 | 1 | 1 | 140 | 0.3 | 359 | 150 | 163 | 46 | 3.0 | 0.5 | E |
| 56 | 1 | 1 | 140 | 0.3 | 359 | 150 | 163 | 46 | 3.0 | 0.5 | E |
| 57 | 1 | 1 | 140 | 0.3 | 359 | 150 | 163 | 46 | 3.0 | 0.5 | E |
| 58 | 1 | 1 | 140 | 0.3 | 359 | 150 | 163 | 46 | 3.0 | 0.5 | E |
| 59 | 1 | 1 | 140 | 0.3 | 359 | 150 | 163 | 46 | 3.0 | 0.5 | E |
| 60 | 1 | 1 | 140 | 0.3 | 359 | 150 | 163 | 46 | 3.0 | 0.5 | C |

E: Example
C: Comparative example

TABLE 62

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 51 | 1 | 15 | 15 | — | — | 40 | 1.0 | Comparative |
| | | | | | | | | example |
| 52 | 1 | 15 | 15 | — | — | 50 | 1.0 | Example |
| 53 | 1 | 15 | 15 | — | — | 80 | 1.0 | Example |
| 54 | 1 | 15 | 15 | — | — | 120 | 1.0 | Example |
| 55 | 1 | 15 | 15 | — | — | 180 | 1.0 | Example |
| 56 | 1 | 15 | 15 | — | — | 200 | 1.0 | Example |
| 57 | 1 | 15 | 15 | — | — | 230 | 1.0 | Example |
| 58 | 1 | 15 | 15 | — | — | 250 | 1.0 | Example |
| 59 | 1 | 15 | 15 | — | — | 350 | 1.0 | Example |
| 60 | 1 | 15 | 15 | — | — | 380 | 1.0 | Comparative |
| | | | | | | | | example |

TABLE 63

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 51 | ◯ | X | X | X | — | Comparative |
| | | | | | | example |
| 52 | ◯ | ◯− | ◯− | ◯ | — | Example |
| 53 | ◯ | ◯ | ◯− | ◯+ | — | Example |
| 54 | ◯ | ⊚ | ◯ | ⊚ | — | Example |
| 55 | ◯ | ⊚ | ⊚ | ⊚ | — | Example |
| 56 | ◯ | ⊚ | ⊚ | ⊚ | — | Example |
| 57 | ◯ | ⊚ | ⊚ | ⊚ | — | Example |
| 58 | ◯ | ⊚ | ⊚ | ⊚ | — | Example |
| 59 | ◯ | ⊚ | ⊚ | ⊚ | — | Example |
| 60 | ◯ | Δ | Δ | ⊚ | — | Comparative |
| | | | | | | example |

TABLE 64

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 61 | 1 | 1 | 140 | 0.3 | 359 | 150 | 163 | 46 | 3.0 | 0.5 | E |
| 62 | 1 | 1 | 140 | 0.3 | 359 | 150 | 163 | 46 | 3.0 | 0.5 | E |
| 63 | 1 | 1 | 140 | 0.3 | 359 | 150 | 163 | 46 | 3.0 | 0.5 | E |
| 64 | 1 | 1 | 140 | 0.3 | 359 | 150 | 163 | 46 | 3.0 | 0.5 | E |
| 65 | 1 | 1 | 140 | 0.3 | 359 | 150 | 163 | 46 | 3.0 | 0.5 | E |
| 66 | 1 | 1 | 140 | 0.3 | 359 | 150 | 163 | 46 | 3.0 | 0.5 | E |
| 67 | 1 | 1 | 140 | 0.3 | 359 | 150 | 163 | 46 | 3.0 | 0.5 | E |
| 68 | 1 | 1 | 140 | 0.3 | 359 | 150 | 163 | 46 | 3.0 | 0.5 | E |
| 69 | 1 | 1 | 140 | 0.3 | 359 | 150 | 163 | 46 | 3.0 | 0.5 | E |
| 70 | 1 | 1 | 140 | 0.3 | 359 | 150 | 163 | 46 | 3.0 | 0.5 | E |
| 71 | 1 | 1 | 140 | 0.3 | 359 | 150 | 163 | 46 | 3.0 | 0.5 | E |
| 72 | 1 | 1 | 140 | 0.3 | 359 | 150 | 163 | 46 | 3.0 | 0.5 | E |
| 73 | 1 | 1 | 140 | 0.3 | 359 | 150 | 163 | 46 | 3.0 | 0.5 | E |
| 74 | 1 | 1 | 140 | 0.3 | 359 | 150 | 163 | 46 | 3.0 | 0.5 | E |

E: Example
C: Comparative example

TABLE 65

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 61 | 1 | 1 | 15 | — | — | 140 | 1.0 | Example |
| 62 | 1 | 2 | 15 | — | — | 140 | 1.0 | Example |
| 63 | 1 | 3 | 15 | — | — | 140 | 1.0 | Example |
| 64 | 1 | 4 | 15 | — | — | 140 | 1.0 | Example |
| 65 | 1 | 5 | 15 | — | — | 140 | 1.0 | Example |
| 66 | 1 | 6 | 15 | — | — | 140 | 1.0 | Example |
| 67 | 1 | 7 | 15 | — | — | 140 | 1.0 | Example |
| 68 | 1 | 8 | 15 | — | — | 140 | 1.0 | Example |
| 69 | 1 | 9 | 15 | — | — | 140 | 1.0 | Example |
| 70 | 1 | 10 | 15 | — | — | 140 | 1.0 | Example |
| 71 | 1 | 11 | 15 | — | — | 140 | 1.0 | Example |
| 72 | 1 | 12 | 15 | — | — | 140 | 1.0 | Example |
| 73 | 1 | 13 | 15 | — | — | 140 | 1.0 | Example |
| 74 | 1 | 14 | 15 | — | — | 140 | 1.0 | Example |

TABLE 66

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 61 | ◯ | ◯ | ◯ | ⊚ | — | Example |
| 62 | ◯ | ◯ | ◯ | ⊚ | — | Example |
| 63 | ◯ | ◯ | ◯ | ⊚ | — | Example |
| 64 | ◯ | ◯ | ◯ | ⊚ | — | Example |
| 65 | ◯ | ◯ | ◯ | ⊚ | — | Example |
| 66 | ◯ | ◯ | ◯ | ⊚ | — | Example |
| 67 | ◯ | ◯ | ◯ | ⊚ | — | Example |
| 68 | ◯ | ◯ | ◯ | ⊚ | — | Example |
| 69 | ◯ | ◯ | ◯ | ⊚ | — | Example |
| 70 | ◯ | ◯ | ◯ | ⊚ | — | Example |
| 71 | ◯ | ◯ | ◯ | ⊚ | — | Example |
| 72 | ◯ | ◯+ | ◯+ | ⊚ | — | Example |
| 73 | ◯ | ◯+ | ◯+ | ⊚ | — | Example |
| 74 | ◯ | ◯+ | ◯+ | ⊚ | — | Example |

TABLE 67

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 75 | 1 | 1 | 140 | 0.3 | 359 | 150 | 163 | 46 | 3.0 | 0.5 | E |
| 76 | 1 | 1 | 140 | 0.3 | 359 | 150 | 163 | 46 | 3.0 | 0.5 | E |
| 77 | 1 | 1 | 140 | 0.3 | 359 | 150 | 163 | 46 | 3.0 | 0.5 | E |
| 78 | 1 | 1 | 140 | 0.3 | 359 | 150 | 163 | 46 | 3.0 | 0.5 | E |
| 79 | 1 | 1 | 140 | 0.3 | 359 | 150 | 163 | 46 | 3.0 | 0.5 | E |
| 80 | 1 | 1 | 140 | 0.3 | 359 | 150 | 163 | 46 | 3.0 | 0.5 | E |
| 81a | 1 | 1 | 140 | 0.3 | 359 | 150 | 163 | 46 | 3.0 | 0.5 | E |
| 81b | 1 | 1 | 140 | 0.3 | 359 | 150 | 163 | 46 | 3.0 | 0.5 | E |
| 81c | 1 | 1 | 140 | 0.3 | 359 | 150 | 163 | 46 | 3.0 | 0.5 | E |
| 81d | 1 | 1 | 140 | 0.3 | 359 | 150 | 163 | 46 | 3.0 | 0.5 | E |
| 81e | 1 | 1 | 140 | 0.3 | 359 | 150 | 163 | 46 | 3.0 | 0.5 | E |
| 81f | 1 | 1 | 140 | 0.3 | 359 | 150 | 163 | 46 | 3.0 | 0.5 | E |
| 81g | 1 | 1 | 140 | 0.3 | 359 | 150 | 163 | 46 | 3.0 | 0.5 | E |
| 82 | 1 | 1 | 140 | 0.3 | 359 | 150 | 163 | 46 | 3.0 | 0.5 | E |

E: Example
C: Comparative example

TABLE 68

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 75 | 1 | 16 | 15 | — | — | 140 | 1.0 | Example |
| 76 | 1 | 17 | 15 | — | — | 140 | 1.0 | Example |
| 77 | 1 | 18 | 15 | — | — | 140 | 1.0 | Example |
| 78 | 1 | 19 | 15 | — | — | 140 | 1.0 | Example |
| 79 | 1 | 20 | 15 | — | — | 140 | 1.0 | Example |
| 80 | 1 | 21 | 15 | — | — | 140 | 1.0 | Example |
| 81a | 1 | 1 | 15 | 1 | 10 | 140 | 1.0 | Example |
| 81b | 1 | 5 | 15 | 1 | 10 | 140 | 1.0 | Example |
| 81c | 1 | 7 | 15 | 1 | 10 | 140 | 1.0 | Example |
| 81d | 1 | 12 | 15 | 1 | 10 | 140 | 1.0 | Example |
| 81e | 1 | 13 | 15 | 1 | 10 | 140 | 1.0 | Example |
| 81f | 1 | 14 | 15 | 1 | 10 | 140 | 1.0 | Example |
| 81g | 1 | 15 | 15 | 1 | 10 | 140 | 1.0 | Example |
| 82 | 1 | 15 | 15 | 2 | 10 | 140 | 1.0 | Example |

TABLE 69

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 75 | ◯ | ◯+ | ◯+ | ⊚ | — | Example |
| 76 | ◯ | ◯+ | ◯+ | ⊚ | — | Example |
| 77 | ◯ | ◯+ | ◯+ | ⊚ | — | Example |
| 78 | ◯ | ◯+ | ◯+ | ⊚ | — | Example |
| 79 | ◯ | ⊚ | ⊚ | ⊚ | — | Example |
| 80 | ◯ | ⊚ | ⊚ | ⊚ | — | Example |
| 81a | ◯ | ◯ | ◯ | ⊚ | ⊚ | Example |
| 81b | ◯ | ◯ | ◯ | ⊚ | ⊚ | Example |
| 81c | ◯ | ◯ | ◯ | ⊚ | ⊚ | Example |
| 81d | ◯ | ◯+ | ◯+ | ⊚ | ⊚ | Example |
| 81e | ◯ | ◯+ | ◯+ | ⊚ | ⊚ | Example |
| 81f | ◯ | ◯+ | ◯+ | ⊚ | ⊚ | Example |
| 81g | ◯ | ⊚ | ⊚ | ⊚ | ⊚ | Example |
| 82 | ◯ | ⊚ | ⊚ | ⊚ | ⊚ | Example |

TABLE 70

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 83 | 1 | 1 | 140 | 0.3 | 359 | 150 | 163 | 46 | 3.0 | 0.5 | E |
| 84 | 1 | 1 | 140 | 0.3 | 359 | 150 | 163 | 46 | 3.0 | 0.5 | E |
| 85 | 1 | 1 | 140 | 0.3 | 359 | 150 | 163 | 46 | 3.0 | 0.5 | E |
| 86 | 1 | 1 | 140 | 0.3 | 359 | 150 | 163 | 46 | 3.0 | 0.5 | E |
| 87 | 1 | 1 | 140 | 0.3 | 359 | 150 | 163 | 46 | 3.0 | 0.5 | E |
| 88 | 1 | 1 | 140 | 0.3 | 359 | 150 | 163 | 46 | 3.0 | 0.5 | E |
| 89 | 1 | 1 | 140 | 0.3 | 359 | 150 | 163 | 46 | 3.0 | 0.5 | E |
| 90 | 1 | 1 | 140 | 0.3 | 359 | 150 | 163 | 46 | 3.0 | 0.5 | E |
| 91 | 1 | 1 | 140 | 0.3 | 359 | 150 | 163 | 46 | 3.0 | 0.5 | C |

E: Example
C: Comparative example

TABLE 71

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 83 | 1 | 15 | 15 | 3 | 10 | 140 | 1.0 | Example |
| 84 | 1 | 15 | 15 | 4 | 10 | 140 | 1.0 | Example |
| 85 | 1 | 15 | 15 | 5 | 10 | 140 | 1.0 | Example |
| 86 | 1 | 15 | 15 | 6 | 10 | 140 | 1.0 | Example |
| 87 | 1 | 15 | 15 | 1 | 1 | 140 | 1.0 | Example |
| 88 | 1 | 15 | 15 | 1 | 3 | 140 | 1.0 | Example |
| 89 | 1 | 15 | 15 | 1 | 40 | 140 | 1.0 | Example |
| 90 | 1 | 15 | 15 | 1 | 80 | 140 | 1.0 | Example |
| 91 | 1 | 15 | 15 | 1 | 100 | 140 | 1.0 | Comparative |
| | | | | | | | | example |

TABLE 72

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 83 | ◯ | ⊚ | ⊚ | ⊚ | ⊚ | Example |
| 84 | ◯ | ⊚ | ⊚ | ⊚ | ⊚ | Example |
| 85 | ◯ | ⊚ | ⊚ | ⊚ | ⊚ | Example |
| 86 | ◯ | ⊚ | ⊚ | ◯ | ⊚ | Example |
| 87 | ◯ | ⊚ | ⊚ | ⊚ | ◯ | Example |
| 88 | ◯ | ⊚ | ⊚ | ⊚ | ⊚ | Example |
| 89 | ◯ | ⊚ | ⊚ | ⊚ | ⊚ | Example |
| 90 | ◯ | ⊚ | ⊚ | ◯ | ⊚ | Example |
| 91 | ◯ | ⊚ | ⊚ | X | ⊚ | Comparative |
| | | | | | | example |

TABLE 73

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 92 | 1 | 1 | 140 | 0.001 | 1.2 | 0.5 | 0.5 | 0.2 | 3.0 | 0.5 | C |
| 93 | 1 | 1 | 140 | 0.005 | 6 | 2.5 | 2.5 | 1 | 3.0 | 0.5 | E |
| 94 | 1 | 1 | 140 | 0.01 | 12 | 5 | 5 | 2 | 3.0 | 0.5 | E |
| 95 | 1 | 1 | 140 | 0.1 | 120 | 51 | 54 | 15 | 3.0 | 0.5 | E |
| 96 | 1 | 1 | 140 | 0.5 | 599 | 250 | 272 | 77 | 3.0 | 0.5 | E |
| 97 | 1 | 1 | 140 | 1.0 | 1197 | 500 | 544 | 153 | 3.0 | 0.5 | E |
| 98 | 1 | 1 | 140 | 2 | 2395 | 1000 | 1089 | 306 | 3.0 | 0.5 | E |
| 99 | 1 | 1 | 140 | 3 | 3591 | 1500 | 1633 | 458 | 3.0 | 0.5 | E |
| 100 | 1 | 1 | 140 | 5 | 5986 | 2500 | 2722 | 764 | 3.0 | 0.5 | C |

E: Example
C: Comparative example

TABLE 74

| | Secondary coating film | | | | | | | |
|---|---|---|---|---|---|---|---|---|
| | | Rust-preventive | | | | | | |
| | Resin | additive component (B) | | Solid lubricant (C) | | Drying | Film | |
| | composition | Kind | Blend | Kind | Blend | temperature | thickness | |
| No. | *4 | *5 | *7 | *6 | *7 | (° C.) | (μm) | Classification |
| 92 | 1 | 15 | 15 | — | — | 140 | 1.0 | Comparative |
| | | | | | | | | example |
| 93 | 1 | 15 | 15 | — | — | 140 | 1.0 | Example |
| 94 | 1 | 15 | 15 | — | — | 140 | 1.0 | Example |
| 95 | 1 | 15 | 15 | — | — | 140 | 1.0 | Example |
| 96 | 1 | 15 | 15 | — | — | 140 | 1.0 | Example |
| 97 | 1 | 15 | 15 | — | — | 140 | 1.0 | Example |
| 98 | 1 | 15 | 15 | — | — | 140 | 1.0 | Example |
| 99 | 1 | 15 | 15 | — | — | 140 | 1.0 | Example |
| 100 | 1 | 15 | 15 | — | — | 140 | 1.0 | Comparative |
| | | | | | | | | example |

TABLE 75

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | after 50 cycles | after 50 cycles | adhesiveness | Workability | Classification |
| 92 | ◯ | X | X | ⊚ | — | Comparative |
| | | | | | | example |
| 93 | ◯ | ◯− | ◯− | ⊚ | — | Example |
| 94 | ◯ | ◯ | ◯ | ⊚ | — | Example |
| 95 | ◯ | ◯+ | ◯+ | ⊚ | — | Example |
| 96 | ◯ | ⊚ | ⊚ | ⊚ | — | Example |
| 97 | ◯ | ⊚ | ⊚ | ⊚ | — | Example |
| 98 | ◯ | ⊚ | ⊚ | ⊚ | — | Example |
| 99 | ◯ | ⊚ | ⊚ | ⊚ | — | Example |
| 100 | ◯ | ⊚ | ⊚ | ⊚ | — | Comparative |
| | | | | | | example ※1 |

※1 Welding impossible

TABLE 76

| | | Primary coating film | | | | | | | | | |
|---|---|---|---|---|---|---|---|---|---|---|---|
| | | | | | Film coating weight *3 | | | | | | |
| | Plated | | | | Total | | | | Mole ratio of film | | |
| | steel | Film | Drying | Film | coating | Composition | Composition | Composition | components | | |
| | sheet | composition | temperature | thickness | weight | (α) | (β) | (γ) | (α)/(γ) | (γ)/(β) | |
| No. | *1 | *2 | (° C.) | (μm) | (mg/m²) | (mg/m²) | (mg/m²) | (mg/m²) | *3 | *3 | Classification |
| 101 | 1 | 1 | 30 | 0.3 | 359 | 150 | 163 | 46 | 3.0 | 0.5 | C |
| 102 | 1 | 1 | 50 | 0.3 | 359 | 150 | 163 | 46 | 3.0 | 0.5 | E |
| 103 | 1 | 1 | 80 | 0.3 | 359 | 150 | 163 | 46 | 3.0 | 0.5 | E |
| 104 | 1 | 1 | 120 | 0.3 | 359 | 150 | 163 | 46 | 3.0 | 0.5 | E |
| 105 | 1 | 1 | 180 | 0.3 | 359 | 150 | 163 | 46 | 3.0 | 0.5 | E |
| 106 | 1 | 1 | 200 | 0.3 | 359 | 150 | 163 | 46 | 3.0 | 0.5 | E |
| 107 | 1 | 1 | 300 | 0.3 | 359 | 150 | 163 | 46 | 3.0 | 0.5 | E |
| 108 | 1 | 1 | 350 | 0.3 | 359 | 150 | 163 | 46 | 3.0 | 0.5 | C |

E: Example
C: Comparative example

TABLE 77

| | Secondary coating film | | | | | | | |
|---|---|---|---|---|---|---|---|---|
| | | Rust-preventive | | | | | | |
| | | additive | | | | | | |
| | Resin | component (Y) | | Solid lubricant (Z) | | Drying | Film | |
| | composition | Kind | Blend | Kind | Blend | temperature | thickness | |
| No. | *4 | *5 | *7 | *6 | *7 | (° C.) | (μm) | Classification |
| 101 | 1 | 15 | 15 | — | — | 140 | 1.0 | Comparative |
| | | | | | | | | example |
| 102 | 1 | 15 | 15 | — | — | 140 | 1.0 | Example |
| 103 | 1 | 15 | 15 | — | — | 140 | 1.0 | Example |
| 104 | 1 | 15 | 15 | — | — | 140 | 1.0 | Example |
| 105 | 1 | 15 | 15 | — | — | 140 | 1.0 | Example |
| 106 | 1 | 15 | 15 | — | — | 140 | 1.0 | Example |
| 107 | 1 | 15 | 15 | — | — | 140 | 1.0 | Example |
| 108 | 1 | 15 | 15 | — | — | 140 | 1.0 | Comparative |
| | | | | | | | | example |

TABLE 78

| | Performance | | | | | |
|---|---|---|---|---|---|---|
| | | | White rust resistance | | | |
| | | White rust resistance | after alkali degreasing | | | |
| | | CCT | CCT | Coating | | |
| No. | Appearance | After 50 cycles | after 50 cycles | adhesiveness | Workability | Classification |
| 101 | ◯ | X | X | X | — | Comparative |
| | | | | | | example |
| 102 | ◯ | ◯— | ◯— | ◯ | — | Example |
| 103 | ◯ | ⊚ | ⊚ | ⊚ | — | Example |
| 104 | ◯ | ⊚ | ⊚ | ⊚ | — | Example |
| 105 | ◯ | ⊚ | ⊚ | ⊚ | — | Example |
| 106 | ◯ | ⊚ | ⊚ | ⊚ | — | Example |
| 107 | ◯ | ⊚ | ⊚ | ⊚ | — | Example |
| 108 | ◯ | X | X | ⊚ | — | Comparative |
| | | | | | | example |

What is claimed is:

1. A steel sheet having organic coating, comprising:
a zinc or a zinc alloy plated steel sheet or an aluminum or an aluminum alloy plated steel sheet;
a composite oxide coating formed on the surface of the plated steel sheet and containing at least one metal selected from the group consisting of Mn and Al; and
an organic coating formed on the composite oxide coating and containing at least one rust-preventive additive component selected from the group consisting of (a) through (i),
(a) a Ca ion exchanged silica and a phosphate,
(b) a Ca ion exchanged silica, a phosphate, and a silicon oxide,
(c) a calcium compound and a silicon oxide,
(d) a calcium compound, a phosphate, and a silicon oxide,
(e) a molybdenate,
(f) at least one organic compound selected from the group consisting of a triazole, a thiol, a thiadiazole, a thiazole, and a thiuram,
(g) at least one substance selected from the group consisting of calcium and calcium compounds,
(h) at least one compound selected from the group consisting of a phosphate and a silicon oxide, and
(i) a Ca ion exchanged silica.

2. The steel sheet of claim 1, wherein said at least one rust-preventive additive component is:
(e) a molybdenate,
(g) at least one substance selected from the group consisting of calcium and a calcium compound, and
(h) at least one compound selected from the group consisting of a phosphate and a silicon oxide.

3. The steel sheet of claim 1, wherein said at least one rust-preventive additive component is:
(e) a molybdenate, and
(i) a Ca ion exchanged silica.

4. The steel sheet of claim 1, wherein said at least one rust-preventive additive component is:
(f) at least one organic compound selected from the group consisting of a triazole, a thiol, a thiadiazole, a thiazole, and a thiuram,
(g) at least one substance selected from the group consisting of calcium and a calcium compound, and
(h) at least one compound selected from the group consisting of a phosphate and a silicon oxide.

5. The steel sheet of claim 1, wherein said at least one rust-preventive additive component is:
(f) at least one organic compound selected from the group consisting of a triazole, a thiol, a thiadiazole, a thiazole, and a thiuram, and
(i) a Ca ion exchanged silica.

6. The steel sheet of claim 1, wherein said at least one rust-preventive additive component is:
(e) a molybdenate, and
(f) at least one organic compound selected from the group consisting of a triazole, a thiol, a thiadiazole, a thiazole, and a thiuram.

7. The steel sheet of claim 1, wherein said at least one rust-preventive additive component is:
(e) a molybdenate,
(f) at least one compound selected from the group consisting of a triazole, a thiol, a thiadiazole, a thiazole, and a thiuram,
(g) at least one substance selected from the group consisting of calcium and a calcium compound, and
(h) at least one compound selected from the group consisting of a phosphate and a silicon oxide.

8. The steel sheet of claim 1, wherein said at least one rust-preventive additive component is:
(e) a molybdenate,
(f) at least one organic compound selected from the group consisting of a triazole, a thiol, a thiadiazole, a thiazole, and a thiuram, and
(i) a Ca ion exchanged silica.

9. The steel sheet of claim 1, wherein the composite oxide coating has a thickness of from 0.005 to 3 μm.

10. The steel sheet of claim 1, wherein the composite oxide coating contains:
(α) oxide fine particles,
(β) at least one substance selected from the group consisting of a phosphate and a phosphoric acid compound, and
(γ) at least one metal selected from the group consisting of Mn and Al.

11. The steel sheet of claim 10, wherein the component (α) contained in the composite oxide coating is a silicon oxide.

12. The steel sheet of claim 10, wherein the composite oxide coating further contains an organic resin.

13. The steel sheet of claim 1, wherein the organic coating has a thickness of from 0.1 to 5 μm.

14. The steel sheet of claim 1, wherein
the organic coating contains a reaction product (X) and the rust-preventive additive component (Y), said reaction product (X) being obtained from a reaction between a film-forming organic resin (A) and an activated-hydrogen-containing compound (B), at least a part of the compound (B) comprising a hydrazine derivative (C) containing activated hydrogen; and
the content of the rust-preventive additive component (Y) is from 1 to 100 parts by weight (solid matter) to 100 parts by weight (solid matter) of the reaction product (X).

15. The steel sheet of claim 14, wherein the organic coating further contains a solid lubricant (Z), and the content of the solid lubricant (Z) is from 1 to 80 parts by weight (solid matter) to 100 parts by weight (solid matter) of the reaction product (X).

16. The steel sheet of claim 1, wherein the film-forming organic resin (A) is a resin (D) containing epoxy group.

17. The steel sheet of claim 14, wherein the hydrazine derivative (C) containing activated hydrogen is a pyrazole compound containing activated hydrogen and/or a triazole compound containing activated hydrogen.

18. The steel sheet of claim 14, wherein the content of the hydrazine derivative (C) containing activated hydrogen in the compound (B) containing activated hydrogen is from 10 to 100 mole %.

19. The steel sheet of claim 16, wherein the resin (D) containing epoxy group is an epoxy resin expressed by a formula of:

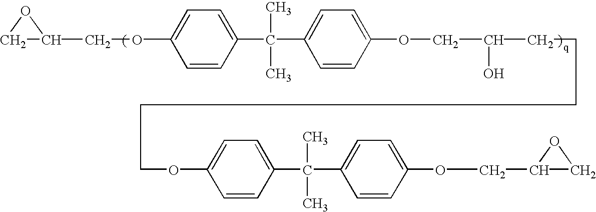

20. The steel sheet of claim 1, wherein the organic coating consists essentially of an organic polymer resin (A) containing OH group and/or COOH group, as a base resin, and the content of the rust-preventive additive component (B) is from 1 to 100 parts by weight (solid matter) to 100 parts by weight (solid matter) of the base resin.

21. The steel sheet of claim 20, wherein the organic coating further contains a solid lubricant (C), and the content of the solid lubricant (C) is from 1 to 80 parts by weight (solid matter) to 100 parts by weight (solid matter) of the base resin.

22. The steel sheet of claim 20, wherein the organic polymer resin (A) containing OH group and/or COOH group is a thermosetting resin.

23. The steel sheet of claim 20, wherein the organic polymer resin (A) containing OH group and/or COOH group is an epoxy resin and/or a modified epoxy resin.

24. A steel sheet with organic coating, comprising:
a zinc or a zinc alloy plated steel sheet or an aluminum or an aluminum alloy plated steel sheet;
a composite oxide coating formed on the surface of the plated steel sheet and containing Mg; and
an organic coating formed on the composite oxide coating and containing at least one rust-preventive additive component selected from the group consisting of (a) through (f),
(a) a Ca ion exchanged silica and a phosphate,
(b) a Ca ion exchanged silica, a phosphate, and a silicon oxide,
(c) a calcium compound and a silicon oxide,
(d) a calcium compound, a phosphate, and a silicon oxide,
(e) a molybdenate, and
(f) at least one compound selected from the group consisting of a triazole, a thiol, a thiadiazole, a thiazole, and a thiuram.

25. The steel sheet of claim 24, wherein said at least one rust-preventive additive component is:
(c) a calcium compound and a silicon oxide,
(e) a molybdenate, and
(f) at least one organic compound selected from the group consisting of a triazole, a thiol, a thiadiazole, a thiazole, and a thiuram.

26. The steel sheet of claim 24, wherein said at least one rust-preventive additive component is:
(a) a calcium compound and a silicon oxide, and
(f) at least one organic compound selected from the group consisting of a triazole, a thiol, a thiadiazole, a thiazole, and a thiuram.

27. The steel sheet of claim 24, wherein the composite oxide coating has a thickness of from 0.005 to 3 μm.

28. The steel sheet of claim 24, wherein the composite oxide coating contains:
(α) oxide fine particles,
(β) at least one substance selected from the group consisting of a phosphate and a phosphoric acid compound, and
(γ) Mg.

29. The steel sheet of claim 24, wherein the organic coating has a thickness of from 0.1 to 5 μm.

30. The steel sheet of claim 24, wherein
the organic coating contains a reaction product (X) and the rust-preventive additive component (Y), said reaction product (X) being obtained from a reaction between a film-forming organic resin (A) and an activated-hydrogen-containing compound (B), at least a part of the compound (B) comprising a hydrazine derivative (C) containing activated hydrogen; and
the content of the rust-preventive additive component (Y) is from 1 to 100 parts by weight (solid matter) to 100 parts by weight (solid matter) of the reaction product (X).

31. The steel sheet of claim 30, wherein the organic coating further contains a solid lubricant (Z), and the content of the solid lubricant (Z) is from 1 to 80 parts by weight (solid matter) to 100 parts by weight (solid matter) of the reaction product (X).

32. The steel sheet of claim 24, wherein the organic coating consists essentially of an organic polymer resin (A) containing OH group and/or COOH group, as a base resin, and the content of the rust-preventive additive component (B) is from 1 to 100 parts by weight ( solid matter) to 100 parts by weight solid matter of the base resin.

33. The steel sheet of claim 32, wherein the organic coating further contains a solid lubricant (C), and the content of the solid lubricant (C) is from 1 to 80 parts by weight (solid matter) to 100 parts by weight (solid matter) of the base resin.

34. A method for manufacturing steel sheet with organic coating comprising the steps of:
(a) preparing a zinc or a zinc alloy plated steel sheet, or an aluminum or an aluminum alloy plated steel sheet;
(b) preparing a treating liquid containing (i) oxide fine particles, (ii) phosphoric acid and/or a phosphoric acid compound, and (iii) at least one metal selected from the group consisting of Mg, Mn, and Al;
(c) adjusting the treating liquid so as the molar concentration of the additive component (i), the total molar concentration of the additive component (ii) converted to P₂O₅, and the total molar concentration of the additive component (iii) converted to the quantity of the at least one metal, to satisfy the molar ratio of (i)/(iii)=0.1 to 20, and of (iii)/(ii)=0.1 to 1.5;
(d) applying the treating liquid onto the plated steel sheet;
(e) forming a composite oxide film having a thickness of from 0.005 to 3 μm onto the surface of plated steel sheet by heating to dry the plated steel sheet on which the treating liquid was applied;
(f) applying a coating composition for forming an organic coating onto the composite oxide coating; and
(g) forming an organic coating having thicknesses of from 0.1 to 5 μm by heating to dry the plated steel sheet on which the coating composition was applied.

35. The method of claim 34, wherein the additive component (i) in the treating liquid for forming the composite oxide coating is a silicon oxide.

36. The method of claim 34, wherein the treating liquid for forming the composite oxide coating further contains an organic resin.

37. A treating liquid for forming a composite oxide coating consisting essentially of (i) oxide fine particles, (ii) phosphoric acid and/or a phosphoric acid compound, and (iii) at least one metal selected from the group consisting of Mg, Mn, and Al; wherein the molar concentration of the additive component (i), the total molar concentration of the additive component (ii) converted to P₂O₅, and the total molar concentration of the additive component (iii) converted to the quantity of the at least one metal, satisfy the molar ratio of (i)/(iii)=0.1 to 20, and of (iii)/(ii)=0.1 to 1.5.

38. An electric equipment product using the steel sheet with organic coating described in claim 1.

39. An electric equipment product using the steel sheet with organic coating described in claim 24.

40. A building material using the steel sheet with organic coating described in claim 1.

41. A building material using the steel sheet with organic coating described in claim 24.

42. A steel sheet for automobile using the steel sheet with organic coating described in claim 1.

43. A steel sheet for automobile using the steel sheet with organic coating described in claim 24.
